(19) United States
(12) Patent Application Publication
(10) Pub. No.: US 2003/0130899 A1
(43) Pub. Date: Jul. 10, 2003

(54) System and method for historical database training of non-linear models for use in electronic commerce

(76) Inventors: Bruce Ferguson, Round Rock, TX (US); Eric Hartman, Austin, TX (US)

Correspondence Address: Jeffrey C. Hood, Conley, Rose, & Tayon, P.C., P.O. Box 398, Austin, TX, 78767, US

(21) Appl. No.: 10/041,403

(22) Filed: Jan. 8, 2002

(51) Int. Cl. G06F 17/60

(52) U.S. Cl. 705/26

(57) ABSTRACT

A system and method for historical database training of non-linear models for use in electronic commerce. The non-linear model is trained with training sets from a stream of electronic commerce data. The system detects availability of new training data, and constructs a training set from the corresponding input data. Over time, many training sets are presented to the non-linear model. When multiple presentations are needed to effectively train the non-linear model, a buffer of training sets is filled and updated as new training data becomes available. Once the buffer is full, a new training set bumps the oldest training set from the buffer. The training sets are presented one or more times each time a new training set is constructed. An historical database may be used to construct training sets for the non-linear model. The non-linear model may be trained retrospectively by searching the historical database and constructing training sets.

### BACKGROUND OF THE INVENTION

1. Field of the Invention

The present invention relates generally to the field of non-linear models. More particularly, the present invention relates to a system for historical database training of non-linear models in e-commerce systems.

2. Description of the Related Art

Many predictive systems may be characterized by the use of an internal model which represents a process or system for which predictions are made. Predictive model types may be linear, non-linear, stochastic, or analytical, among others. However, for complex phenomena non-linear models may generally be preferred due to their ability to capture non-linear dependencies among various attributes of the phenomena. Examples of non-linear models may include neural networks and support vector machines (SVMs).

Generally, a model is trained with training input data, e.g., historical data, in order to reflect salient attributes and behaviors of the phenomena being modeled. In the training process, sets of training input data may be provided as inputs to the model, and the model output may be compared to corresponding sets of desired outputs. The resulting error is often used to adjust weights or coefficients in the model until the model generates the correct output (within some error margin) for each set of training input data. The model is considered to be in “training mode” during this process. After training, the model may receive real-world data as inputs, and provide predictive output information which may be used to control the process or system or make decisions regarding the modeled phenomena. It is desirable to allow for on-line training of predictive models (e.g., non-linear models, including neural networks and support vector machines), particularly in the field of e-commerce.

Predictive models may be used for analysis, control, and decision making in many areas, including electronic commerce (i.e., e-commerce), e-marketplaces, financial (e.g., stocks and/or bonds) markets and systems, data analysis, data mining, process measurement, optimization (e.g., optimized decision making, real-time optimization), quality control, as well as any other field or domain where predictive or classification models may be useful and where the object being modeled may be expressed abstractly. For example, quality control in commerce is increasingly important. The control of quality and the reproducibility of quality may be the focus of many efforts. For example, in Europe, quality is the focus of the ISO (International Standards Organization, Geneva, Switzerland) 9000 standards. These rigorous standards provide for quality assurance in production, installation, final inspection, and testing of processes. They also provide guidelines for quality assurance between a supplier and customer.

A simple example of a process 1212 to be controlled is shown in FIG. 14. This example is presented merely for purposes of illustration. The example process 1212 is the baking of a cake. Inputs 1222 (e.g., flour, sugar, milk, baking powder, lemon flavoring, etc.) may be processed in a baking process 1212 under process conditions 1906. The process conditions 1906 may be controlled process conditions. Examples of process conditions 1906 may include: mix batter until uniform, bake batter in a pan at a preset oven temperature for a preset time, remove baked cake from pan, and allow removed cake to cool to room temperature.

The output 1216 produced in this example is a cake having desired output properties 1904. For example, these desired output properties 1904 may include a cake that is: fully cooked but not burned, brown on the outside, yellow on the inside, having a suitable lemon flavoring, etc.

Referring to the general case, outputs 1216 may refer to abstract outputs, such as information, analysis, decision-making, transactions, or any other type of usable object, result, or service. The actual output properties 1904 of outputs 1216 produced in a process 1212 may be determined by a combination of all of the process conditions 1906 of process 1212 and the inputs 1222 that are utilized. Process conditions 1906 may be, for example, the properties of the inputs 1222, the speed at which process 1212 runs (also referred to as the production rate of the process 1212), the process conditions 1906 in each step or stage of the process 1212 (e.g., pricing, inventory, interest rates, delivery distances and methods, etc.), the duration of each step or stage, and so on.

FIG. 15 shows a more detailed block diagram of the various aspects of the creation of outputs 1216 using process 1212. Referring now to FIGS. 14 and 15, outputs 1216 are defined by one or more output property aim value(s) 2006 of its output properties 1904. The output property aim values 2006 of the output properties 1904 may be those which the output 1216 needs to have in order for it to be ideal for its intended end use. The objective in running process 1212 is to create outputs 1216 having output properties 1904 which match the output property aim value(s) 2006. For example, output property aim value(s) 2006 may include such parameter values as after-tax profit, inventory amounts, revenue, or any other aspect of the e-commerce or financial system.

To effectively operate process 1212, the process conditions 1906 may be maintained at one or more process condition setpoint(s) or aim value(s) 1404 (also referred to as regulatory control setpoint(s) in the example of FIG. 17, discussed below) so that the output 1216 produced has the output properties 1904 matching the desired output property aim value(s) 2006. This task may be divided into three parts or aspects for purposes of explanation.

In the first part or aspect, the process condition setpoint(s) or aim value(s) are initially set (2008) in order for the process 1212 to produce an output 1216 having the desired output property aim values 2006. Referring back to the baking of a cake example set forth above, this is analogous to deciding to set the temperature of the oven to a particular setting before beginning the baking of the cake batter. In an e-commerce application, this may involve setting payment conditions (e.g., credit rates), pricing constraints, product selection, profit margins, desired profits, desired return on investments, etc.

The second step or aspect involves measurement and adjustment of the process 1212. Specifically, process conditions 1906 may be measured to produce process condition measurement(s) 1224. The process condition measurement(s) 1224 may be used to generate adjustment(s) 1208 (also referred to as controller output data in the example of FIG. 4, discussed below) to controllable process state(s) 2002 so as to hold the process conditions 1906 as close as possible to process condition setpoint(s) 1404. Referring again to the baking of a cake example above, this is analogous to the way the oven measures the temperature and turns the heating element on or off so as to maintain the temperature of the oven at the desired temperature value. In the e-commerce application, this may involve monitoring prices, profit margins, etc.,

The third stage or aspect involves holding output property measurements 1304 of the output properties 1904 as close as possible to the output property aim value(s) 2006. This involves producing output property measurement(s) 1304 based on the output properties 1904 of the output 1216. From these measurements, adjustments to process condition setpoint(s) 1402 may be made so as to maintain process condition(s) 1906. Referring again to the baking of a cake example above, this is analogous to measuring how well the cake is baked. This could be done, for example, by sticking a toothpick into the cake and adjusting the temperature during the baking step so that the toothpick eventually comes out clean. In an e-commerce system, the adjustments may be made to such parameters as pricing, inventory levels, inducements, discounts, etc.

It should be understood that the previous description is intended only to show general conditions and potential problems associated with producing outputs of predetermined quality and properties. It may be readily understood that there may be many variations and combinations of tasks that are encountered in a given process.

Thus, one embodiment of a process may be generalized as being made up of five basic steps or stages as follows: (1) the initial setting of process condition setpoint(s) 2008; (2) producing process condition measurement(s) 1224 of the process conditions 1906; (3) adjusting 1208 controllable process state(s) 2002 in response to the process condition measurement(s) 1224; (4) producing output property measurement(s) 1304 based on output properties 1904 of the created output 1216; and (5) adjusting 1402 process condition setpoint(s) 1404 in response to the output property measurement(s) 1304. The explanation which follows explains the problems associated with meeting and optimizing these five steps.

As shown above, the second and fourth steps or stages involve measurement 1224 of process conditions 1906 and measurement 1304 of output properties 1904, respectively. Such measurements may sometimes be very difficult, if not impossible, to effectively perform in certain situations.

For many outputs, the important output properties 1904 relate to the end use of the output and not to the process conditions 1906 of the process 1212. One illustration of this involves an e-commerce system. An example of an output property 1904 of an e-commerce system is the change in profitability based on timing, placement, and characteristics of an offered inducement. Another example involves the baking of a cake example set forth above. An important output property 1904 of a baked cake is how well the cake resists breaking apart when the frosting is applied. Often, the measurement of such output properties 1904 is difficult and/or time consuming and/or expensive.

An example of this problem may be shown in connection with the e-commerce system. The profitability of an e-commerce inducement, e.g., presented on an e-commerce website, may be measured over various time intervals. However, such measurements over short time intervals may be unreliable. For example, it may take a significant number of transactions before a reliable result may be obtained. In other words, determining reliable results may be slow. In this example, it may take so long to determine the results that the conditions may have changed significantly by the time the results are available. For example, reliable results of a strategy targeting the Christmas shopping season may not be available until the season is substantially over. Thus, the e-commerce system may be producing different output properties 1904 (e.g., profitability) before the results are available for use in controlling the process 1212.

It is noted that some process condition measurements 1224 may be inexpensive, take little time, and may be quite reliable. For example, inventory levels typically may be measured easily, inexpensively, quickly, and reliably. But oftentimes process conditions 1906 make such easy measurements much more difficult to achieve. For example, it may be difficult to determine current inventory levels in a global distribution network spanning multiple time zones and disparate communication infrastructures and technologies.

Regardless of whether or not measurement of a particular process condition 1906 or output property 1904 is easy or difficult to obtain, such measurement may be vitally important to the effective and necessary control of the process 1212. It may thus be appreciated that it would be preferable if a direct measurement of a specific process condition 1906 and/or output property 1904 could be obtained in an inexpensive, reliable, timely and effective manner.

As stated above, the direct measurement of the process conditions 1906 and/or the output properties 1904 is often difficult, if not impossible, to do effectively. One response to this deficiency has been the development of computer models (not shown) as predictors of desired measurements. These computer models may be used to create values used to control the process 1212 based on inputs that may not be identical to the particular process conditions 1906 and/or output properties 1904 that are critical to the control of the process 1212. In other words, these computer models may be used to develop predictions (estimates) of the particular process conditions 1906 or output properties 1904. These predictions may be used to adjust the controllable process state 2002 or the process condition setpoint 1404.

Such conventional computer models, as explained below, have limitations. To better understand these limitations and how the present invention overcomes them, a brief description of each of these conventional models is set forth.

A computer-based fundamental model (not shown) uses known information about the process 1212 to predict desired unknown information, such as output conditions 1906 and output properties 1904. A fundamental model may be based on scientific, engineering, financial, and/or business principles, among others. Such principles may include the conservation of material and energy, the equality of forces, supply and demand, and so on. These basic principles may be expressed as equations which are solved mathematically or numerically, usually using a computer program. Once solved, these equations may give the desired prediction of unknown information.

Conventional computer fundamental models have significant limitations, such as: (1) They may be difficult to create since the process 1212 may be described at the level of scientific or technical understanding, which is usually very detailed; (2) Not all processes 1212 are understood in basic principles in a way that may be computer modeled; (3) Some output properties 1904 may not be adequately described by the results of the computer fundamental models; and (4) The number of skilled computer model builders is limited, and the cost associated with building such models is thus quite high. These problems result in computer fundamental models being practical only in some cases where measurement is difficult or impossible to achieve.

Another conventional approach to solving measurement problems is the use of a computer-based (or empirical) statistical model (not shown). Such a computer-based statistical model may use known information about process 1212 to determine desired information that may not be effectively measured. A statistical model may be based on the correlation of measurable process conditions 1906 or output properties 1904 of the process 1212.

To use an example of a computer-based statistical model, assume that it is desired to be able to predict the profitability of an inducement (e.g., a discount coupon), output 1216. This may be difficult to measure directly, and may take considerable time to perform. In order to build a computer-based statistical model which will produce this desired output property 1904 information, the model builder would need to have a base of experience, including known information and actual measurements of desired unknown information. For example, known information may include the duration of the inducement (e.g., the effective lifetime of the coupon). Actual measurements of desired unknown information may be the actual measurements of the profit differentials due to the offered inducement.

A mathematical relationship (i.e., an equation) between the known information and the desired unknown information may be created by the developer of the empirical statistical model. The relationship may contain one or more constants (which may be assigned numerical values) which affect the value of the predicted information from any given known information. A computer program may use many different measurements of known information, with their corresponding actual measurements of desired unknown information, to adjust these constants so that the best possible prediction results may be achieved by the empirical statistical model. Such a computer program, for example, may use non-linear regression.

Computer-based statistical models may sometimes predict output properties 1904 which may not be well described by computer fundamental models. However, there may be significant problems associated with computer statistical models, which include the following: (1) Computer statistical models require a good design of the model relationships (i.e., the equations) or the predictions will be poor; (2) Statistical methods used to adjust the constants typically may be difficult to use; (3) Good adjustment of the constants may not always be achieved in such statistical models; and (4) As is the case with fundamental models, the number of skilled statistical model builders is limited, and thus the cost of creating and maintaining such statistical models is high.

The result of these deficiencies is that computer-based empirical statistical models may be practical in only some cases where the process conditions 1906 and/or output properties may not be effectively measured.

As set forth above, there are considerable deficiencies in conventional approaches to obtaining desired measurements for the process conditions 1906 and output properties 1904 using conventional direct measurement, computer fundamental models, and computer statistical models. Some of these deficiencies are as follows: (1) Output properties 1904 may often be difficult to measure; (2) Process conditions 1906 may often be difficult to measure; (3) Determining the initial value or settings of the process conditions 1906 when making a new output 1216 is often difficult; and (4) Conventional computer models work only in a small percentage of cases when used as substitutes for measurements.

### SUMMARY OF THE INVENTION

A system and method are presented for historical database training of non-linear models (e.g., neural networks, or support vector machines) for use in electronic commerce (e-commerce). The non-linear model may train by retrieving training sets from a stream of process data. The non-linear model may detect the availability of new training data, and may construct a training set by retrieving the corresponding input data. The non-linear model may be trained using the training set. Over time, many training sets may be presented to the non-linear model.

The non-linear model may detect training input data in several ways. In one approach, the non-linear model may monitor for changes in data values of training input data. A change may indicate that new data are available. In a second approach, the non-linear model may compute changes in raw training input data from one cycle to the next. The changes may be indicative of the action of human operators or other actions in the process. In a third mode, a historical database may be used and the non-linear model may monitor for changes in a timestamp of the training input data. Laboratory data may be used as training input data in this approach.

When new training input data are detected, the non-linear model may construct a training set by retrieving input data corresponding to the new training input data. Often, the current or most recent values of the input data may be used. When a historical database provides both the training input data and the input data, the input data are retrieved from the historical database for a time period selected using the timestamps of the training input data.

For some non-linear models or training situations, multiple presentations of each training set may be needed to effectively train the non-linear model. In this case, a buffer of training sets (e.g., a FIFO—first in, first out—buffer) is filled and updated as new training input data becomes available. The size of the buffer may be selected in accordance with the training needs of the non-linear model. Once the buffer is full, a new training set may bump the oldest training set from the buffer. The training sets in the buffer may be presented one or more times each time a new training set is constructed. It is noted that the use of a buffer to store training sets is but one example of storage means for the training sets, and that other storage means are also contemplated, including lists (such as queues and stacks), databases, and arrays, among others.

If a historical database is used, the non-linear model may be trained retrospectively. Training sets may be constructed by searching the historical database over a time span of interest for training input data. When training input data are found, an input data time is selected using the training input data timestamps, and the training set is constructed by retrieving the input data corresponding to the input data time. Multiple presentations may also be used in the retrospective training approach.

In one embodiment, the method may include building a first training set using training data, where the training data may include one or more timestamps indicating a chronology of the training data and one or more process parameter values corresponding to each timestamp. The first training set may include process parameter values corresponding to a first time period in the chronology. In one embodiment, building the first training set may include retrieving the training data from a historical database, selecting a training data time period based on the one or more timestamps, and retrieving the process parameter values from the training data indicated by the training data time period. Thus, the first training set may include retrieved process parameter values in chronological order over the selected training data time period. The non-linear model may then be trained using the first training set.

Then, a second training set may be generated by removing at least a subset of the parameter values of the first training set, preferably the oldest parameter values of the training set, and adding new parameter values from the training data based on the timestamps to generate a second training set. Thus, the second training set may correspond to a second time period in the chronology. The non-linear model may then be trained using the second training set. The process may then be repeated, successively updating the training set to generate new training sets by removing old data and adding new data based on the timestamps, and training the non-linear model with each training set.

Using data pointers, easy access to many process data systems may be achieved. A modular approach with natural language configuration of the non-linear model may be used to implement the non-linear model. Expert system functions may be provided in the modular non-linear model to provide decision-making functions for use in control, analysis, management, or other areas of application.

Non-linear models may be applied in a number of fields. Fields which may benefit from the use of on-line training of a non-linear model may include: electronic commerce (i.e., e-commerce), e-marketplaces, financial (e.g., stocks and/or bonds) markets and systems, data analysis, data mining, process measurement, optimization (e.g., optimized decision making, real-time optimization), quality control, as well as any other field or domain where predictive or classification models may be useful and where the object being modeled may be expressed abstractly.

### BRIEF DESCRIPTION OF THE DRAWINGS

Other objects and advantages of the invention will become apparent upon reading the following detailed description and upon reference to the accompanying drawings in which:

FIG. 1 illustrates an exemplary computer system according to one embodiment of the present invention;

FIG. 2 illustrates a first e-commerce system that operates according to various embodiments of the present invention;

FIG. 3 illustrates a second e-commerce system that operates according to various embodiments of the present invention;

FIG. 4 illustrates a third e-commerce system that operates according to various embodiments of the present invention;

FIG. 5 is a flowchart diagram illustrating operation of an e-commerce transaction according to one embodiment of the present invention;

FIG. 6 is a flowchart illustrating operation of an alternate e-commerce transaction according to one embodiment of the present invention;

FIG. 7a is a block diagram illustrating an overview of optimization according to one embodiment;

FIG. 7b is a dataflow diagram illustrating an overview of optimization according to one embodiment;

FIG. 8 illustrates a network system suitable for implementing an e-marketplace, according to one embodiment;

FIGS. 9a and 9b illustrate an e-marketplace with transaction optimization, according to one embodiment, wherein FIG. 9a illustrates various participants providing transaction requirements to the e-marketplace optimization server, and FIG. 9b illustrates various participants receiving transaction results from the e-marketplace optimization server;

FIG. 10 is a flowchart of a transaction optimization process, according to one embodiment;

FIGS. 11a and 11b illustrate a system for optimizing an e-marketplace, according to one embodiment;

FIG. 12 is a flowchart diagram illustrating a method of creating and using models and optimization procedures to model and/or control a business process, according to one embodiment;

FIG. 13 illustrates a support vector machine implementation, according to one embodiment;

FIG. 14 is a high level block diagram illustrating the key aspects of a process 1212 having process conditions 1906 used to produce outputs 1216 having output properties 1904 from inputs 1222, according to one embodiment;

FIG. 15 illustrates the various steps and parameters which may be used to perform the control of process 1212 to produce outputs 1216 from inputs 1222, according to one embodiment;

FIG. 16 is a nomenclature diagram illustrating one embodiment of the present invention at a high level;

FIG. 17 is a representation of the architecture of an embodiment of the present invention;

FIG. 18 is a high level block diagram of the six broad steps included in one embodiment of a non-linear model process system and method according to the present invention;

FIG. 19 is an intermediate block diagram of steps and modules included in the store input data and training input data step 102 of FIG. 18, according to one embodiment;

FIG. 20 is an intermediate block diagram of steps and modules included in the configure and train non-linear model step 104 of FIG. 18, according to one embodiment;

FIG. 21 is an intermediate block diagram of input steps and modules included in the predict output data using non-linear model step 106 of FIG. 18, according to one embodiment;

FIG. 22 is an intermediate block diagram of steps and modules included in the retrain non-linear model step 108 of FIG. 18, according to one embodiment;

FIG. 23 is an intermediate block diagram of steps and modules included in the enable/disable control step 110 of FIG. 18, according to one embodiment;

FIG. 24 is an intermediate block diagram of steps and modules included in the control process using output data step 112 of FIG. 18, according to one embodiment;

FIG. 25 is a detailed block diagram of the configure non-linear model step 302 of FIG. 20, according to one embodiment;

FIG. 26 is a detailed block diagram of the new training input data step 306 of FIG. 20, according to one embodiment;

FIG. 27 is a detailed block diagram of the train non-linear model step 308 of FIG. 20, according to one embodiment;

FIG. 28 is a detailed block diagram of the error acceptable step 310 of FIG. 20, according to one embodiment;

FIG. 29 is a representation of the architecture of an embodiment of the present invention having the additional capability of using laboratory values from a historical database 1210;

FIG. 30 is an embodiment of controller 1202 of FIGS. 17 and 29 having a supervisory controller 1408 and a regulatory controller 1406;

FIG. 31 illustrates various embodiments of controller 1202 of FIG. 30 used in the architecture of FIG. 17;

FIG. 32 is a modular version of block 1502 of FIG. 31 illustrating various different types of modules that may be utilized with a modular non-linear model 1206, according to one embodiment;

FIG. 33 illustrates an architecture for block 1502 of FIGS. 31 and 32 having a plurality of modular non-linear models 1702-1702ⁿ with pointers 1710-1710ⁿ pointing to a limited set of non-linear model procedures 1704-1704ⁿ, according to one embodiment;

FIG. 34 illustrates an alternate architecture for block 1502 of FIGS. 31 and 32 having a plurality of modular non-linear models 1702-1702ⁿ with pointers 1710-1710ⁿ to a limited set of non-linear model procedures 1704-1704ⁿ , and with parameter pointers 1802-1802ⁿ to a limited set of system parameter storage areas 1806-1806ⁿ, according to one embodiment;

FIG. 35 is an exploded block diagram illustrating the various parameters and aspects that may make up the non-linear model 1206, according to one embodiment;

FIG. 36 is an exploded block diagram of the input data pointer 3504 and the output data pointer 3506 of the non-linear model 1206 of FIG. 35, according to one embodiment;

FIG. 37 is an exploded block diagram of the prediction timing control 3512 and the training timing control 3514 of the non-linear model 1206 of FIG. 35, according to one embodiment;

FIG. 38 is an exploded block diagram of various examples and aspects of controllers 1202 of FIG. 17 and controllers 1406 and 1408 of FIG. 30, according to one embodiment;

FIG. 39 is a representative computer display of one embodiment of the present invention illustrating part of the configuration specification of the non-linear model 1206, according to one embodiment;

FIG. 40 is a representative computer display of one embodiment of the present invention illustrating part of the data specification of the non-linear model 1206, according to one embodiment;

FIG. 41 illustrates a computer screen with a pop-up menu for specifying the data system element of the data specification of FIG. 40, according to one embodiment;

FIG. 42 illustrates a computer screen with detailed individual items of the data specification display of FIG. 40, according to one embodiment;

FIG. 43 is a detailed block diagram of the enable control step 602 of FIG. 23, according to one embodiment;

FIG. 44 is a detailed block diagram of steps and modules 2502, 2504 and 2506 of FIG. 25, according to one embodiment; and

FIG. 45 is a detailed block diagram of steps and modules 2508, 2510, 2512 and 2514 of FIG. 25, according to one embodiment.

While the invention is susceptible to various modifications and alternative forms, specific embodiments thereof may be shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF SEVERAL EMBODIMENTS

Incorporation by Reference

U.S. Pat. No. 5,950,146, titled “Support Vector Method For Function Estimation”, whose inventor is Vladimir Vapnik, and which issued on Sep. 7, 1999, is hereby incorporated by reference in its entirety as though fully and completely set forth herein.

U.S. Pat. No. 5,649,068, titled “Pattern Recognition System Using Support Vectors”, whose inventors are Bernard Boser, Isabelle Guyon, and Vladimir Vapnik, and which issued on Jul. 15, 1997, is hereby incorporated by reference in its entirety as though fully and completely set forth herein.

U.S. Pat. No. 5,058,043, titled “Batch Process Control Using Expert Systems”, whose inventor is Richard D. Skeirik, and which issued on Oct. 15, 1991, is hereby incorporated by reference in its entirety as though fully and completely set forth herein.

U.S. Pat. No. 5,006,992, titled “Process Control System With Reconfigurable Expert Rules and Control Modules”, whose inventor is Richard D. Skeirik, and which issued on Apr. 9, 1991, is hereby incorporated by reference in its entirety as though fully and completely set forth herein.

U.S. Pat. No. 4,965,742, titled “Process Control System With On-Line Reconfigurable Modules”, whose inventor is Richard D. Skeirik, and which issued on Oct. 23, 1990, is hereby incorporated by reference in its entirety as though fully and completely set forth herein.

U.S. Pat. No. 4,920,499, titled “Expert System With Natural-Language Rule Updating”, whose inventor is Richard D. Skeirik, and which issued on Apr. 24, 1990, is hereby incorporated by reference in its entirety as though fully and completely set forth herein.

U.S. Pat. No. 4,910,691, titled “Process Control System with Multiple Module Sequence Options”, whose inventor is Richard D. Skeirik, and which issued on Mar. 20, 1990, is hereby incorporated by reference in its entirety as though fully and completely set forth herein.

U.S. Pat. No. 4,907,167, titled “Process Control System with Action Logging”, whose inventor is Richard D. Skeirik, and which issued on Mar. 6, 1990, is hereby incorporated by reference in its entirety as though fully and completely set forth herein.

U.S. Pat. No. 4,884,217, titled “Expert System with Three Classes of Rules”, whose inventors are Richard D. Skeirik and Frank O. DeCaria, and which issued on Nov. 28, 1989, is hereby incorporated by reference in its entirety as though fully and completely set forth herein.

U.S. Pat. No. 5,212,765, titled “On-Line Training Neural Network System for Process Control”, whose inventor is Richard D. Skeirik, and which issued on May 18, 1993, is hereby incorporated by reference in its entirety as though fully and completely set forth herein.

U.S. Pat. No. 5,826,249, titled “Historical Database Training Method for Neural Networks”, whose inventor is Richard D. Skeirik, and which issued on Oct. 20, 1998, is hereby incorporated by reference in its entirety as though fully and completely set forth herein.

U.S. Pat. No. 5,353,207, titled “Residual Activation Neural Network”, whose inventors are James D. Keeler, Eric J. Hartman, Kadir Liano, and Ralph B. Ferguson, and which issued on Oct. 4, 1994, is hereby incorporated by reference in its entirety as though fully and completely set forth herein.

U.S. patent application Ser. No. 09/493,951, titled “System And Method For Optimization Including Cross-Record Constraints”, whose inventors are Frank D. Caruana, Pinchas Ben-Or, Abhijit Chatteree, Timothy L. Smith, Thomas J. Traughber, Rhonda Alexander, Michael E. Niemann, Matthew M. Harris and Steven J. Waldschmidt, and filed on Jan. 28, 2000, is hereby incorporated by reference in its entirety as though fully and completely set forth herein.

U.S. patent application Ser. No. 09/493,404, titled “System And Method For Generating Inducements During E-Commerce Transactions Using An Optimization Process”, whose inventors are Edmond Herschap III, Timothy J. Magnuson, Thomas J. Traughber, and Kasey White, and filed on Jan. 28, 2000, is hereby incorporated by reference in its entirety as though fully and completely set forth herein.

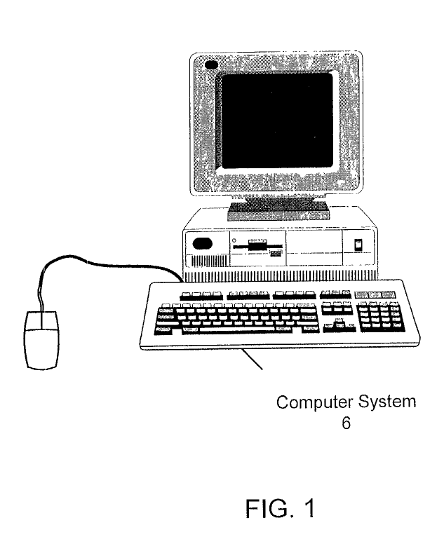

FIG. 1—Computer System

FIG. 1 illustrates a computer system 6 operable to execute a non-linear model for performing modeling and/or control operations. Several embodiments of methods for creating and/or using a non-linear model are described below. The computer system 6 may be any type of computer system, including a personal computer system, mainframe computer system, workstation, network appliance, Internet appliance, personal digital assistant (PDA), television system or other device. In general, the term “computer system” may be broadly defined to encompass any device having at least one processor that executes instructions from a memory medium.

As shown in FIG. 1, the computer system 6 may include a display device operable to display operations associated with the non-linear model. The display device may also be operable to display a graphical user interface of process or control operations. The graphical user interface may comprise any type of graphical user interface, e.g., depending on the computing platform.

The computer system 6 may include a memory medium(s) on which one or more computer programs or software components according to one embodiment of the present invention may be stored. For example, the memory medium may store one or more non-linear model software programs (e.g., neural networks or support vector machines) which are executable to perform the methods described herein. Also, the memory medium may store a programming development environment application used to create and/or execute non-linear model software programs. The memory medium may also store operating system software, as well as other software for operation of the computer system.

The term “memory medium” is intended to include various types of memory or storage, including an installation medium, e.g., a CD-ROM, floppy disks, or tape device; a computer system memory or random access memory such as DRAM, SRAM, EDO RAM, Rambus RAM, etc.; or a non-volatile memory such as a magnetic media, e.g., a hard drive, or optical storage. The memory medium may comprise other types of memory or storage as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution.

As used herein, the term “neural network” refers to at least one software program, or other executable implementation (e.g., an FPGA), that implements a neural network as described herein. The neural network software program may be executed by a processor, such as in a computer system. Thus the various neural network embodiments described below are preferably implemented as a software program executing on a computer system.

As used herein, the term “support vector machine” refers to at least one software program, or other executable implementation (e.g., an FPGA), that implements a support vector machine as described herein. The support vector machine software program may be executed by a processor, such as in a computer system. Thus the various support vector machine embodiments described below are preferably implemented as a software program executing on a computer system.

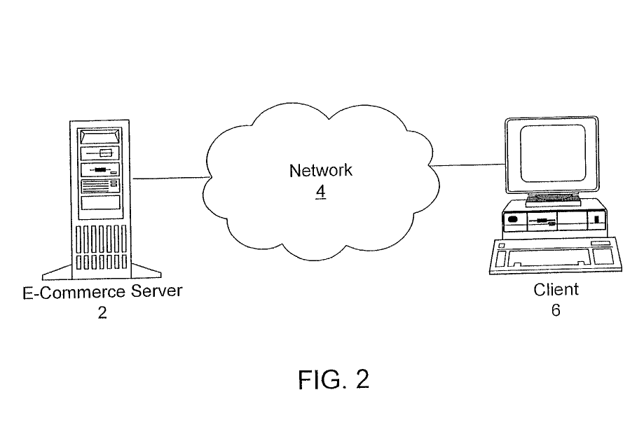

FIGS. 2 through 4—Various Network Systems for Performing E-Commerce

FIGS. 2, 3, and 4 illustrate simplified and exemplary e-commerce or Internet commerce systems that operate according to various embodiments of the present invention. The systems shown in FIGS. 2, 3, and 4 may utilize an optimization process to provide targeted inducements, e.g., promotions or advertising, to a user, such as during an e-commerce transaction. The systems shown in FIGS. 2, 3, and 4 may also utilize an optimization process to configure the e-commerce site (also called a web site) of an e-commerce vendor.

As shown in the e-commerce system of FIG. 2, the e-commerce system may include an e-commerce server 2. The e-commerce server 2 is preferably maintained by a vendor who offers products, such as goods or services, for sale over a network, such as the Internet. One example of an e-commerce vendor is Amazon.com, which sells books and other items over the Internet.

As used herein, the term “product” is intended to include various types of goods or services, such as books, music, furniture, on-line auction items, clothing, consumer electronics, software, medical supplies, computer systems etc., or various services such as loans (e.g., auto, mortgage, and home re-financing loans), securities (e.g., CDs, stocks, retirement accounts, cash management accounts, bonds, and mutual funds), ISP service, content subscription services, travel services, or insurance (e.g., life, health, auto, and home owner's insurance), among others.

As shown, the e-commerce server 2 may be connected to a network 4, preferably the Internet. The Internet is currently the primary mechanism for performing e-commerce. However, the network 4 may be any of various types of wide-area networks and/or local area networks, or networks of networks, such as the Internet, which connects computers and/or networks of computers together, thereby providing the connectivity for enabling e-commerce to operate. Thus, the network 4 may be any of various types of networks, including wired networks, wireless networks, etc. In the preferred embodiment, the network 4 is the Internet using standard protocols such as TCP/IP, http, and html or xml.

A client computer 6 may also be connected to the Internet. The client system 6 may be a computer system, network appliance, Internet appliance, personal digital assistant (PDA) or other system. The client computer system 6 may execute web browser software for allowing a user of the client computer 6 to browse and/or search the network 4, e.g., the Internet, as well as enabling the user to conduct transactions or commerce over the network 4. The network 4 is also referred to herein as the Internet 4. When the user of the client computer 6 desires to browse or purchase a product from a vendor over the Internet 4, the web browser software preferably accesses the e-commerce site of the respective e-commerce server, such as e-commerce server 2. The client 6 may access a web page of the e-commerce server 2 directly or may access the site through a link from a third party. The user of the client computer 6 may also be referred to as a customer.

When the client web browser accesses the web page of the e-commerce server 2, the e-commerce server 2 provides various data and information to the client browser on the client system 6, possibly including a graphical user interface (GUI) that displays the products offered, descriptions and prices of these products, and other information that would typically be useful to the purchaser of a product.

The e-commerce server 2, or another server, may also provide one or more inducements to the client computer system 6, wherein the inducements may be generated using an optimization process or an experiment engine. The e-commerce server 2 may include an optimizer, such as an optimization software program, which is executable to generate the one or more inducements in response to various information related to the e-commerce transaction. The operation of the optimizer in generating the inducements to be provided is discussed further below.

As used herein, the term “inducement” is intended to include one or more of advertising, promotions, discounts, offers or other types of incentives which may be provided to the user. In general, the purpose of the inducement is to achieve a desired commercial result with respect to a user. For example, one purpose of the inducement may be to encourage or entice the user to complete the purchase of the product, or to encourage or entice the user to purchase additional products, either from the current e-commerce vendor or another vendor. For example, an inducement may be a discount on purchase of a product from the e-commerce vendor, or a discount on purchase of a product from another vendor. An inducement may also be an offer of a free product with purchase of another product. The inducement may also be a reduction or discount in shipping charges associated with the product, or a credit for future purchases, or any other type of incentive. Another purpose of the inducement may be to encourage or entice the user to select or subscribe to a certain e-commerce site, or to encourage the user to provide desired information, such as user demographic information.

The inducement(s) may be provided to the user during any part of an e-commerce transaction. As used herein, an “e-commerce transaction” may include a portion, subset, or all of any stage of a user purchase of a product from an e-commerce site, including selection of the e-commerce site, browsing of products on the e-commerce site, selection of one or more products from the e-commerce site, such as using a “shopping cart” metaphor, purchasing the one or more products or “checking out,” and delivery of the product. During any stage of the e-commerce transaction, one or more inducements may be generated and displayed to the user. In one embodiment, the optimization process may determine times, such as during a user's “click flow” in navigating the e-commerce site, for provision of the inducements to the user. Thus the optimization process may optimize the types of inducements provided as well as the timing of delivery of the inducements.

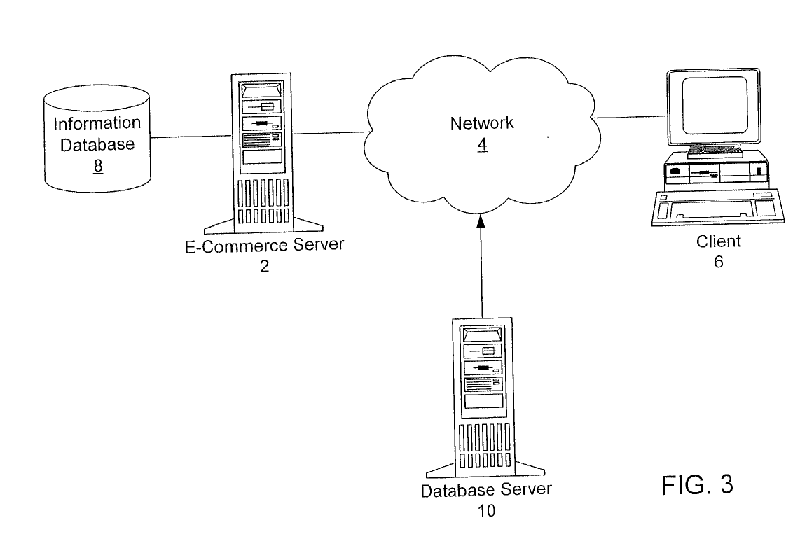

As shown in the e-commerce system of FIG. 3, an information database 8 may be coupled to or comprised in the e-commerce server 2. Alternatively, or in addition, a separate database server 10 may be coupled to the network 4, wherein the separate database server 10 includes an information database 8 (not shown). The information database 8 and/or database server 10 may store information related to the e-commerce transaction, as described above. The e-commerce server 2 may access this information from the information database 8 and/or the database server 10 for use by the optimization program in generating the one or more inducements to display to a user. Thus, the e-commerce server 2 may collect and/or store its own information database 8, and/or may access this information from the separate database server 10.

As noted above, the information database 8 and/or database server 10 may store information related to the e-commerce transaction. The information “related to the e-commerce transaction” may include user demographic information, i.e., demographic information of users, such as age, sex, marital status, occupation, financial status, income level, purchasing habits, hobbies, past transactions of the user, past purchases of the user, commercial activities of the user, affiliations, memberships, associations, historical profiles, etc. The information “related to the e-commerce transaction” may also include “user site navigation information”, which comprises information on the user's current or prior navigation of an e-commerce site of the e-commerce vendor. For example, where the e-commerce vendor maintains an e-commerce site, and the site receives input from a user during any stage of an e-commerce transaction, the user site navigation information may comprise information on the user's current navigation of the e-commerce site of the e-commerce vendor. The information “related to the e-commerce transaction” may also include time and date information, inventory information of products offered by the e-commerce vendor, and/or competitive information of competitors to the e-commerce vendor. The information “related to the e-commerce transaction” may further include number and dollar amount of products being purchased (or comprised in the shopping cart), “costs” associated with various inducements, the cost of the transaction being conducted, as well as the results from previous transactions. The information “related to the e-commerce transaction” may also include various other types of information related to the e-commerce transaction or information which is useable in selecting or generating inducements to display to users during an e-commerce transaction.

As noted above, the e-commerce server 2 may include an optimization process, such as an optimization software program, which is executable to use the information “related to the e-commerce transaction” from the information database 8 or the database server 10 to generate the one or more inducements to be provided to the user.

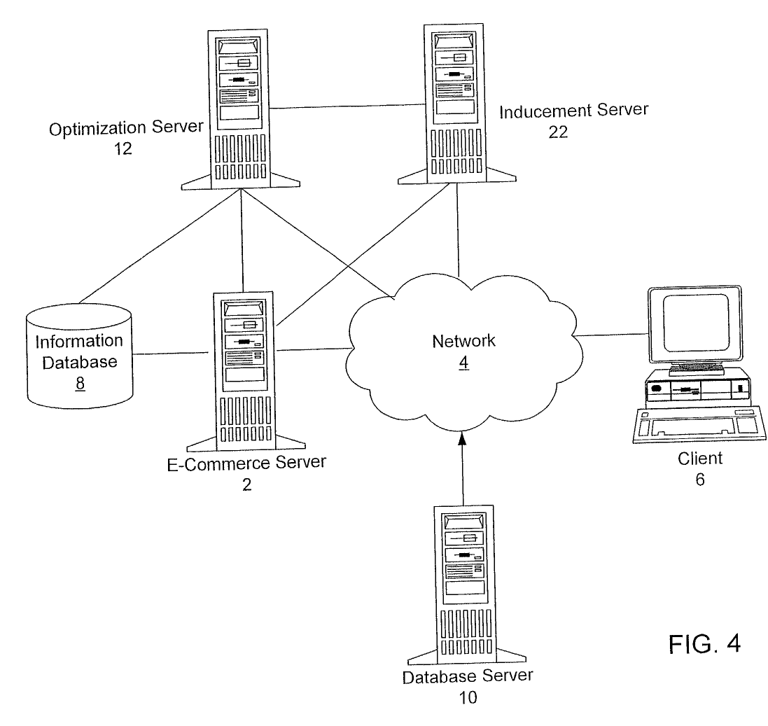

As shown in the e-commerce system of FIG. 4, the e-commerce system may also include a separate optimization server 12 and/or a separate inducement server 22. As noted above, the e-commerce server 2 may instead implement the functions of both the optimization server 12 and the inducement server 22.

The optimization server 12 may couple to the information database 8 and/or may couple through the Internet to the database server 10. Alternatively, the information database 8 may be comprised in the optimization server 12. The optimization server 12 may also couple to the e-commerce server 2.

The optimization server 12 may include the optimization software program and may execute the optimization software program using the information to generate the one or more inducements to be provided to the user. Thus, the optimization software program may be executed by the e-commerce server 2 or by the separate optimization server 12.

The optimization server 12 may also store the inducements which are provided to the client computer system 6, or the inducements may be provided by the e-commerce server 2. The optimization server 12 may be operated directly by the e-commerce vendor who operates the e-commerce server 2, or by a third party company. Thus, the optimization server 12 may offload or supplement the operation of the e-commerce server 2, i.e., offload this task from the e-commerce vendor.

The system may also include a separate inducement server 22 which may couple to the Internet 4 as well as to one or both of the optimization server 12 and the e-commerce server 2. The inducement server 22 may operate to receive information regarding inducements generated by the optimization software program, either from the e-commerce server 2 or the optimization server 12, and source the inducements to the client 6. Alternatively, the inducement server 22 may also include the optimization software program for generating the inducements to be provided to the client computer system 6. The inducement server 22 may be operated directly by the e-commerce vendor who operates the e-commerce server 2, by the third party company who operates the optimization server 12, or by a separate third party company. Thus, the inducement server 22 may offload or supplement the operation of the e-commerce server 2 and/or the optimization server 12, i.e., offload this task from the e-commerce vendor or the optimization provider who operates the optimization server 12.

In the e-commerce system of FIG. 4, one or both of the optimization server 12 or the inducement server 22 may not be coupled to the Internet for security reasons, and thus the optimization server 12 and/or inducement server 22 may use other means for communicating with the e-commerce server 2. For example, the optimization server 12 and/or inducement server 22 may connect directly to the e-commerce server 2, or directly to each other, (not through the Internet), e.g., through a direct connection such as a dedicated T1 line, frame relay, Ethernet LAN, DSL, or other dedicated (and presumably more secure) communication channel.

It is noted that the e-commerce systems of FIGS. 2, 3, and 4 are exemplary e-commerce systems. Thus, various different embodiments of e-commerce systems may also be used, as desired. The e-commerce systems shown in FIGS. 2, 3, and 4 may be implemented using one or more computer systems, e.g., a single server or a number of distributed servers, connected in various ways, as desired.

Also, FIGS. 2, 3, and 4 illustrate exemplary embodiments of e-commerce systems including one e-commerce server 2, one client computer system 6, one optimization server 12, and one inducement server 22 which may be connected to the Internet 4. However, it is noted that alternate e-commerce systems may utilize any number of e-commerce servers 2, clients 6, optimization servers 12, and/or inducement servers 22.

Further, in addition to the various servers described above, an e-commerce system may include various other components or functions, such as credit card verification, payment, inventory, shipping, among others.

Each of the e-commerce server 2, optimization server 12, and/or the inducement server 22 may include various standard components such as one or more processors or central processing units and one or more memory media, and other standard components, e.g., a display device, input devices, a power supply, etc. Each of the e-commerce server 2, optimization server 12, and/or the inducement server 22 may also be implemented as two or more different computer systems.

At least one of the e-commerce server 2, optimization server 12, and/or the inducement server 22 preferably includes a memory medium on which computer programs are stored. Also, the servers 2, 12 and/or 22 may take various forms, including a computer system, mainframe computer system, workstation, or other device. In general, the term “computer server” or “server” may be broadly defined to encompass any device having a processor that executes instructions from a memory medium.

The memory medium may store an optimization software program for implementing the optimized inducement generation process. The software program may be implemented in any of various ways, including procedure-based techniques, component-based techniques, and/or object-oriented techniques, among others. For example, the software program may be implemented using ActiveX controls, C++ objects, Java objects, Microsoft Foundation Classes (MFC), or other technologies or methodologies, as desired. A CPU of one of the servers 2, 12 or 22 executing code and data from the memory medium comprises a means for implementing an optimized inducement generation process according to the methods or flowcharts described below.

Various embodiments further include receiving or storing instructions and/or data implemented in accordance with the foregoing description upon a carrier medium. Suitable carrier media include memory media or storage media such as magnetic or optical media, e.g., disk or CD-ROM, as well as signals such as electrical, electromagnetic, or digital signals, conveyed via a communication medium such as networks and/or a wireless link.

The optimization server 12, the e-commerce server 2, and/or the inducement server 22 may be programmed according to one embodiment to generate and/or provide one or more inducements to a user conducting an e-commerce transaction. In the following description, for convenience, the e-commerce system is described assuming the e-commerce server 2 implements or executes the optimization process, i.e., executes the optimization software program (or implements the function of the optimization server 12). This is not intended to limit various possible embodiments of e-commerce systems that operate according to various embodiments of the present invention.

Targeted inducements may provide a number of benefits to e-commerce vendors. First, the amount of sales and revenue for e-commerce vendors may increase, through increased closure of purchases. Targeted inducements may also provide a number of benefits to the user, including various inducements or incentives to the user that add value to the user's purchases.

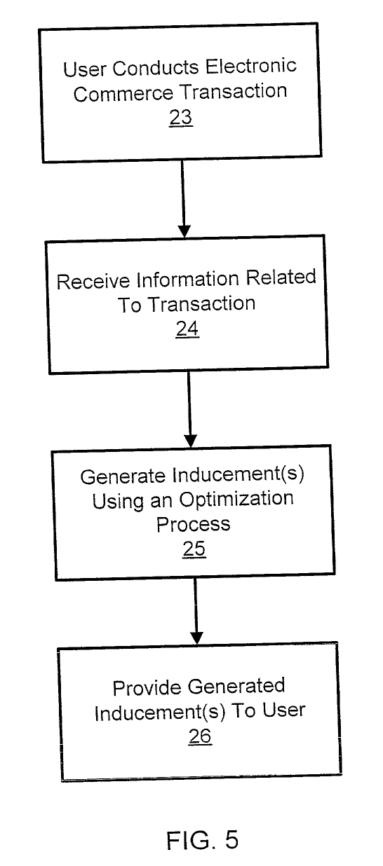

FIG. 5—Providing Optimized Inducements to a User Conducting an E-Commerce Transaction

FIG. 5 illustrates an embodiment of a method for providing one or more inducements to a user conducting an e-commerce transaction using an optimization process. It is noted that various of the steps mentioned below may occur concurrently and/or in different orders, or may be absent in some embodiments.

As shown, in step 23 the method may comprise receiving input from a user conducting an e-commerce transaction with an e-commerce vendor. For example, an e-commerce server 2 of the e-commerce vendor may receive the user input, wherein the user is conducting the e-commerce transaction with the e-commerce server 2. The user input may comprise the user selecting the e-commerce site, or the user browsing the site, e.g., the user selecting a product or viewing information about a product. The user input may also comprise the user entering various user demographic information, or information to purchase a product. Thus the user input may occur during any part of the e-commerce transaction.

As noted above, an e-commerce transaction may include a portion, subset or all of any of various stages of a user purchase of a product from an e-commerce site, including selection of the e-commerce site, browsing of products on the e-commerce site, selection of one or more products from the e-commerce site, such as using a “shopping cart” metaphor, and purchasing the one or more products or “checking out”. During any stage of the e-commerce transaction, one or more inducements may be generated and displayed to the user. As used herein, the term “user” may refer to a customer, a potential customer, a business, an organization, or any other establishment.

The client system 6 may provide identification of the user to the e-commerce server 2 or another server. Alternatively, or instead the client system 6 may provide identification of itself (i.e., the client system 6), such as with a MAC ID or other identification, to the e-commerce server 2 or another server. The client system identification may then be used by the e-commerce server 2 or another server to determine the identity of the user and/or relevant demographic information of the user.

The client system 6 may provide identification using any of various mechanisms, such as cookies, digital certificates, or any other user identification method. For example, the client system 6 may provide a cookie which indicates the identity of the user or client system 6. The client system 6 may instead provide a digital certificate which indicates the identity of the user or client system 6. A digital certificate may reside in the client computer 6 and may be used to identify the client computer 6. In general, digital certificates may be used to authenticate the user and perform a secure transaction. When the user accesses the e-commerce site of the e-commerce server 2, the client system 6 may transmit its digital certificate to the e-commerce server 2. As an alternative to the use of digital certificates, a user access to an e-commerce site may include registration and the use of passwords by users accessing the site, or may include no user identification.

In step 24 the method may include storing, receiving or collecting information, wherein the information is related to the e-commerce transaction. For example, the method may use the received digital certificate or cookie from the client system to reference the user's demographic information, such as from a database. Various types of information related to the e-commerce transaction are discussed above. This information may be used to generate the one or more inducements, as well as to update stored information pertaining to the user. Where the information is financial information received from a user, the financial information may be verified.

For example, pertinent information may be retrieved via accessing an internal or separate database 8 or database server 10, respectively, for demographic information, historical profiles, inventory information, environmental information, competitor information, or other information “related to the e-commerce transaction”. Here, a separate database may refer to a remote database server 10 maintained by the e-commerce vendor, or a database server 10 operated and/or maintained by a third party, e.g., an infomediary. Thus, the e-commerce server 2 may access information from its own database and/or a third party database. In one embodiment, the method may include collecting information during the e-commerce transaction, such as demographic information regarding the user or the user's navigation of the e-commerce site, often referred to as “click flow”. This collected information may then be used, possibly in conjunction with other information, in generating the one or more inducements.

In one embodiment, the method may include collecting demographic information of the user during the e-commerce transaction, which may then be used to generate the one or more inducements. For example, upon registration and/or during checkout, the user might be asked to supply demographic information, such as name, address, hobbies, memberships, affiliations, etc.

For another example, environmental information, such as geographic information, local weather conditions, traffic patterns, popular hobbies, etc. may be determined based on the user's address to display specific products suitable for conditions in the user's locale, such as rain gear during the wet season.

In one embodiment, in order for the e-commerce vendor to gain information about the user, the user may be presented with an opportunity to complete a survey, upon completion of which the user may receive an inducement, such as a discount toward current or future purchases. In this manner, stored user demographic information may be kept current.

In step 25 the method may generate one or more inducements in response to the information, wherein the generation of inducements uses an optimization process. In one embodiment, the generation of the one or more inducements may comprise inputting the information into an optimization process, and the optimization process generating (e.g., selecting or creating) one or more inducements in response to the information. The optimization process may use constrained optimization techniques.

The optimization process may comprise inputting the information related to the e-commerce transaction into at least one predictive model to generate one or more action variables. The action variables may comprise predictive user behaviors corresponding to the information. The action variables, as well as other data, such as constraints and an objective function, may then be input into an optimizer, which then may generate the one or more inducements to be presented to the user.

In various embodiments, the predictive model may comprise one or more linear predictive models, and/or one or more non-linear predictive models (e.g., neural networks, support vector machines). Non-linear predictive models may of course include both continuous non-linear models and non-continuous non-linear models. In various embodiments, the predictive model may comprise one or more trained neural networks. One example of a trained neural network is described in U.S. Pat. No. 5,353,207, incorporated by reference as noted above. In other embodiments, the predictive model may comprise one or more support vector machines. The predictive model may be trained using various embodiments of the method and system of the present invention, as described in greater detail below.

As is well known in the art, a neural network comprises an input layer of nodes, an output layer of nodes, and a hidden layer of nodes disposed therein, and weighted connections between the hidden layer and the input and output layers. In a neural network embodiment used in the invention, the connections and the weights of the connections essentially contain a stored representation of the e-commerce system and the user's interaction with the e-commerce system.

The neural network may be trained using back propagation with historical data or any of several other neural network training methods, as would be familiar to one skilled in the art. The above-mentioned information, including results of previous transactions of the user responding to previous inducements, which may be collected during the e-commerce transaction, may be used to update the predictive model(s). The predictive model may be updated either in a batch mode, such as once per day or once per week, or in a real-time mode, wherein the model(s) are updated continuously as new information is collected.

In one embodiment, designed experiments may be used to create the initial training input data for a non-linear model (e.g., a neural network model, or a support vector machine model). When the system or method is initially installed on an e-commerce server, the method may present a range of inducements to a subset of users or customers. The users or customers resultant behaviors to these inducement may be recorded, and then combined with demographic and other data. This information may then be used as the initial training input data for the non-linear model. This process may be repeated at various times to update the non-linear model, as desired.

As noted above, the optimizer may receive one or more constraints, wherein the constraints comprise limitations on one or more resources, and may comprise functions of the action variables. Examples of the constraints include budget limits, number of inducements allowed per customer, value of an inducement, or total value of inducements dispensed. The optimizer may also receive an objective function, wherein the objective function comprises a function of the action variables and represents the goal of the e-commerce vendor. In one embodiment, the objective function may represent a desired commercial goal of the e-commerce vendor, such as maximizing profit, or increasing market share. As another example, if the user is a habitual customer of the e-commerce vendor, the objective function may be a function of lifetime customer value, wherein lifetime customer value comprises a sum of expected cash flows over the lifetime of the customer relationship.

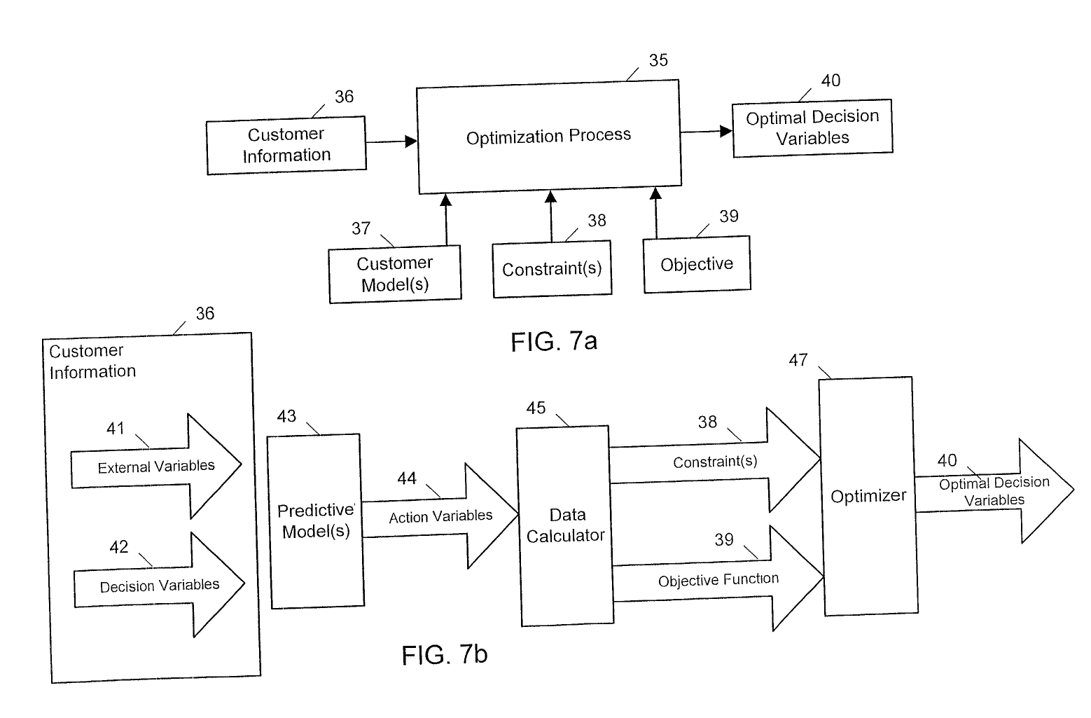

The optimizer may then solve the objective function subject to the constraints and generate (e.g., select) the one or more inducements. The optimization process is described in greater detail below with respect to FIGS. 7a and 7b.

After the optimizer generates one or more inducements in response to the information using the optimization process, in step 26 the method then provides the one or more generated inducements to the user. More specifically, the e-commerce server 2 (or the optimization server 12 or the inducement server 22) may provide the inducement(s) to the client computer system 6, where the inducements are displayed, preferably by a browser, on the client computer system 6. As discussed above, the inducement(s) are preferably designed to encourage or entice the user to complete the transaction in a desired way, such as by purchasing a product, purchasing additional products, selecting a particular e-commerce site, providing desired user demographic information, etc. In one embodiment, the one or more inducements may be pre-selected and then provided to the user while the user conducts the e-commerce transaction. In another embodiment, the inducement(s) may be both selected and provided substantially in real-time while the user is conducting the e-commerce transaction.

The user's response to the one or more inducements presented may be monitored and/or recorded for use in subsequent on-line training of the non-linear model. In some cases, the processing of the user's response via the on-line training may cause the non-linear model to be updated.

As one example, during user checkout to purchase a product from the e-commerce vendor, the one or more generated inducements may be provided and displayed to the user on the client system 6 to encourage the user to complete the purchase. In response to the inducements provided and displayed to the user, the user may provide input to complete purchase of the product from the e-commerce vendor. The user input to complete purchase of the product from the e-commerce vendor may include acceptance of the one or more inducements. The e-commerce vendor would then provide the product to the user, incorporating any inducements or incentives made to the user, such as discounts, free gifts, discounted shipping etc.

As another example, the one or more generated inducements may be provided and displayed to the user while the user is browsing products on the e-commerce site to encourage or entice the user to purchase these products, e.g., to add the products to the virtual shopping cart. In response to the inducements provided and displayed to the user, the user may provide input to add products to the shopping cart. In one embodiment, the inducements that are made to encourage the user to add the products to the virtual shopping cart may only be valid if the products are in fact purchased by the user.

After the user has responded to the inducement, the method may include collecting information regarding the user's response to the particular inducement provided. This collected information may then be used to update or train the predictive model(s), e.g., to train the neural network(s), or to train the support vector machines. The collected information may include not only the particular inducement provided and the user's response, but also the timing of the inducement with respect to the user's navigation of the e-commerce site. The optimization process may then take this information into account in the future presentations of inducements to users, thus the types of inducements presented as well as the timing of inducement presentation may be optimized.

The above-mentioned information regarding the user's response to inducements may also be stored and compiled to generate summary displays and reports to allow the e-commerce vendor or others to review the results of inducement offerings. The summary displays and reports may include, but are not limited to, percentage responses of particular classes or segments of users to particular inducements presented at particular stages or times in the “click flow” of the users' site navigation, revenue increases as a function of inducements, inducement timing, and/or user demographics, or any other information or correlations germane to the e-commerce vendor's goals.

In an alternate embodiment, the predictive model is a commerce model of a commerce system which is used to predict a defined commercial result as a function of information related to the e-commerce transaction and also as a function of the inducements that may be provided to the user during the e-commerce transaction. The optimal inducement is generated by varying the inducement input to the commerce model to vary the predicted output of the commerce model in a predetermined manner until a desired predicted output of the commerce model is achieved, at which point, the optimal inducement has been generated. In this embodiment, the predictive model may be a non-linear model (e.g., a trained neural network or a trained support vector machine).

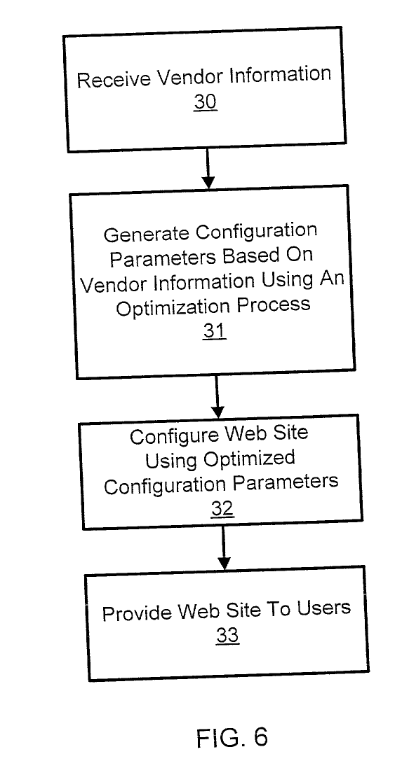

FIG. 6—Optimized Configuration of an E-Commerce Site

FIG. 6 illustrates an embodiment of a method for configuring an e-commerce site using an optimization process. Here it is presumed that the e-commerce site is maintained by an e-commerce vendor, and that the e-commerce site is useable for conducting e-commerce transactions. It is noted that various of the steps mentioned below may occur concurrently and/or in different orders, or may be absent in some embodiments.

As shown, in step 30 the method comprises receiving vendor information, wherein the vendor information is related to products offered by the e-commerce vendor. As used herein, “vendor information” may include an inventory of products offered by the e-commerce vendor, time and date information, environmental information, and/or competitive information of competitors to the e-commerce vendor. The vendor information is preferably not specific to any one user, but rather is related generally to the e-commerce vendor's products, web site or other general information. In one embodiment, the vendor information may include user-specific information, which may entail customizing portions of the e-commerce site for specific users.

In one example, the vendor information may include inventory information pertaining to which of the e-commerce vendor's products are over-stocked, so that they may be featured prominently on the e-commerce site or placed on sale, and/or those that are under-stocked or sold out, so that the price may be adjusted or selectively removed.

In another example, the vendor information may comprise seasonal and/or cultural information, such as the beginning and end of the Christmas season, or Cinco de Mayo, whereupon appropriate marketing and/or graphical themes may be presented.

In yet another example, the vendor information may involve competitive information of competitors, such as the competitor's current pricing of products identical to or similar to those sold by the e-commerce vendor. The e-commerce vendor's prices may then be adjusted, or product presentation may be changed.

In step 31 the method includes generating a configuration of the e-commerce site in response to the vendor information, wherein generation of the e-commerce site configuration uses an optimization process. In one embodiment, generating the configuration of the e-commerce site includes modifying one or more configuration parameters of the e-commerce site and/or generating one or more new configuration parameters of the e-commerce site. For example, one or more configuration parameters of the e-commerce site may represent one or more of a color or a layout of the e-commerce site. One or more configuration parameters of the e-commerce site may also represent content comprised in or presented by the e-commerce site, such as text, images, graphics, audio, or other types of content. One or more configuration parameters of the e-commerce site may also represent one or more inducements, such as promotions, advertisements, offers, or product purchase discounts or incentives, in the e-commerce site, as described above with respect to FIG. 5.

The optimization process used to generate the e-commerce site configuration is described above with reference to FIG. 5, but in this embodiment of the invention, the information input into the predictive model is the vendor information, and the optimized decision variables comprise the e-commerce site configuration parameters. Examples of the constraints in this embodiment may comprise the number of products displayed, the number of colors employed simultaneously on the page, or limits on the values of sale discounts. The objective function represents a given desired commercial goal of the e-commerce vendor, such as increased profits, increased sales of a particular product or product line, increased traffic to the e-commerce site, etc. Further detailed description of the optimization process may be found below, with reference to FIGS. 7a and 7b.

Once the optimizer has solved the objective function, in step 32, the resulting configuration parameters may be applied to the e-commerce site. In other words, the e-commerce site may be configured, modified, or generated based on the configuration parameters produced by the optimization process. Thus a designer may change one or more of a color, layout, or content of the e-commerce site. In an alternate embodiment, the optimized configuration parameters may be applied to the e-commerce site automatically by software designed for that purpose which may reside on the e-commerce server. In this way, the e-commerce site may in large part be configured without the need for direct human involvement.

For example, modification of one or more configuration parameters of the e-commerce site may entail modifying one or more of a color or a layout of the e-commerce site. Modification of one or more configuration parameters of the e-commerce site may also entail modifying content comprised in or presented by the e-commerce site, such as text, images, graphics, audio, or other types of content. Modification of one or more configuration parameters of the e-commerce site may also include incorporating one or more inducements, such as promotions, advertisements, or product purchase discounts or incentives, in the e-commerce site in response to the vendor information, as described above with respect to FIG. 5.

In step 33 the method may include making the reconfigured e-commerce site available to users of the e-commerce site. In other words, when users connect to the e-commerce site, the newly configured e-commerce pages may be provided to the user and displayed on the client system of the user. These newly configured e-commerce pages are designed to achieve a desired commercial goal of the e-commerce vendor.

The responses of one or more users to the reconfigured e-commerce site presented may be monitored and/or recorded for use in subsequent on-line training of the non-linear model. In some cases, the processing of the responses via the on-line training may cause the non-linear model to be updated.

It is noted that, although the embodiments illustrated in FIGS. 5 and 6 have much in common, they differ in the following way. The inducement optimization embodiment of FIG. 5 is preferably executed with the aim of influencing an individual user by customizing the inducements which may be based primarily on information specific to that user, or to a user segment or sample of which that user is a member. In contrast, the configuration optimization embodiment of FIG. 6 is preferably executed with the aim of influencing a broad group of users based primarily on information, circumstances, and needs of the e-commerce vendor. It is noted that the embodiments of FIGS. 5 and 6 are not mutually exclusive, and so may be used in conjunction with each other to further the commercial goals of the e-commerce vendor.

FIG. 7—Overview of Optimization

As discussed herein, optimization may generally be used by a decision-maker associated with a business to select an optimal course of action or optimal course of decision. The optimal course of action or decision may include a sequence or combination or actions and/or decisions. For example, optimization may be used to select an optimal course of action for marketing one or more products to one or more customers, e.g., by selecting inducements or web site configuration for an e-commerce site. As used herein, a “customer” may include an existing customer or a prospective customer of the business. As used herein, a “customer” may include one or more persons, one or more organizations, or one or more business entities. As used herein, the term “product” is intended to include various types of goods or services, as described above. It is noted that optimization may be applied to a wide variety of industries and circumstances.

Generally, a business may desire to apply the optimal course of action or optimal course of decision to one or more customer relationships to increase the value of customer relationships to the business. As used herein, a “portfolio” may include a set of relationships between the business and a plurality of customers. In general, the process of optimization may include determining which variables in a particular problem are most predictive of a desired outcome, and what treatments, actions, or mix of variables under the decision-maker's control (i.e., decision variables) will optimize the specified value. The one or more products may be marketed to customers in accordance with the optimal course of action, such as through inducements displayed on an e-commerce site, or an optimized web site configuration. Other means of applying the optimal course of action may include, for example, (i) conducting an acquisition campaign in accordance with the optimal course of action, (ii) conducting a promotional campaign in accordance with the optimal course of action, (iii) conducting a re-pricing campaign in accordance with the optimal course of action, (iv) conducting an e-mailing campaign in accordance with the optimal course of action, and/or (v) direct mailing and/or targeted advertising.

FIG. 7a is a block diagram which illustrates an overview of optimization according to one embodiment. FIG. 7b is a dataflow diagram which illustrates an overview of optimization according to one embodiment. As shown in FIG. 7a, an optimization process 35 may accept the following elements as input: customer information records 36, predictive model(s) such as customer model(s) 37, one or more constraints 38, and an objective 39. The optimization process 35 may produce as output an optimized set of decision variables 40. In one embodiment, each of the customer model(s) 37 may correspond to one of the customer information records 36. Additionally or alternatively, the customer model(s) 37 may include historical data and/or real-time data, as described in the on-line training methods below. As used herein, an “objective” may include a goal or desired outcome of a process (e.g., an optimization process).

As used herein, a “constraint” may include a limitation on the outcome of an optimization process. Constraints are typically “real-world” limits on the decision variables and are often critical to the feasibility of any optimization solution. Constraints may be specified for numerous variables (e.g., decision variables, action variables, among others). Managers who control resources and/or capital, or are responsible for financial outcomes should be involved in setting constraints that accurately represent their real-world environments. Setting constraints with management input may realistically restrict the allowable values for the decision variables.

In many applications of the optimization process 35, the number of customers involved in the optimization process 35 may be so large that treating the customers individually is computationally infeasible. In these cases, it may be useful to group like customers together in segments. If segmented properly, the customers belonging to a given segment will typically have approximately the same response in the action variables (shown in FIG. 7b) to a given change in decision variables and external variables.

For example, customers may be placed into particular segments based on particular customer attributes such as risk level, financial status, or other demographic information. Each customer segment may be thought of as an average customer for a particular type or profile. A segment model, which represents a segment of customers, may be used as described above with reference to a customer model 37 to generate the action variables for that segment. Another alternative to treating customers individually is to sample a larger pool of customers. Therefore, as used herein, a “customer” may include an individual customer, a segment of like customers, and/or a sample of customers. As used herein, a “customer model”, “predictive model”, or “model” may include segment models, models for individual customers, and/or models used with samples of customers.

The customer information 36 may include external variables 41 and/or decision variables 42, as shown in FIG. 7b. As used herein, “decision variables” are those variables that the decision-maker may change to affect the outcome of the optimization process 35. For example, in the optimization of inducements provided to a user viewing an e-commerce site, the type of inducement and value of inducement may be decision variables. As used herein, “external variables” are those variables that are not under the control of the decision-maker. In other words, the external variables are not changed in the decision process but rather are taken as givens. For example, external variables may include variables such as customer addresses, customer income levels, customer demographic information, credit bureau data, transaction file data, cost of funds and capital, and other suitable variables.

In one embodiment, the customer information 36, including external variables 41 and/or decision variables 42, may be input into the predictive model(s) 43 to generate the action variables 44. In one embodiment, each of the predictive model(s) 43 may correspond to one of the customer information records 36, wherein each of the customer information records 36 may include appropriate external variables 41 and/or decision variables 42. As used herein, “action variables” are those variables that predict a set of actions for an input set of external variables and decision variables. In other words, the action variables may comprise predictive metrics for customer behavior. For example, in the optimization of inducements provided to users, the action variables may include the probability of a customer's response to an inducement. In a re-pricing campaign, the action variables may include the likelihood of a customer maintaining a service after the service is re-priced. In the optimization of a credit card offer, the action variables may include predictions of balance, attrition, charge-off, purchases, payments, and other suitable behaviors for the customer of a credit card issuer.

The predictive model(s) 43 may include the customer model(s) 37 as well as other models. The predictive model(s) 43 may take any of several forms, including, but not limited to: trained neural networks, trained support vector machines, statistical models, analytic models, and any other suitable models (e.g., other trained or untrained non-linear models) for generating predictive metrics. The models may take various forms including linear or non-linear (e.g., a neural network, or a support vector machine), and may be derived from empirical data or from managerial judgment.

In one embodiment, the predictive model(s) 43 may be implemented as a non-linear model (e.g., a neural network, or a support vector machine). In the neural network implementation, typically, the neural network includes a layer of input nodes, interconnected to a layer of hidden nodes, which are in turn interconnected to a layer of output nodes, where each connection is associated with an adjustable weight whose value is set in the training phase of the model. The neural network may be trained, for example, with historical customer data records as input, as further described below in various embodiments of the present invention. The trained neural network may include a non-linear mapping function that may be used to model customer behaviors and provide predictive customer models in the optimization system. The trained neural network may generate action variables 44 based on customer information 36 such as external variables 41 and/or decision variables 42.

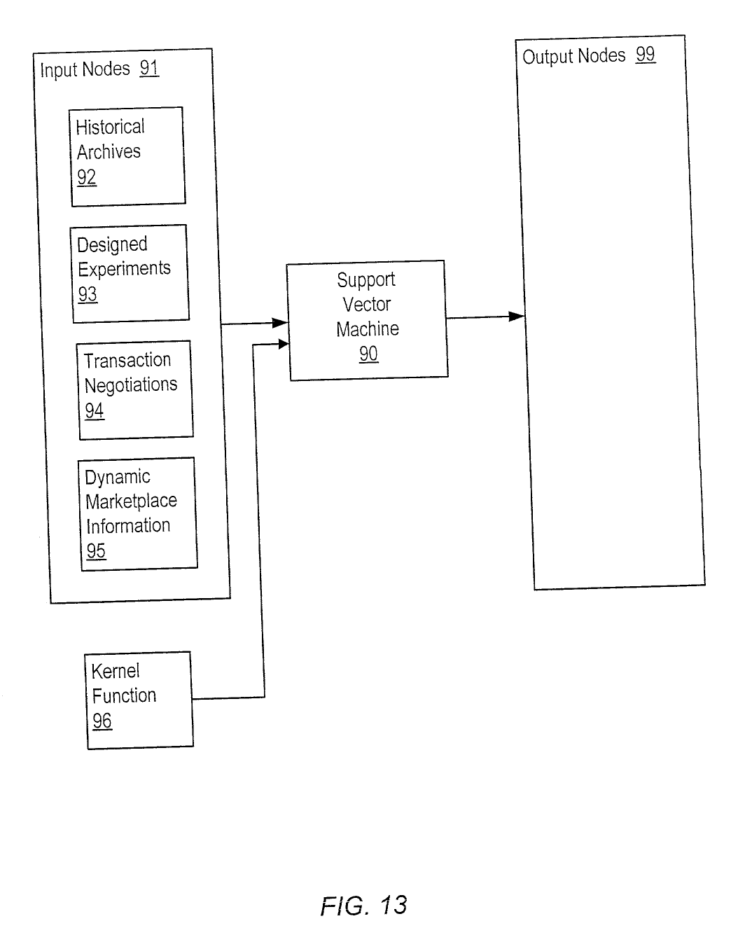

In the support vector machine implementation, typically, the support vector machine includes a layer of input nodes, interconnected to a layer of support vectors, which are in turn interconnected to a layer of output nodes, wherein each node computes a non-linear function of values of the support vectors. See FIG. 13 for more detail on a support vector machine implementation.

In one embodiment, a model may comprise a representation that allows prediction of action variables, a, due to various decision variables, d, and external variables, e. For example, a customer may be modeled to predict customer response to various offers under various circumstances. It may be said that the action variables, a, are a function, via the model, of the decision and external variables, d and e, such that: a=M(d,e), where M( ) is the model, a is the vector of action variables, d is the vector of decision variables, and e is the vector of external variables.

In one embodiment, the action variables 44 generated by the predictive model(s) 43 may be used to formulate constraint(s) 38 and the objective function 39 via formulas. As shown in FIG. 7b, a data calculator 45 may generate the constraint(s) 38 and objective function 39 using the action variables 44 and potentially other data and variables. In one embodiment, the formulas used to formulate the constraint(s) 38 and objective function 39 may include financial formulas such as formulas for determining net operating income over a certain time period. The constraint(s) 38 and objective function 39 may be input into an optimizer 47, which may comprise, for example, a custom-designed process or a commercially available “off the shelf ” product. The optimizer may then generate the optimal decision variables 40 which have values optimized for the goal specified by the objective function 39 and subject to the constraint(s) 38. A further understanding of the optimization process 35 and the optimizer 47 may be gained from the references “An Introduction to Management Science: Quantitative Approaches to Decision Making”, by David R. Anderson, Dennis J. Sweeney, and Thomas A. Williams, West Publishing Co. (1991); and “Fundamentals of Management Science” by Efraim Turban and Jack R. Meredith, Business Publications, Inc. (1988).

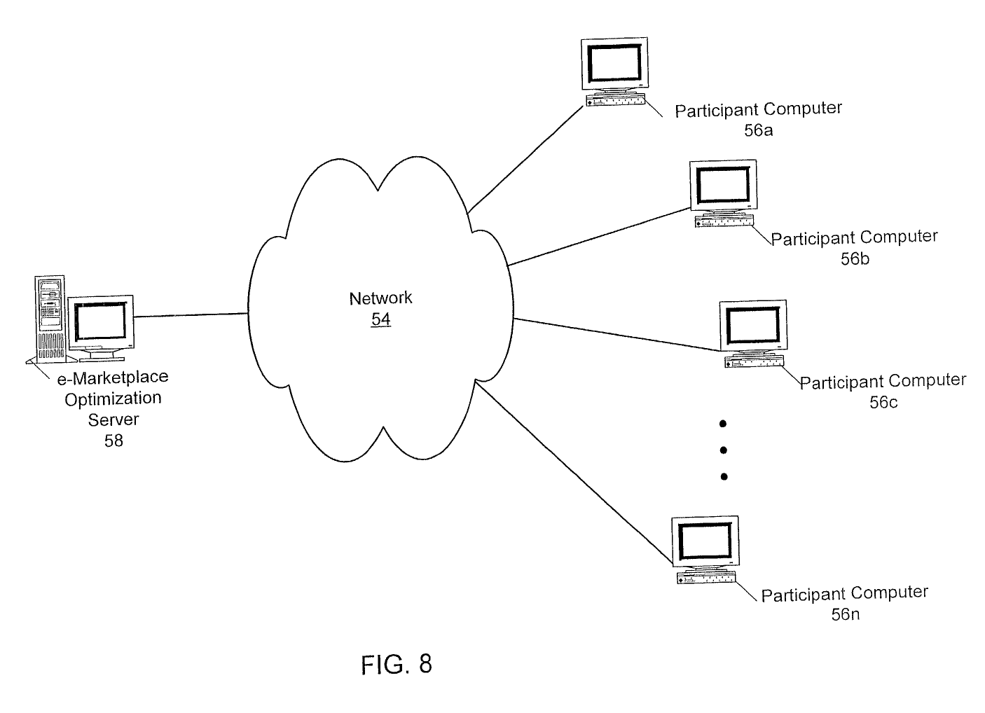

FIG. 8—An e-Marketplace System

FIG. 8 illustrates a network system suitable for implementing an e-marketplace, according to one embodiment. As FIG. 8 shows, an e-marketplace optimization server 58 is communicatively coupled to a plurality of participant computers 56 through a network 54. Each of the participant computers 56 may be operated by or on behalf of a participant. As used herein, the term “participant” is used to refer to one or both of participant and participant computer 56. The network 54 may be a Local Area Network (LAN), or a Wide Area Network (WAN) such as the Internet.

In one embodiment, the e-marketplace optimization server 58 may host an e-commerce site which is operable to provide an e-marketplace where goods and services may be bought and sold among participants 56. The e-marketplace optimization server 58 may comprise one or more server computer systems for implementing e-marketplace optimization as described herein.

Each participant 56 may be a buyer or a seller, or possibly a service provider, depending upon a particular transaction being conducted. Note that for purposes of simplicity, similar components, e.g., participant computers 56a, 56b, 56c, and 56n may be referred to collectively herein by a single reference numeral, e.g., 56.

The e-marketplace optimization server 58 preferably includes a memory medium on which computer programs are stored. For example, the e-marketplace optimization server 58 may store a transaction optimization program for optimizing e-marketplace transactions among a plurality of participants 56. The e-marketplace optimization server 58 may also store web site hosting software for presenting various graphical user interfaces (GUIs) on the various participant computer systems 56 and for communicating with the various participant computer systems 56. The GUIs presented on the various participant computer systems 56 may be used to allow the participants to provide transaction requirements to the e-marketplace optimization server 58 or receive transaction results from the e- marketplace optimization server 58.

Thus, an e-marketplace may function as a forum to facilitate transactions between participants and may comprise an e-commerce site. The e-commerce site may be hosted on an e-commerce server computer system (e.g., e-commerce server 2, described in previous Figures). The e-marketplace optimization server 58 may take various forms, including one or more connected computer systems.

The memory medium preferably stores one or more software programs for providing an e-marketplace and optimizing transactions among various participants. The software program may be implemented in any of various ways, including procedure-based techniques, component-based techniques, and/or object-oriented techniques, among others. For example, the software program may be implemented using ActiveX controls, C++ objects, Java objects, Microsoft Foundation Classes (MFC), or other technologies or methodologies, as desired. A CPU, such as the host CPU, executing code and data from the memory medium comprises a means for creating and executing the software program according to the methods or flowcharts described below.

Various embodiments further include receiving or storing instructions and/or data implemented in accordance with the foregoing description upon a carrier medium. Suitable carrier media include a memory medium as described above, as well as signals such as electrical, electromagnetic, or digital signals, conveyed via a communication medium such as networks and/or a wireless link.

In one embodiment, each of the participant computers 56 may include a memory medium which stores standard browser software, which is used for displaying a graphical user interface presented by the e-marketplace optimization server 58. In another embodiment, each of the participant computers 56 may store other client software for interacting with the e-marketplace optimization server 58.

The e-marketplace may serve to facilitate the buying and selling of goods and services in any industry, including metals, wood and paper, food, manufacturing, electronics, healthcare, insurance, finance, or any other industry in which goods or services may be bought and sold. In one embodiment, the e-marketplace may serve the chemical manufacturing industry, providing a forum for the purchase and sale of raw chemicals and chemical products. There may be multiple suppliers (sellers) of a given product, such as polypropylene for example, and a single buyer who wishes to place an order for the product. The multiple suppliers may compete to fill the order of the single buyer. In another embodiment, there may be multiple buyers and one supplier of a product. The multiple customers may then compete to receive an order from the supplier. In yet another embodiment, there may be multiple buyers and multiple sellers involved in a given transaction, in which case a complex transaction may result in which multiple sub-transactions may be conducted among the participants 56.

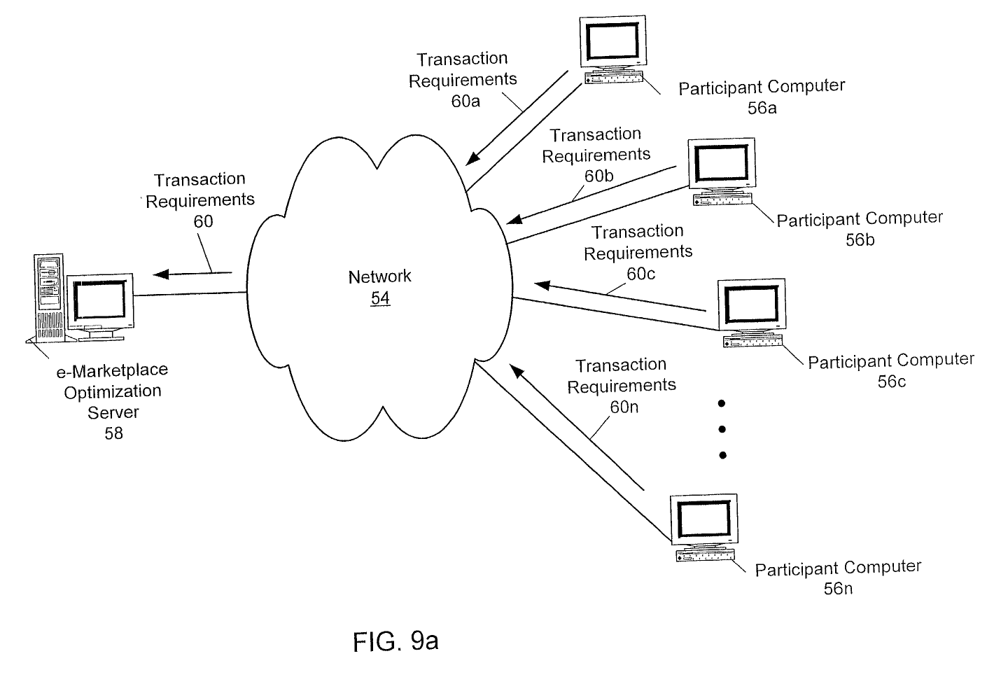

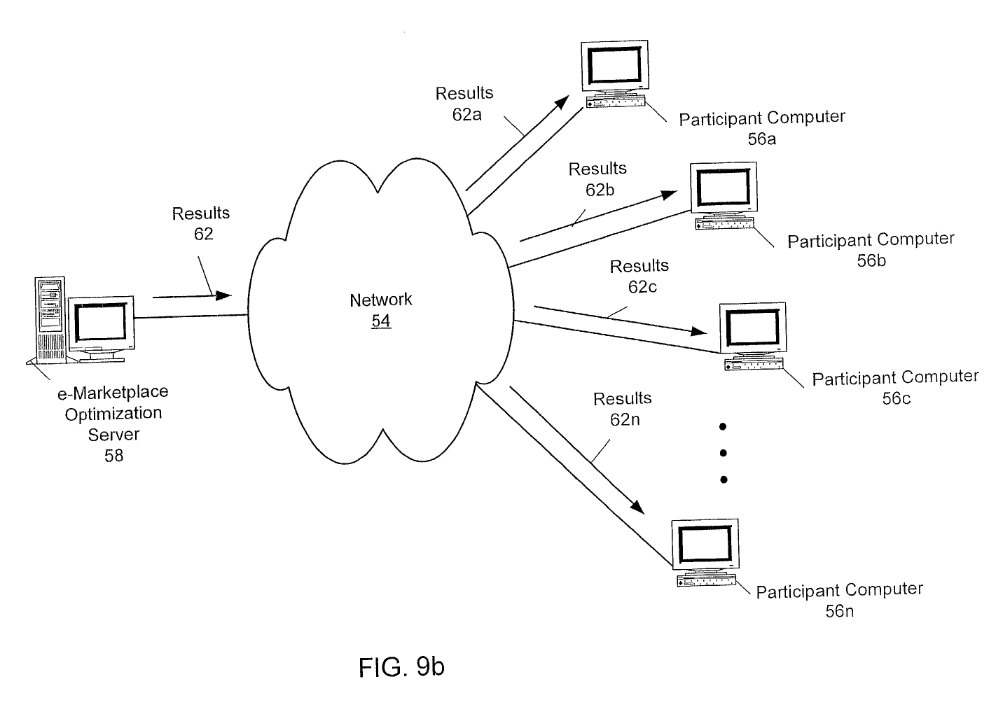

FIG. 9—An e-Marketplace with Transaction Optimization

FIGS. 9a and 9b illustrate an e-marketplace system with transaction optimization, according to one embodiment. As shown, the embodiments illustrated in FIGS. 9a and 9b are substantially similar to that illustrated in FIG. 8. FIG. 9a illustrates various participants 56 providing transaction requirements 60 to the e-marketplace optimization server 58, and FIG. 9b illustrates various participants 56 receiving transaction results 62 from the e-marketplace optimization server 58.

The e-marketplace optimization server 58, in addition to hosting the e-marketplace site, may also be operable to provide optimization services to the e-marketplace. The optimization services may comprise mediating a transaction among the participants 56 such that the desired outcome best serves the needs and/or desires of two or more of the participants. In one embodiment, the transaction may be optimized by a transaction optimization program or engine which is stored and executed on the e-marketplace optimization server 58. For example, in the case mentioned above where there are multiple sellers and one buyer, the transaction optimization program may generate a transaction which specifies one of the sellers to provide the product order to the buyer, at a particular price, by a particular time, such that the buyer's needs are met as well as those of the seller.

As shown in FIG. 9a, the plurality of participant computer systems 56 may be coupled to the server computer system 58 over the network 54. Each of the participant computers 56 may be operable to provide transaction requirements 60 to the server 58. For each of the plurality of participants, the transaction requirements 60 may include one or more of constraints, objectives and other information related to the transaction. The constraints and/or objectives may include parameter bounds, functions, algorithms, and/or models which specify each participant's transaction guidelines. In one embodiment, each participant may, at various times, modify the corresponding transaction requirements 60 to reflect the participant's current transaction constraints and/or objectives. As noted above, constraints may be expressed not only as value bounds for parameters, but also in the form of functions or models. For example, a participant may provide a model to the e-marketplace and specify that an output of the model is to be minimized, maximized, or limited to a particular range. Thus the behavior of the model may constitute a constraint or limitation on a solution. Similarly, a model (or function) may also be used to express objectives of the transaction for a participant.

As FIG. 9a shows, each participant's transaction requirements 60 may be sent to the e-marketplace optimization server 58. The e-marketplace optimization server 58 may then execute the transaction optimization program using the transaction requirements 60 from each of the plurality of participant computer systems to produce optimized transaction results for each of the plurality of participants. The transaction optimization program may include a model of at least a portion of the e-marketplace. For example, the model may comprise a model of a transaction, a model of one or more participants, or a model of the e-marketplace itself. In one embodiment, the model may be implemented as a non-linear model (e.g., a neural network, or a support vector machine). The term “support vector machine” is used synonymously with “support vector” herein.

In one embodiment, the transaction optimization program may use the model to predict transaction results for each of the plurality of participants. The transaction optimization program may use these results to optimize the transaction among a plurality of participants.

As shown in FIG. 9b, after the transaction optimization program executing on the e-marketplace server 58 has generated the transaction results 62, the transaction results 62 may be sent to each of the participants 56 over the network 54. In one embodiment, the transaction results 62 may specify which of the participants is included in the transaction, as well as the terms of the transaction and possibly other information.

In one embodiment, each of the participants may receive the same transaction results 62, i.e. each of the participants may receive the terms of the optimized transaction, including which of the participants were selected for the transaction. In another embodiment, each participant may receive only the transaction results 62 which apply to that participant. For example, the terms of the optimized transaction may only be delivered to those participants which were included in the optimized transaction, while the participants which were excluded from the transaction (or not selected for the transaction) may receive no results. In another embodiment, the terms of the optimized transaction may be delivered to each of the participants, but the identities of the participants selected for the optimized transaction may be concealed from those participants who were excluded in the optimized transaction.

In one embodiment, the transaction optimization program may include an optimizer which operates to optimize the transaction according to the constraints and/or objectives comprised in the transaction requirements 60 from each of the plurality of participant computer systems 56.

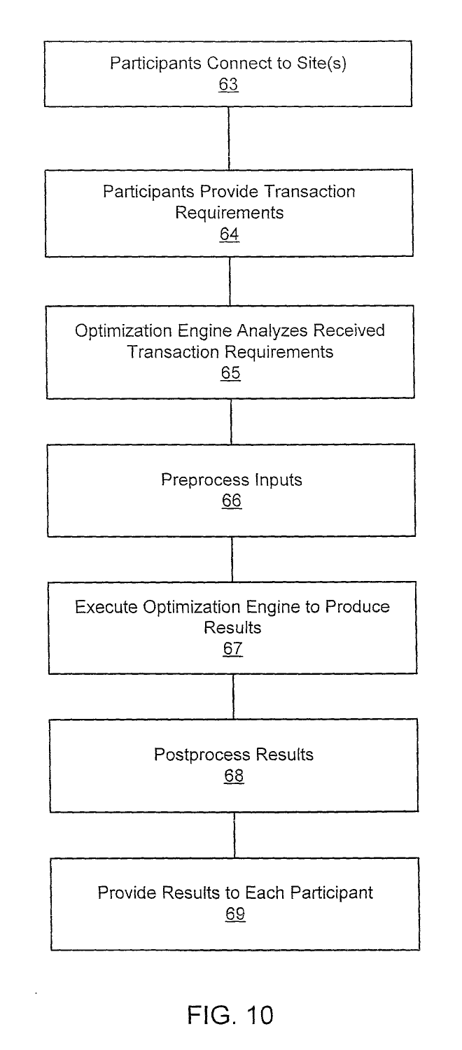

FIG. 10—Transaction Optimization Process

FIG. 10 is a flowchart of a transaction optimization process, according to one embodiment. As FIG. 10 shows, in step 63, participants may connect to an e-marketplace site over a network 54, such as the Internet. The e-marketplace site may be hosted on e-marketplace server 58. The participants preferably connect to the e-marketplace server 58 using participant computer systems 56 which are operable to communicate with the e-marketplace server 58 over the network 54. In one embodiment, the participants may communicate with the e-marketplace server through a web browser, such as Netscape Navigator™ or Microsoft Internet Explorer™. In another embodiment, custom client/server software may be used to communicate between the server and the participants.

In step 64, each participant may provide transaction requirements 60 to the e-marketplace server 58. The transaction requirements 60 may include one or more constraints and/or objectives for a given participant. The objectives may codify the goals of a participant with regard to the transaction, such as increasing revenues or market share, decreasing inventory, minimizing cost, or any other desired outcome of the transaction. The constraints for a given participant may specify limitations which may bound the terms of an acceptable transaction for that participant, such as maximum or minimum order size, time to delivery, profit margin, total cost, or any other factor which may serve to limit transaction terms.

In step 65, a transaction optimization engine may optionally analyze the transaction requirements 60 (constraints and/or objectives). In one embodiment, the transaction requirements 60 may be analyzed to filter out unfeasible parameters, e.g. bad data, for example, such as uninitialized or missing parameters.

In step 66, the transaction optimization engine may optionally preprocess a plurality of inputs from the plurality of e-marketplace participants providing one or more transaction terms which describe the specifics of the desired transaction, such as order quantity or quality, or product type. The inputs may be preprocessed to aid in formulating the optimization problem to be solved.

In step 67, the transaction optimization engine or program may be executed using the transaction requirements 60 from each of the participants to produce transaction results 62 for each of the participants. The transaction results 62 may include a set of transaction terms which specify a transaction between two or more of the participants which optimizes the objectives of the two or more participants subject to the constraints of the two or more participants.

In step 68, the transaction optimization engine may optionally post process the optimized transaction results 62. Such post processing may be performed to check for reasonable results, or to extract useful information for analysis.

Finally, in step 69, the transaction results 62 may be provided to the participants. At this point, the resultant optimized transaction may be executed among the two or more participants specified in the optimized transaction.

In one embodiment, after the transaction results 62 have been provided to the participants, the participants may adjust their constraints and/or objectives and re-submit them to the transaction optimization server, initiating another round of transaction optimization. This may continue until a pre-determined number of rounds has elapsed, or until the participants agree to terminate the process.

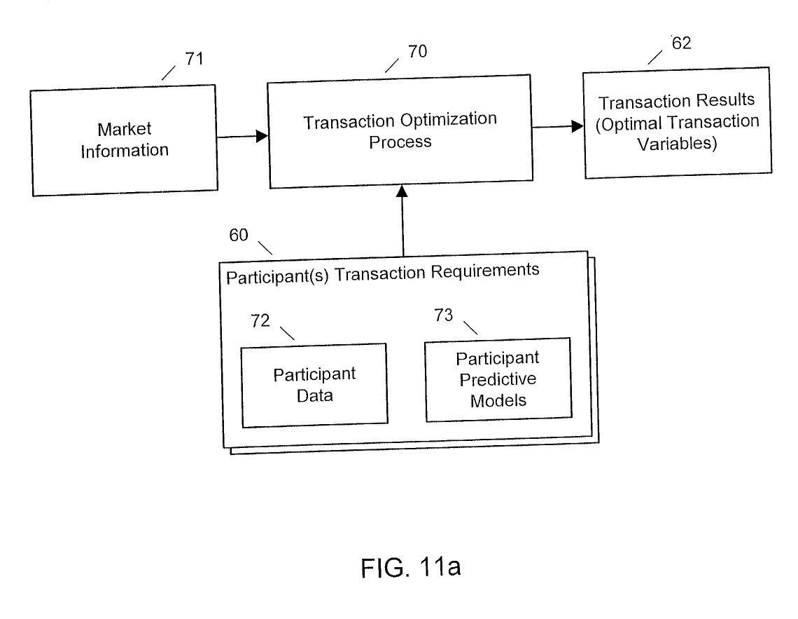

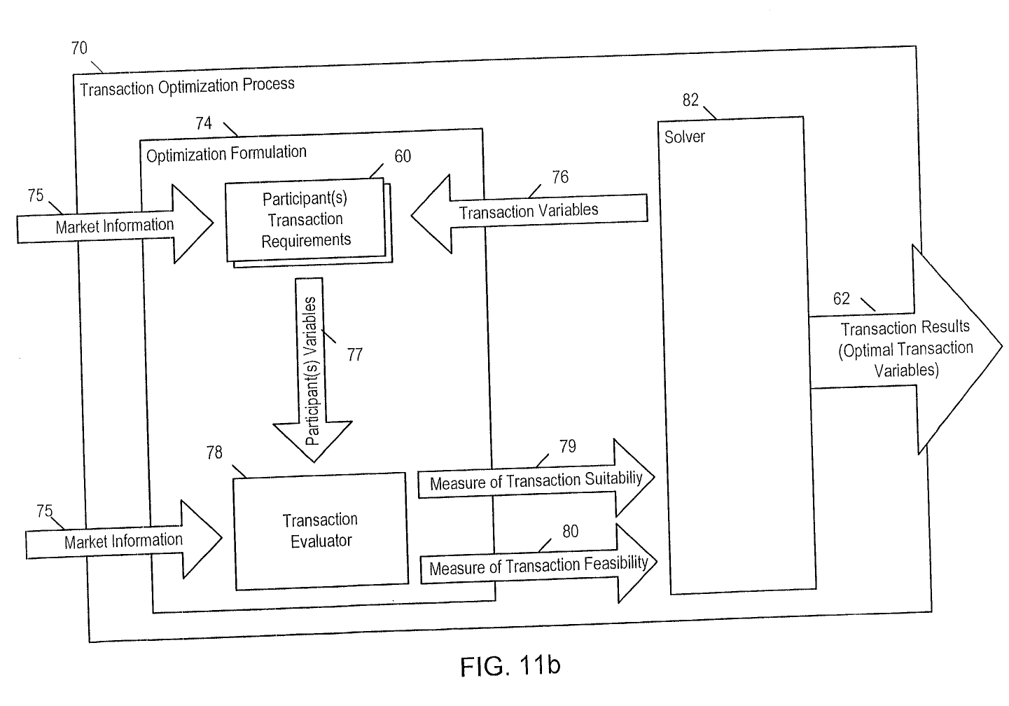

FIG. 11—e-Marketplace Transaction Optimization Overview

FIG. 11a is a block diagram which illustrates an overview of optimization as applied to e-marketplace transactions, according to one embodiment. FIG. 11b is a dataflow diagram which illustrates an optimization process according to one embodiment. FIGS. 11a and 11b together illustrate an exemplary system for optimizing an e-marketplace system.

As shown in FIG. 11a, a transaction optimization process 70 may accept the following elements as input: market information 71 and participant(s) transaction requirements 60. The optimization process 70 may produce as output transaction results 62 in the form of an optimized set of transaction variables. As used herein, “optimized” means that the selection of transaction values is based on a numerical search or selection process which maximizes a measure of suitability while satisfying a set of feasibility constraints. A further understanding of the optimization process 70 may be gained from the references “An Introduction to Management Science: Quantitative Approaches to Decision Making”, by David R. Anderson, Dennis J. Sweeney, and Thomas A. Williams, West Publishing Co. (1991); and “Fundamentals of Management Science” by Efraim Turban and Jack R. Meredith, Business Publications, Inc. (1988).

As used herein, the term “market information” may refer to any information generated, stored, or computed by the marketplace which provides context for the possible transactions. This information is not available to a participant without engaging in the e-marketplace. Furthermore, the market information is treated as a set of external variables in that those variables are not under the control of the transaction optimization process. For example, the marketplace may report the number of active participants, the recent historical demand for a particular product, or the current asking price for a product being sold. Additionally, market information may include information retrieved from other marketplaces.

As used herein, “transaction requirements” may include information that a participant provides to the optimization process to affect the outcome of the transaction optimization process. This information may include: (a) the participants objectives in accepting a transaction, (b) constraints describing what transaction parameters the participant will accept, (c) and internal participant data including inventory, production schedules, cost of goods sold, available funds, and/or required delivery times. Information may either be specified statically as participant data 72 or as participant predictive models 73 which allow information to be computed dynamically based on market information and transaction variables.

As noted above, an “objective” may include a goal or desired outcome of a process; in this case, a transaction optimization process. Some example objectives are: obtain goods at a minimum price, sell goods in large lots, minimize delivery costs, and reduce inventory as rapidly as possible.

As noted above, a “constraint” may include a limitation on the outcome of an optimization process. Constraints may include “real-world” limits on the transaction variables and are often critical to the feasibility of any optimization solution. For example, a marketplace seller may impose a minimum constraint on the volume of product that may be delivered in one transaction. Similarly, a marketplace buyer may impose a maximum constraint on the price the buyer is willing to pay for a purchased product. Constraints may be specified for numerous variables (e.g., transaction variables, computed variables, among others). For example, a seller may have a minimum limit on the margin of sales. This quantity may be computed internally by the seller participant. Constraints may reflect financial or business constraints. They may also reflect physical production or delivery constraints.

As described above, the constraints and/or objectives provided by a participant may include parameter bounds or limits, functions, algorithms, and/or models which express the desired transaction requirements of the participant.

As used herein, “transaction variables” define the terms of a transaction. For example, the transaction variables may identify the selected participants, the volume of product exchanged, the purchase price, and the delivery terms, among others. As used herein, “optimal transaction variables” define the final transaction, which is provided to two or more of the participants as transaction results 62. The optimization process 70 selects the optimal transaction variables 62 in order to satisfy the constraints of the participants and best meet the objectives of the participants.

As shown in the dataflow of FIG. 11b, the transaction optimization process 70 may comprise an optimization formulation 74 and a solver 82. The optimization formulation 74 is a system which may take as input a proposed set of transaction variables 76 and market information 75. The optimization formulation 74 may then compute both a measure of suitability for the proposed transaction 79 and one or more measures of feasibility for the proposed transaction 80. The solver 82 may determine a set of transaction variables 76 that maximizes the transaction suitability 79 over all participants while simultaneously ensuring that all of the transaction feasibility conditions are satisfied.

Before execution of the transaction optimization program, participants may each submit transaction requirements 60 to the marketplace. These requirements are incorporated into the optimization formulation 74. The participant transaction requirements 60 are used to compute or specify a set of participant(s) variables 77 for each participant based on the market information 75, proposed transaction variables 76, and participant's unique properties. The participant(s) variables 77 are passed to a transaction evaluator 78 which determines the overall suitability 79 and feasibility 80 of the transaction variables 76 proposed by the solver 82. The solver uses these measures 79 and 80 to refine the choice of transaction variables 76. After the optimization solver 82 computes, selects, or creates the final set of transaction variables 76 in response to the received data, the e-marketplace server, or a separate server, or possibly the solver itself, may distribute or provide the transaction results 62 to some or all of the participants. The transaction results 62 may be provided to the client systems of the participants, where the results (transactions) may be displayed, stored or automatically acted upon. As discussed above, the transaction results 62 are preferably designed to achieve a desired commercial result, e.g., to complete a transaction in a desired way, such as by purchasing or selling a product.

Participant(s) variables 77 are used to represent participant constraints and/or objectives to the transaction evaluator 78 in a standard form. These participant(s) variables 77 are based on the participant's requirements. In one embodiment, the constraints and/or objectives are directly represented as participant data. For example, a buyer-participant may specify a product code, desired volume, and maximum unit price. In another example a seller may specify available product, minimum selling price, minimum order volume, and delivery time-window. In another embodiment, objective and constraint terms may be computed as a function of transaction variables using predictive models. For example, a buyer may specify a maximum price computed based on a combination of the predicted market demand and seller's available volume. As another example, models may be used to translate a participant's strategic business objectives such as increase profit, increase market share, minimize inventory, etc., into standardized objective and constraint information based on current marketplace activity. In yet another embodiment, constraints and/or objectives are determined as a mixture of static data and dynamically computed values.

Participant predictive model(s) 73 may be used to compute participant variables such as constraints and/or objectives dynamically based on current marketplace information and proposed transaction variables. Models may estimate current or future values associated with the participant, other participants, or market conditions. Computations may represent different aspects of a participant's strategy. For example, a predictive model may represent the manufacturing conditions and behavior of a participant, a price-bidding strategy, the future state of a participant's product inventory, or the future behavior of other participants.

Predictive models 73 may take on any of a number of forms. In one embodiment, a model may be implemented as a non-linear model, such as a neural network or support vector machine (see FIG. 13). In the neural network implementation, typically, the neural network includes a layer of input nodes, interconnected to a layer of hidden nodes, which are in turn interconnected to a layer of output nodes, wherein each connection is associated with an adjustable weight or coefficient and wherein each node computes a non-linear function of values of source nodes. In the support vector machine implementation, typically, the support vector machine includes a layer of input nodes, interconnected to a layer of support vectors, which are in turn interconnected to a layer of output nodes, wherein each node computes a non-linear function of values of the support vectors. See FIG. 13 for more detail on a support vector machine implementation.

The support vectors are set in the training phase of the model. The model may be trained based on data extracted from historical archives, data gathered from designed experiments, or data gathered during the course of transaction negotiations. The model may be further trained based on dynamic marketplace information. In other embodiments, predictive models may be based on statistical regression methods, analytical formulas, physical first principles, or rule-based systems or decision-tree logic. In another embodiment, a model may be implemented as an aggregation of a plurality of model types.

Individual constraints and/or objectives 77 from two or more participants are passed to the transaction evaluator 78. The transaction evaluator combines the set of participant constraints to provide to the solver 82 one or more measures of transaction feasibility 80. The transaction evaluator also combines the individual objectives of the participants to provide to the solver 82 one or more measures of transaction suitability 79. The combination of objectives may be based on a number of different strategies. In one embodiment, the individual objectives may be combined by a weighted average. In a different embodiment, the individual objectives may be preserved and simultaneously optimized, such as in a Pareto optimal sense, as is well known in the art.

The solver 82 implements a constrained search strategy to determine the set of transaction variables that maximize the transaction suitability while satisfying the transaction feasibility constraints. Many strategies may be used, as desired. Solver strategies may be substituted as necessary to satisfy the requirements of a particular marketplace type. Examples of search strategies may include gradient-based solvers such as linear programming, non-linear programming, mixed-integer linear and/or non-linear programming. Search strategies may also include non-gradient methods such as genetic algorithms and evolutionary programming techniques. Solvers may be implemented as custom optimization processes or off-the-shelf applications or libraries.

As mentioned above, the e-marketplace system described herein may include one or more predictive models used to represent various aspects of the system, such as the participants, the related market, or any other attribute of the system. In one embodiment, one or more of the predictive models may be implemented as a non-linear model (e.g., a neural network, or a support vector machine). To increase the usefulness of a non-linear model, they may be trained with data, and internal weights or coefficients may be set to reconcile input training input data with expected or desired output data. On-line training methods may be used to train non-linear models, according to various embodiments of the present invention, as further detailed below.

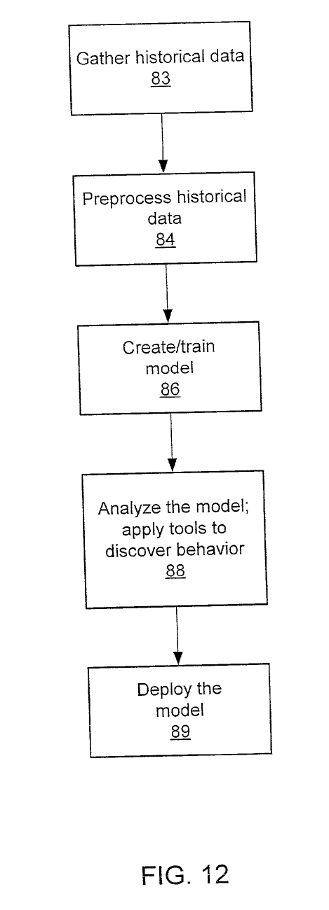

FIG. 12—Method of Modeling a Business Process

FIG. 12 is a flowchart diagram illustrating a method of creating and using models and optimization procedures to model and/or control a business process, according to one embodiment.

As used herein, the term “business process” may refer to a series of actions or operations in a particular field or domain, beginning with inputs (e.g., data inputs), and ending with outputs, as further described in detail below. Thus, the term “business process” is intended to include many areas, such as electronic commerce (i.e., e-commerce), e-marketplaces, financial (e.g., stocks and/or bonds) markets and systems, insurance systems, data analysis, data mining, process measurement, optimization (e.g., optimized decision making, real-time optimization), quality control, as well as any other business-related or financial-related field or domain where predictive or classification models may be useful and where the object being modeled may be expressed. In various embodiments of the present invention, components described herein as inputs or outputs may comprise software constructs or operations which control or provide information or information processes. The term “process” is intended to include a “business process” as described herein.

As shown, in step 83 the method involves gathering historical data which describes the process. This historical data may comprise a combination of inputs and the resulting outputs when these inputs are applied to the respective process. This historical data may be gathered in many and various ways. Typically, large amounts of historical data are available for most processes or enterprises.

In step 84 the method may preprocess the historical data. The preprocessing may occur for several reasons. For example, preprocessing may be performed to manipulate or remove error conditions or missing data, or accommodate data points that are marked as bad or erroneous. Preprocessing may also be performed to filter out noise and unwanted data. Further, preprocessing of the data may be performed because in some cases the actual variables in the data are themselves awkward to use in modeling. For example, where the variables are interest rate 1 and interest rate 2, the model may be much more related to the ratio between the interest rates. Thus, rather than apply interest rate 1 and interest rate 2 to the model, the data may be processed to create a synthetic variable which is the ratio of the two interest rate values, and the model may be used against the ratio.

In step 86 the model may be created and/or trained. This step may involve several steps. First, a representation of the model may be chosen, e.g., choosing a linear model or a non-linear model. If the model is a non-linear model, the model may be a neural network or a support vector machine, among other non-linear models. Further, the neural network may be a fully connected neural net or a partly connected neural net. After the model has been selected, a training algorithm may be applied to the model using the historical data, e.g., to train the non-linear model. Finally, the method may verify the success of this training to determine whether the model actually corresponds to the process being modeled. In one embodiment, the training in step 86 may be on-line training, as further described below.

In step 88, the model is typically analyzed. This may involve applying various tools to the model to discover its behavior. Lastly, in step 89, the model may be deployed in the “real-world” to model, predict, optimize, or control the respective process. The model may be deployed in any of various manners. For example, the model may be deployed simply to perform predictions, which involves specifying various inputs and using the model to predict the outputs. Alternatively, the model may be deployed with a problem formulation, e.g., an objective function, and a solver or optimizer.

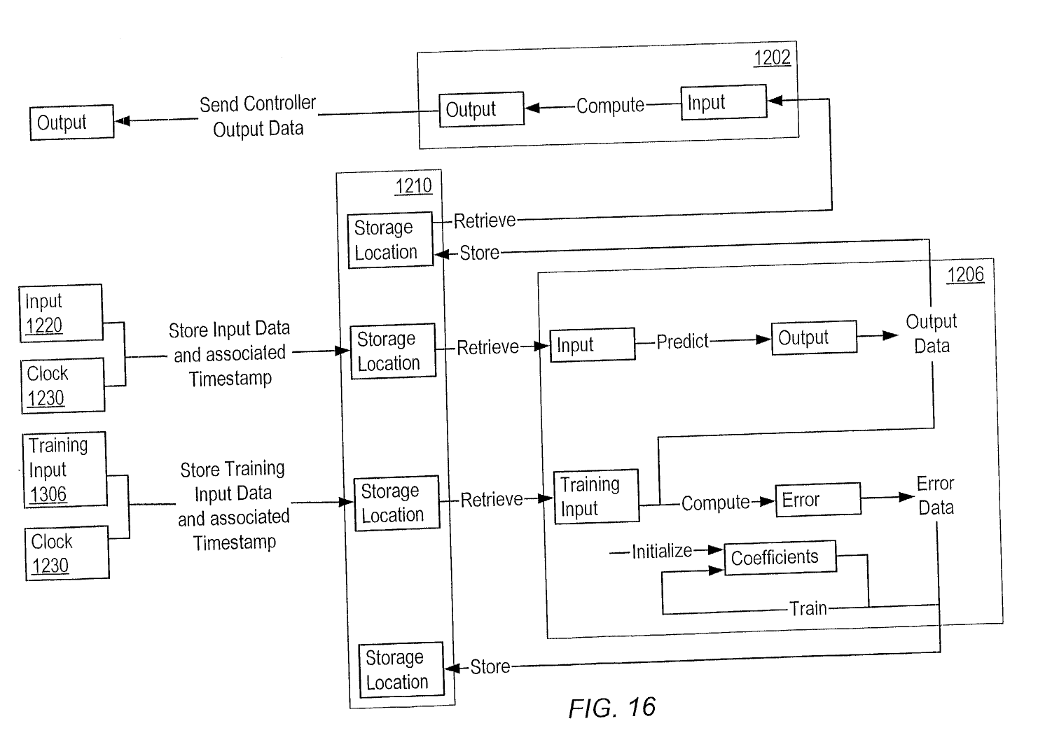

FIG. 16—Nomenclature Diagram

FIG. 16 may provide a reference of consistent terms for describing an embodiment of the present invention. FIG. 16 is a nomenclature diagram which shows the various names for elements and actions used in describing various embodiments of the present invention. In referring to FIG. 16, the boxes may indicate elements in the architecture and the labeled arrows may indicate actions.

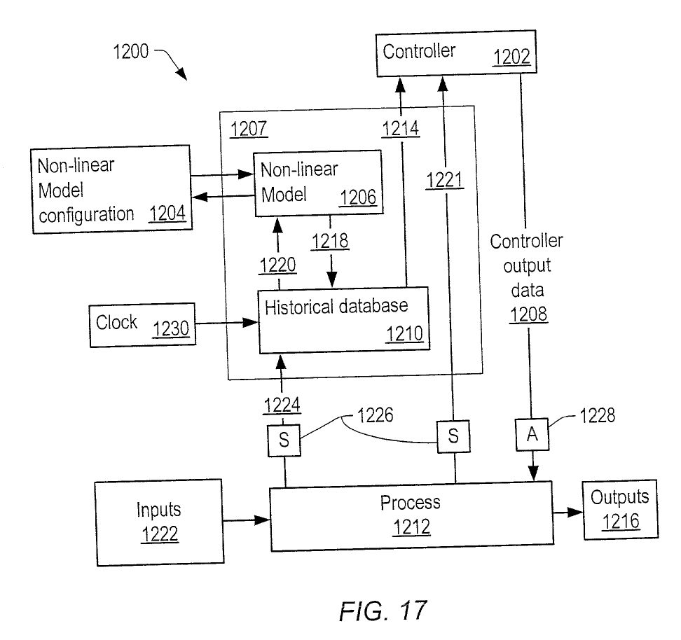

As discussed below in greater detail, various embodiments of the present invention essentially utilize non-linear models (e.g., neural networks, or support vector machines) to provide predicted values of important and not readily obtainable process conditions 1906 and/or output properties 1904 to be used by a controller 1202 to produce controller output data 1208 (shown in FIG. 17) used to control the process 1212.

As shown in FIG. 17, a non-linear model 1206 may operate in conjunction with a historical database 1210 which, in one embodiment, provides input data 1220 to the non-linear model 1206. It should be understood that the drawings and detailed description thereto describe a “process” 1212. As noted earlier, “process” is an inclusive term, intended to encompass various embodiments of the invention applicable in many areas, such as electronic commerce (i.e., e-commerce), e-marketplaces, financial (e.g., stocks and/or bonds) markets and systems, data analysis, data mining, process measurement, optimization (e.g., optimized decision making, real-time optimization), quality control, as well as any other field or domain where predictive or classification models may be useful and where the object being modeled may be expressed abstractly. Thus, specific steps described herein may be different, or omitted as appropriate or desired in various embodiments. In various embodiments of the present invention, components described herein as inputs or outputs may comprise software constructs or operations which control or provide information or information processes, rather than physical phenomena or processes.

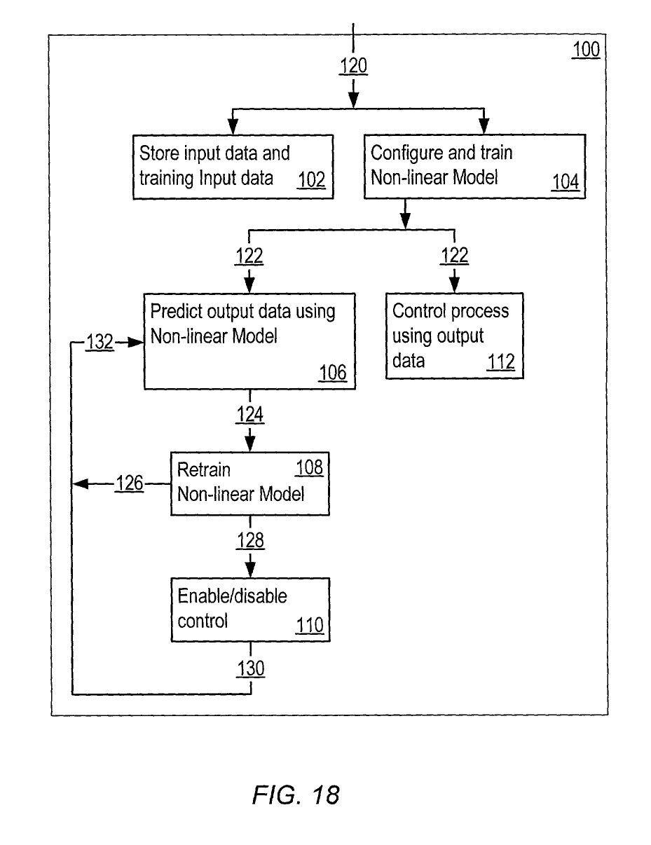

Referring now to FIGS. 17 and 18, input data and training input data may be collected and subsequently stored in a historical database with associated timestamps as indicated by step 102. In parallel, the non-linear model 1206 may be configured and trained in step 104. As shown in FIG. 17, the non-linear model 1206 may be used to predict output data 1218 using input data 1220. The prediction of output data is also noted in step 106 of FIG. 18. In parallel with step 106, control of the process using the output data may be performed in step 112. Following the prediction of output data, the non-linear model 1206 may be retrained in step 108, followed by control being enabled or disabled in step 110, using the predicted output data.

FIG. 13—Support Vector Machine Implementation

In order to fully appreciate the various aspects and benefits produced by various embodiments of the present invention, an understanding of non-linear model technology is useful. A detailed description of a non-linear model in the form of a neural network is described earlier. Support vector machine technology as applicable to the support vector machine 90 of the system and method of various embodiments of the present invention is discussed below.

Support Vector Machine Introduction

Historically, classifiers have been determined by choosing a structure, and then selecting a parameter estimation algorithm used to optimize some cost function. The structure chosen may fix the best achievable generalization error, while the parameter estimation algorithm may optimize the cost function with respect to the empirical risk.

There are a number of problems with this approach, however. These problems may include:

1. The model structure needs to be selected in some manner. If this is not done correctly, then even with zero empirical risk, it is still possible to have a large generalization error.

2. If it is desired to avoid the problem of over-fitting, as indicated by the above problem, by choosing a smaller model size or order, then it may be difficult to fit the training input data (and hence minimize the empirical risk).

3. Determining a suitable learning algorithm for minimizing the empirical risk may still be quite difficult. It may be very hard or impossible to guarantee that the correct set of parameters is chosen.

The support vector method is a recently developed non-linear model technique which is designed for efficient multidimensional function approximation. The basic idea of support vector machines (SVMs) is to determine a classifier or regression machine which minimizes the empirical risk (i.e., the training set error) and the confidence interval (which corresponds to the generalization or test set error), that is, to fix the empirical risk associated with an architecture and then to use a method to minimize the generalization error. One advantage of SVMs as adaptive models for binary classification and regression is that they provide a classifier with minimal VC (Vapnik-Chervonenkis) dimension which implies low expected probability of generalization errors. SVMs may be used to classify linearly separable data and non-linearly separable data. SVMs may also be used as non-linear classifiers and regression machines by mapping the input space to a high dimensional feature space. In this high dimensional feature space, linear classification may be performed.

In the last few years, a significant amount of research has been performed in SVMs, including the areas of learning algorithms and training methods, methods for determining the data to use in support vector methods, and decision rules, as well as applications of support vector machines to speaker identification, and time series prediction applications of support vector machines.

Support vector machines have been shown to have a relationship with other recent non-linear classification and modeling techniques such as: radial basis function networks, sparse approximation, PCA (principle components analysis), and regularization. Support vector machines have also been used to choose radial basis function centers.

A key to understanding SVMs is to see how they introduce optimal hyperplanes to separate classes of data in the classifiers. The main concepts of SVMs are reviewed below.

How Support Vector Machines Work

The following describes support vector machines in the context of classification, but the general ideas presented may also apply to regression, or curve and surface fitting.

1. Optimal Hyperplanes

Consider an m-dimensional input vector x=[x₁, . . . , xₘ]^{T}∈X⊂R^{m} and a one-dimensional output y∈{−1,1}. Let there exist n training vectors (xᵢ,yᵢ) i=1, . . , n. Hence we may write X=[x₁x₂ . . . xₙ] or

$$X = [ \begin{matrix}{x}_{11} & … & {x}_{1 n} \\ ⋮ & ⋰ & ⋮ \\ {x}_{m1} & … & {x}_{mn}\end{matrix} ] \qquad ( 1 )$$

A hyperplane capable of performing a linear separation of the training input data is described by

w^{T}X+b=0 (2)

where w=[W₁W₂ . . . Wₘ]^{T}, w∈W⊂R^{m}.

The concept of an optimal hyperplane was proposed by Vladimir Vapnik. For the case where the training input data are linearly separable, an optimal hyperplane separates the data without error and the distance between the hyperplane and the closest training points is maximal.

2. Canonical Hyperplanes

A canonical hyperplane is a hyperplane (in this case we consider the optimal hyperplane) in which the parameters are normalized in a particular manner.

Consider (2) which defines the general hyperplane. It is evident that there is some redundancy in this equation as far as separating sets of points. Suppose we have the following classes

yᵢ[w^{T}x₁+b]≧1i=1, . . . ,n (3)

where yε[−1,1].

One way in which we may constrain the hyperplane is to observe that on either side of the hyperplane, we may have w^{T}x+b>0 or w^{T}x+b<0. Thus, if we place the hyperplane midway between the two closest points to the hyperplane, then we may scale w,b such that

$${min}_{i = 1 … n} \vert {w}^{T} {x}_{i} + b \vert = 0 \qquad ( 4 )$$

Now, the distance d from a point xᵢ to the hyperplane denoted by ( w,b) is given by

$$d ( w , b ; {x}_{i} ) = \frac{\vert {w}^{T} {x}_{i} + b \vert}{‖ w ‖} \qquad ( 5 )$$

where ∥w∥=w^{T}w. By considering two points on opposite sides of the hyperplane, the canonical hyperplane is found by maximizing the margin

$$\begin{matrix}p ( w , b ) = {min}_{i ; {y}_{i} = 1} d ( w , b ; {x}_{i} ) + {min}_{j ; yj = 1} d ( w , b ; {x}_{j} ) \\ = \frac{2}{‖ w ‖}\end{matrix} \qquad ( 6 )$$

This implies that the minimum distance between two classes i and j is at least [2/(∥w∥)].

Hence an optimization function which we seek to minimize to obtain canonical hyperplanes, is

$$J ( w ) = \frac{1}{2} {‖ w ‖}^{2} \qquad ( 7 )$$

Normally, to find the parameters, we would minimize the training error and there are no constraints on w,b. However, in this case, we seek to satisfy the inequality in (3). Thus, we need to solve the constrained optimization problem in which we seek a set of weights which separates the classes in the usually desired manner and also minimizing J(w), so that the margin between the classes is also maximized. Thus, we obtain a classifier with optimally separating hyperplanes.

A Support Vector Machine Learning Rule

For any given data set, one possible method to determine W₀,b₀ such that (8) is minimized would be to use a constrained form of gradient descent. In this case, a gradient descent algorithm is used to minimize the cost function J(w), while constraining the changes in the parameters according to (3). A better approach to this problem however, is to use Lagrange multipliers which is well suited to the non-linear constraints of (3). Thus, we introduce the Lagrangian equation:

$$L ( w , b , α ) = \frac{1}{2} {‖ w ‖}^{2} - {\sum }_{i = 1}^{n} {α}_{i} ( {y}_{i} [ {w}^{T} {x}_{i} + b ] - 1 ) \qquad ( 8 )$$

where αᵢ are the Lagrange multipliers and αᵢ>0.

The solution is found by maximizing L with respect to α₁ and minimizing it with respect to the primal variables w and b. This problem may be transformed from the primal case into its dual and hence we need to solve

$${max}_{α} {min}_{w , b} L ( w , b , α ) \qquad ( 9 )$$

At the solution point, we have the following conditions

$$\begin{matrix}\frac{\partial L ( {w}_{0} , {b}_{0} , {α}_{0} )}{\partial w} = 0 \\ \frac{\partial L ( {w}_{0} , {b}_{0} , {α}_{0} )}{\partial b} = 0\end{matrix} \qquad ( 10 )$$

where solution variables w₀,b₀,α₀ are found. Performing the differentiations, we obtain respectively,

$$\begin{matrix}{\sum }_{i = 1}^{n} {α}_{0 i} {y}_{i} = 0 \\ {w}_{0} = {\sum }_{i = 1}^{n} {α}_{0 i} {x}_{i} {y}_{i}\end{matrix} \qquad ( 11 )$$

and in each case α₀ᵢ>0, i=1, . . . , n.

These are properties of the optimal hyperplane specified by (w₀b₀) note that given the Lagrange multipliers, the desired weight vector solution may be found directly in terms of the training vectors.

To determine the specific coefficients of the optimal hyperplane specified by (w₀,b₀) we proceed as follows. Substitute (13) and (14) into (9) to obtain

$${L}_{D} ( w , b , α ) = {\sum }_{i = 1}^{n} {α}_{i} - \frac{1}{2} {\sum }_{i = 1}^{n} {\sum }_{j = 1}^{n} {α}_{i} {α}_{j} {y}_{i} {y}_{j} ( {x}_{i}^{T} {x}_{j} ) \qquad ( 12 )$$

It is necessary to maximize the dual form of the Lagrangian equation in (15) to obtain the required Lagrange multipliers. Before doing so however, consider (3) once again. We observe that for this inequality, there will only be some training vectors for which the equality holds true. That is, only for some ( xᵢ,yᵢ) will the following equation hold:

yᵢ[w^{T}xᵢ+b]=1 i=1, . . . , n (13)

The training vectors for which this is the case, are called support vectors.

Since we have the Karush-K-ü hn-Tucker (KKT) conditions that α₀ᵢ>0, i=1, . . . , n and that given by (3), from the resulting Lagrangian equation in (9), we may write a further KKT condition

α₀ᵢ(yᵢ[w₀^{T}x₁+b₀]−1)=0 i=1, . . . ,n (14)

This means, that since the Lagrange multipliers α₀ᵢ are nonzero with only the support vectors as defined in (16), the expansion of w₀ in (14) is with regard to the support vectors only.

Hence we have

$${w}_{0} = {\sum }_{i ⋐ S} {α}_{0 i} {x}_{i} {y}_{i} \qquad ( 15 )$$

where S is the set of all support vectors in the training set. To obtain the Lagrange multipliers α₀ᵢ, we need to maximize (15) only over the support vectors, subject to the constraints α₀ᵢ>0, i=1, . . . , n and that given in (13). This is a quadratic programming problem and may be readily solved. Having obtained the Lagrange multipliers, the weights w₀ may be found from (18).

Classification of Linearly Separable Data

A support vector machine which performs the task of classifying linearly separable data is defined as

f(x)=sgn{w^{T}x+b} (16)

where w,b are found from the training set. Hence may be written as

$$f ( x ) = sgn \{ {\sum }_{i ⋐ S} {α}_{0 i} {y}_{i} ( {x}_{i}^{T} x ) + {b}_{0} \} \qquad ( 17 )$$

where α₀ᵢ are determined from the solution of the quadratic programming problem in (15) and b₀ is found as

$${b}_{0} = \frac{1}{2} ( {w}_{0}^{T} {x}_{i}^{+} + {w}_{0}^{T} {x}_{i} ) \qquad ( 18 )$$

where xᵢ⁺ and xᵢ³¹ are any input training vector examples from the positive and negative classes respectively. For greater numerical accuracy, we may also use

$${b}_{0} = \frac{1}{2 n} {\sum }_{i = 1}^{n} ( {w}_{0}^{T} {x}_{i}^{+} + {w}_{0}^{T} {x}_{i} ) \qquad ( 19 )$$

Classification of Non-Linearly Separable Data

For the case where the data are non-linearly separable, the above approach can be extended to find a hyperplane which minimizes the number of errors on the training set. This approach is also referred to as soft margin hyperplanes. In this case, the aim is to

yᵢ[w^{T}xᵢ+b]≧1−ξᵢ i=1, . . . ,n (20)

where ξᵢ>0, i=1, . . . , n. In this case, we seek to minimize to optimize

$$J ( w , ξ ) = \frac{1}{2} {‖ w ‖}^{2} + C {\sum }_{i = 1}^{n} {ξ}_{i} \qquad ( 21 )$$

Non-Linear Support Vector Machines

For some problems, improved classification results may be obtained using a non-linear classifier. Consider (20) which is a linear classifier. A non-linear classifier may be obtained using support vector machines as follows.

The classifier is obtained by the inner product xᵢ^{T}x where i⊂S, the set of support vectors. However, it is not necessary to use the explicit input data to form the classifier. Instead, all that is needed is to use the inner products between the support vectors and the vectors of the feature space.

That is, by defining a kernel

K(xᵢ,x)=xᵢ^{T}x (22)

a non-linear classifier can be obtained as

$$f ( x ) = sgn \{ {\sum }_{i ⋐ S} {α}_{0 i} {y}_{i} K ( {x}_{i} , x ) + {b}_{0} \} \qquad ( 23 )$$

Kernel Functions

A kernel function may operate as a basis function for the support vector machine. In other words, the kernel function may be used to define a space within which the desired classification or prediction may be greatly simplified. Based on Mercer's theorem, as is well known in the art, it is possible to introduce a variety of kernel functions, including:

1. Polynomial

The p^{th} order polynomial kernel function is given by

K(xᵢ,x)= (24)

2. Radial Basis Function

K(xᵢ,x)=e (25)

where γ>0.

3. Multilayer Networks

A multilayer network may be employed as a kernel function as follows. We have

K(xᵢ,x)=σ(θ(xᵢ^{T}x)+φ) (26)

where σ is a sigmoid function.

Note that the use of a non-linear kernel permits a linear decision function to be used in a high dimensional feature space. We find the parameters following the same procedure as before. The Lagrange multipliers may be found by maximizing the functional

$${L}_{D} ( w , b , α ) = {\sum }_{i = 1}^{n} {α}_{i} - \frac{1}{2} {\sum }_{i = 1}^{n} {\sum }_{j = 1}^{n} {α}_{i} {α}_{j} {y}_{i} {y}_{j} K ( {x}_{i} , x ) \qquad ( 27 )$$

When support vector methods are applied to regression or curve-fitting, a high-dimensional “tube” with a radius of acceptable error is constructed which minimizes the error of the data set while also maximizing the flatness of the associated curve or function. In other words, the tube is an envelope around the fit curve, defined by a collection of data points nearest the curve or surface, i.e., the support vectors.

Thus, support vector machines offer an extremely powerful method of obtaining models for classification and regression. They provide a mechanism for choosing the model structure in a natural manner which gives low generalization error and empirical risk.

Construction of Support Vector Machines A support vector machine (e.g., non-linear model 1206) may be built by specifying a kernel function, a number of inputs, and a number of outputs. Of course, as is well known in the art, regardless of the particular configuration of the support vector machine, some type of training process may be used to capture the behaviors and/or attributes of the system or process to be modeled.

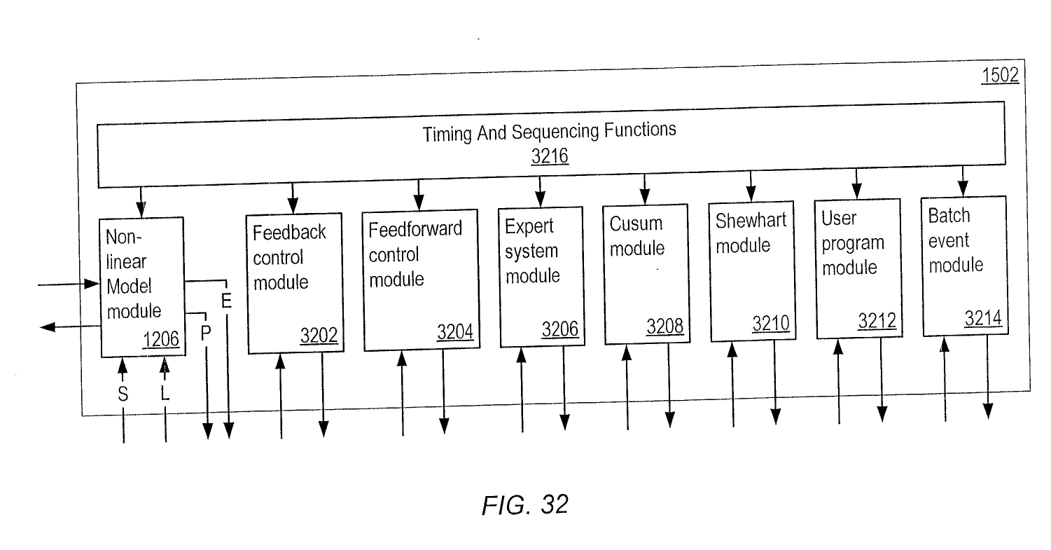

The modular aspect of one embodiment of the present invention as shown in FIG. 32 may take advantage of this way of simplifying the specification of a non-linear model (e.g., a neural network, or a support vector machine). Note that more complex support vector machines and/or other complex non-linear models (e.g., complex neural networks) may require more configuration information, and therefore more storage.

Various embodiments of the present invention may contemplate other types of non-linear model configurations for use with non-linear model 1206. In one embodiment, all that is required for non-linear model 1206 is that the non-linear model be able to be trained and retrained so as to provide needed predicted values.

Support Vector Machine Training

The coefficients used in the support vector machine represented by non-linear model 1206 may be adjustable constants which determine the values of the predicted output data for given input data for any given support vector machine configuration. Support vector machines may be superior to conventional statistical models because support vector machines may adjust these coefficients automatically. Thus, support vector machines may be capable of building the structure of the relationship (or model) between the input data 1220 and the output data 1218 by adjusting the coefficients. While a conventional statistical model typically requires the developer to define the equation(s) in which adjustable constant(s) are used, the support vector machine represented by the non-linear model 1206 may build the equivalent of the equation(s) automatically.

The support vector machine represented by the non-linear model 1206 may be trained by presenting it with one or more training set(s). The one or more training set(s) are the actual history of known input data values and the associated correct output data values. As described below, one embodiment of the present invention may use the historical database with its associated timestamps to automatically create one or more training set(s).

To train the support vector machine, the newly configured support vector machine is usually initialized by assigning random values to all of its coefficients. During training, the support vector machine represented by the non-linear model 1206 may use its input data 1220 to produce predicted output data 1218.

These predicted output data values 1218 may be used in combination with training input data 1306 to produce error data. These error data values may then be used to adjust the coefficients of the support vector machine.

It may thus be seen that the error between the output data 1218 and the training input data 1306 may be used to adjust the coefficients so that the error is reduced.

Advantages of Support Vector Machines

Support vector machines may be superior to computer statistical models because support vector machines do not require the developer of the support vector machine model to create the equations which relate the known input data and training values to the desired predicted values (i.e., output data). In other words, the support vector machine represented by non-linear model 1206 may learn the relationships automatically in the training step 104.

The support vector machine represented by non-linear model 1206 may require the collection of training input data with its associated input data, also called a training set. The training set may need to be collected and properly formatted. The conventional approach for doing this is to create a file on a computer on which the support vector machine is executed.

In one embodiment of the present invention, in contrast, creation of the training set is done automatically using a historical database 1210, as shown in FIG. 17. This automatic step may eliminate errors and may save time, as compared to the conventional approach. Another benefit may be significant improvement in the effectiveness of the training function, since automatic creation of the training set(s) may be performed much more frequently.

Implementation Using a Non-Linear Model

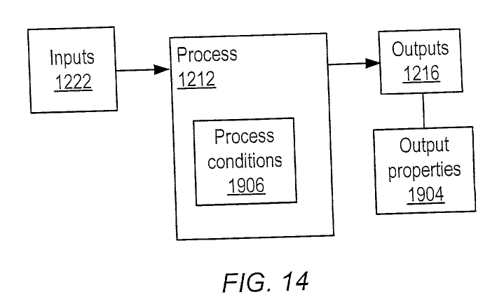

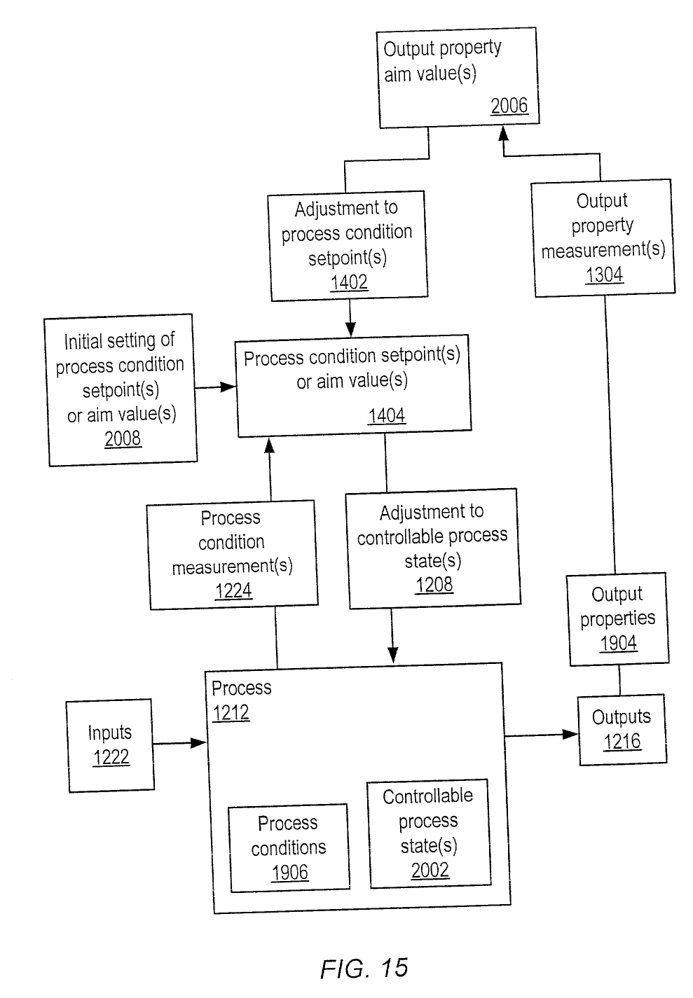

Referring to FIGS. 17 and 18, one embodiment of the present invention may include a computer implemented non-linear model (e.g., a neural network, or a support vector machine) which produces predicted output data values 1218 using a trained non-linear model (e.g., a trained neural network, or a trained support vector machine) supplied with input data 1220 at a specified interval. The predicted data 1218 may be supplied via a historical database 1210 to a controller 1202, which may control a process 1212 which may produce outputs 1216. In this way, the process conditions 1906 and output properties 1904 (as shown in FIGS. 14 and 15) may be maintained at a desired quality level, even though important process conditions and/or output properties may not be effectively measured directly, or modeled using fundamental or conventional statistical approaches. In various embodiments of the present invention, the process being controlled is a “business process”, as described above. When process 1212 represents a business process, the corresponding controller 1202 is intended to include a computer system (e.g., in an e-commerce system, the computer system may be an e-commerce server computer system).

One embodiment of the present invention may be configured by a developer using a non-linear model configuration (e.g., a neural network configuration, or a support vector machine configuration) in step 104. Various parameters of the non-linear model may be specified by the developer by using natural language without knowledge of specialized computer syntax and training. For example, parameters specified by the user may include the type of kernel function (e.g., for a support vector machine), the number of inputs, the number of outputs, as well as algorithm parameters such as cost of constraint violations, and convergence tolerance (epsilon). For the support vector machine non-linear model, other possible parameters specified by the user may depend on which kernel is chosen (e.g., for gaussian kernels, one may specify the standard deviation, for polynomial kernels, one may specify the order of the polynomial). In one embodiment, there may be default values (estimates) for these parameters which may be overridden by user input.

In this way, the system may allow an expert in the process being measured to configure the system without the use of a non-linear model expert (e.g., a neural network expert, or a support vector machine expert).

As shown in FIG. 16, the non-linear model may be automatically trained on-line using input data 1220 and associated training input data 1306 having timestamps (for example, from clock 1230). The input data and associated training input data may be stored in a historical database 1210, which may supply this data (i.e., input data 1220 and associated training input data 1306) to the non-linear model 1206 for training at specified intervals.

The (predicted) output data produced by the non-linear model may be stored in the historical database. The stored output data may be supplied to the controller 1202 for controlling the process as long as the error data between the output data and the training input data 1306 is below an acceptable metric.

The error data may also be used for automatically retraining the non-linear model. This retraining may typically occur while the non-linear model is providing the controller with the output data, via the historical database. The retraining of the non-linear model may result in the output data approaching the training input data as much as possible over the operation of the process. In this way, an embodiment of the present invention may effectively adapt to changes in the process, which may occur in a commercial application.

A modular approach for the non-linear model, as shown in FIG. 32, may be utilized to simplify configuration and to produce greater robustness. In essence, the modularity may be broken out into specifying data and calling subroutines using pointers.

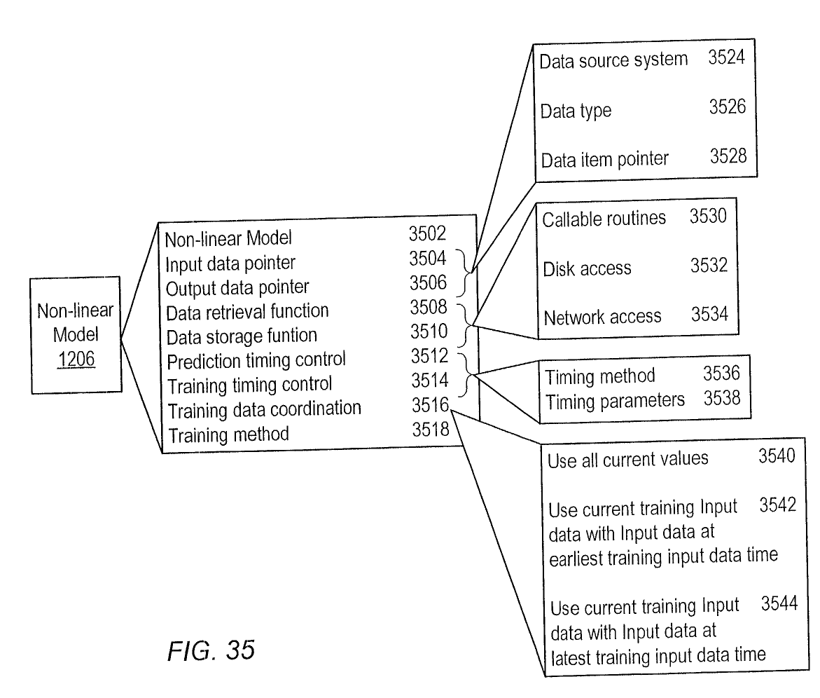

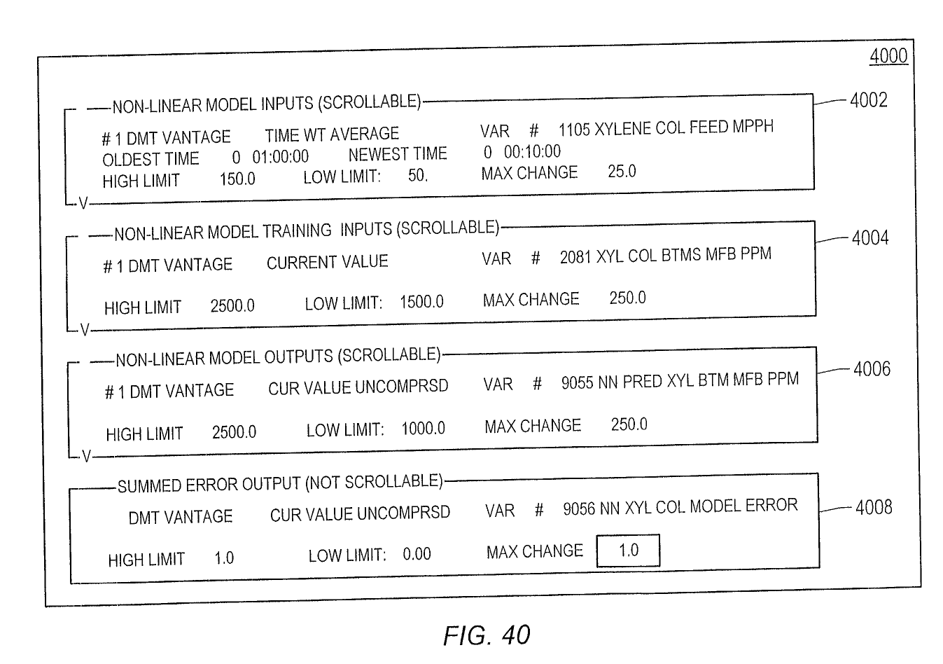

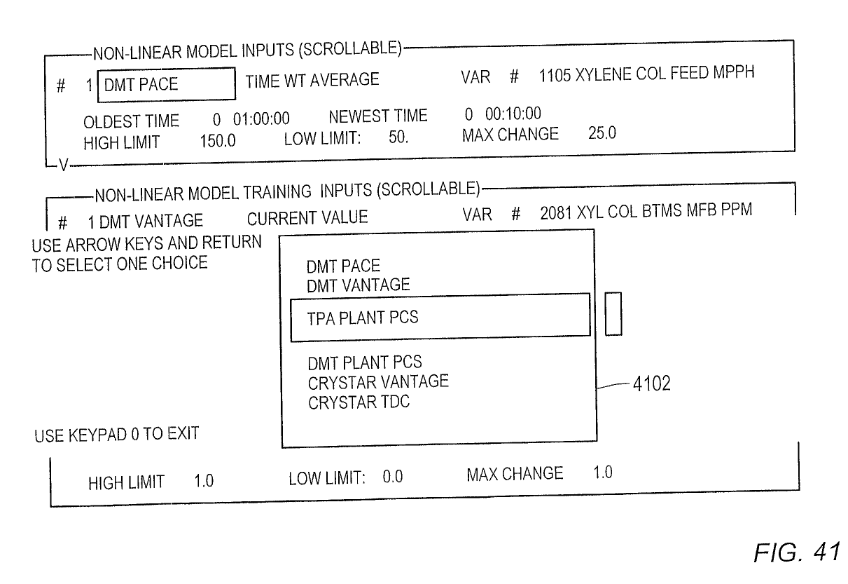

In configuring the non-linear model, as shown in FIG. 35, data pointers 3504 and/or 3506 may be specified. A template approach, as shown in FIGS. 40 and 41, may be used to assist the developer in configuring the non-linear model without having to perform any actual computer programming.

The present invention in various embodiments is a system and method for on-line training of non-linear models for use in electronic commerce systems. The term “on-line” indicates that the data used in various embodiments of the present invention is collected directly from the data acquisition systems which generate this data. An on-line system may have several characteristics. One characteristic may be the processing of data as the data are generated. This characteristic may also be referred to as real-time operation. Real-time operation in general demands that data be detected, processed, and acted upon fast enough to effectively respond to the situation.

In contrast, off-line methods may also be used. In off-line methods, the data being used may be generated at some point in the past and there typically is no attempt to respond in a way that may effect the situation. It is noted that while one embodiment of the present invention may use an on-line approach, alternate embodiments may substitute off-line approaches in various steps.

Use in Combination with Expert Systems

The above description of non-linear models (e.g., neural networks, or support vector machines) as used in various embodiments of the present invention illustrate that non-linear models add a unique and powerful capability to improving processes. Non-linear models may allow the inexpensive creation of predictions of measurements that may be difficult or impossible to obtain. As used in various embodiments of the present invention, non-linear models serve as a source of input data to be used by controllers of various types in controlling a process (e.g., a financial analysis process, an e-commerce process, or any other process which may benefit from the use of predictive models).

Expert systems may provide a completely separate and completely complimentary capability for predictive model based systems. Expert systems may be essentially decision-making programs which base their decisions on process knowledge which is typically represented in the form of if-then rules. Each rule in an expert system makes a small statement of truth, relating something that is known or could be known about the process to something that may be inferred from that knowledge. By combining the applicable rules, an expert system may reach conclusions or make decisions which mimic the decision-making of human experts.

The systems and methods described in several of the United States patents and patent applications incorporated by reference above use expert systems in a control system architecture and method to add this decision-making capability to process control systems. As described in these patents and patent applications, expert systems provide a very advantageous function in the implementation of process control systems.

The present system and method adds a different capability of substituting non-linear models for measurements which may be difficult to obtain. The advantages of the present system may be both consistent with and complimentary to the capabilities provided in the above-noted patents and patent applications using expert systems. The combination of non-linear model capability with expert system capability may provide even greater benefits than either capability provided alone. Thus, by combining non-linear model and expert system capabilities in a single application, greater results may be achieved than using either technique alone.

As described below, when implemented in a modular process architecture, non-linear model functions may be easily combined with expert system functions and other functions to build integrated process applications. Thus, while various embodiments of the present invention may be used alone, these various embodiments of the present invention may provide even greater value when used in combination with the expert system inventions in the above-noted patents and patent applications.

One Method of Operation

One method of operation of one embodiment of the present invention may store input data and training input data, may configure and may train a non-linear model, may predict output data using the non-linear model, may retrain the non-linear model, may enable or may disable control using the output data, and may control the process using output data. As shown in FIG. 18, more than one step may be carried out or performed in parallel. As indicated by the divergent order pointer 120, the first two steps in one embodiment of the present invention may be carried out in parallel. First, in step 102, input data and training input data may be stored in the historical database with associated timestamps. In parallel, the non-linear model may be configured and trained in step 104. Next, two series of steps may be carried out in parallel as indicated by the order pointer 122. First, in step 106, the non-linear model may be used to predict output data using input data stored in the historical database. In parallel, control of the process using the output data may be carried out in step 112 when enabled by step 110 (as shown by the loop indicated by order pointers 126, 130, and 132.

Store Input Data and Training Input Data Step 102

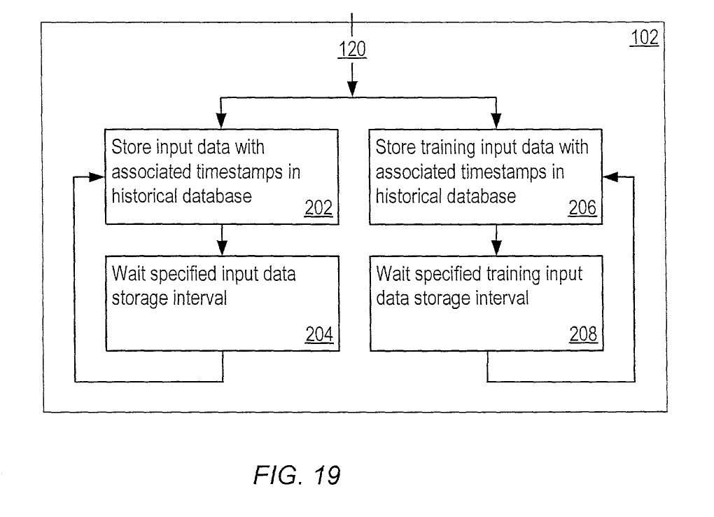

Referring now to FIGS. 18 and 19, step 102 may have the function of storing input data 1220 and storing training input data 1306. Both types of data may be stored in a historical database 1210 (see FIG. 17 and related structure diagrams), for example. Each stored input data and training input data entry in historical database 1210 may utilize an associated timestamp. The associated timestamp may allow the system and method of one embodiment of the present invention to determine the relative time that the particular measurement or predicted value or measured value was taken, produced, or derived.

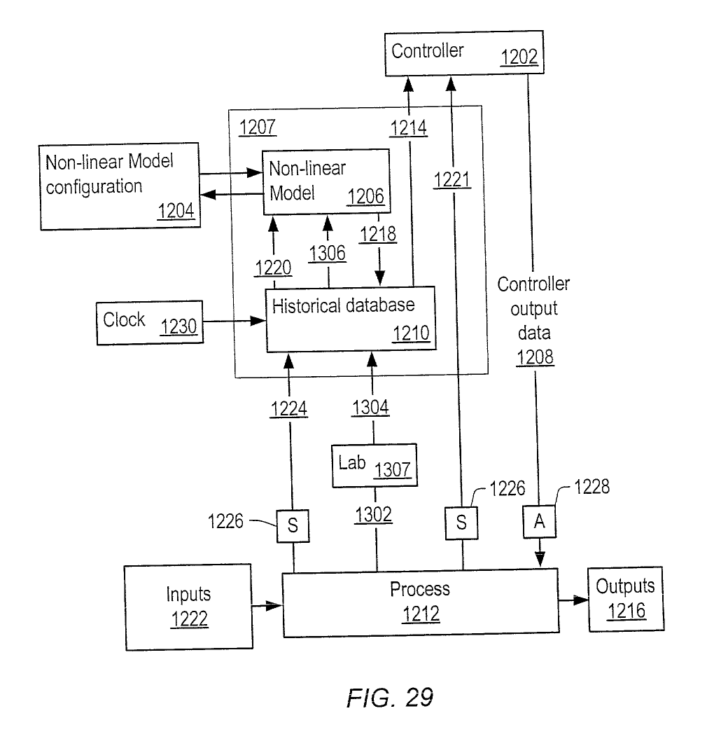

A representative example of step 102 is shown in FIG. 19, which is described as follows. The order pointer 120, as shown in FIG. 19, indicates that input data 1220 and training input data 1306 may be stored in parallel in the historical database 1210, as shown in steps 202 and 206. In one embodiment, input data from sensors 1226 (see FIGS. 17 and 29) may be produced by sampling at specific time intervals the sensor signal 1224 provided at the output of the sensor 1226. It is noted that as used herein, the term “sensor” refers to any program, device, or process which collects data regarding a phenomenon. This sampling may produce an input data value or number or signal. Each of the data points may be called an input datum 1220 as used in this application. The input data may be stored with an associated timestamp in the historical database 1210, as indicated by step 202. The associated timestamp that is stored in the historical database with the input data may indicate the time at which the input data were produced, derived, calculated, etc.

Step 204 shows that the next input data value may be stored by step 202 after a specified input data storage time interval has lapsed or timed out. This input data storage interval realized by step 204 may be set at any specific value (e.g., by the user). Typically, the input data storage interval is selected based on the characteristics of the process being controlled.

As shown in FIG. 19, in addition to the sampling and storing of input data at specified input data storage intervals, training input data 1306 may also be stored. As shown by step 206, training input data may be stored with associated timestamps in the historical database 1210. Again, the associated timestamps utilized with the stored training input data may indicate the relative times at which the training input data were derived, produced, or obtained. It is noted that this usually is the time when the process condition or output property actually existed in the process. In other words, since it may take a relatively long period of time to produce the training input data (one reason may be that analysis has to be performed), it is more accurate to use a timestamp which indicates the actual time when the measured state existed in the process rather than to indicate when the actual training input data was entered into the historical database. This use of a relative timestamp may produce a much closer correlation between the training input data 1306 and the associated input data 1220. A close correlation is desirable, as is discussed in detail below, in order to more effectively train and control the system and method of various embodiments of the present invention.

The training input data may be stored in the historical database 1210 in accordance with a specified training input data storage interval, as indicated by step 208. The training input data storage interval may be a fixed or variable time period. Typically, the training input data storage interval is a time interval which is dictated by when the training input data are actually produced by the laboratory or other mechanism utilized to produce the training input data 1306. As is discussed in detail herein, this often times takes a variable amount of time to accomplish depending upon the process, the mechanisms being used to produce the training input data, and other variables associated both with the process and with the measurement/analysis process utilized to produce the training input data. It is noted that the specified input data storage interval is usually considerably shorter than the specified training input data storage interval.

As may be seen, step 102 thus results in the historical database 1210 receiving values of input data and training input data with associated timestamps. These values may be stored for use by the system and method of one embodiment of the present invention in accordance with the steps and modules discussed in detail below.

Configure and Train Non-Linear Model Step 104

As shown in FIG. 18, the order pointer 120 shows that a configure and train non-linear model step 104 may be performed in parallel with the store input data and training input data step 102. The purpose of step 104 may be to configure and train the non-linear model 1206 (see FIG. 17).

Specifically, the order pointer 120 may indicate that the step 104 plus all of its subsequent steps may be performed in parallel with the step 102.

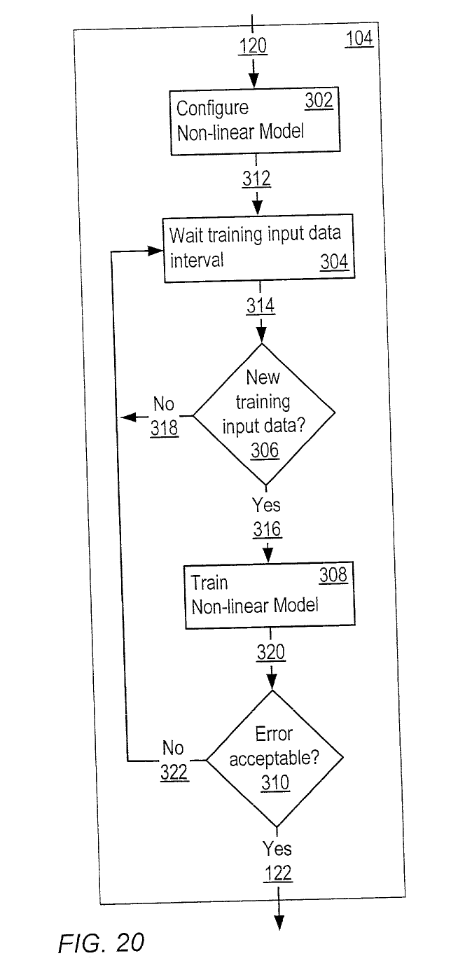

FIG. 20 shows a representative example of the step 104. As shown in FIG. 20, this representative embodiment is made up of five steps 302, 304, 306, 308 and 310.

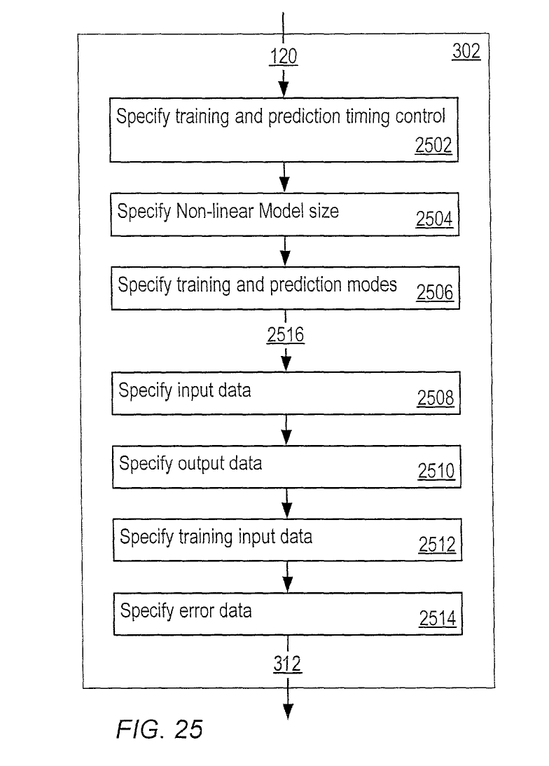

Referring now to FIG. 20, an order pointer 120 shows that the first step of this representative embodiment is a configure non-linear model step 302. Configure non-linear model step 302 may be used to set up the structure and parameters of the non-linear model 1206 that is utilized by the system and method of one embodiment of the present invention. As discussed below in detail, the actual steps utilized to set up the structure and parameters of non-linear model 1206 may be shown in FIG. 25.

After the non-linear model 1206 has been configured in step 302, an order pointer 312 indicates that a wait training input data interval step 304 may occur or may be utilized. The wait training input data interval step 304 may specify how frequently the historical database 1210 is to be looked at to determine if any new training input data to be utilized for training of the non-linear model 1206 exists. It is noted that the training input data interval of step 304 may not be the same as the specified training input data storage interval of step 208 of FIG. 19. Any desired value for the training input data interval may be utilized for step 304.

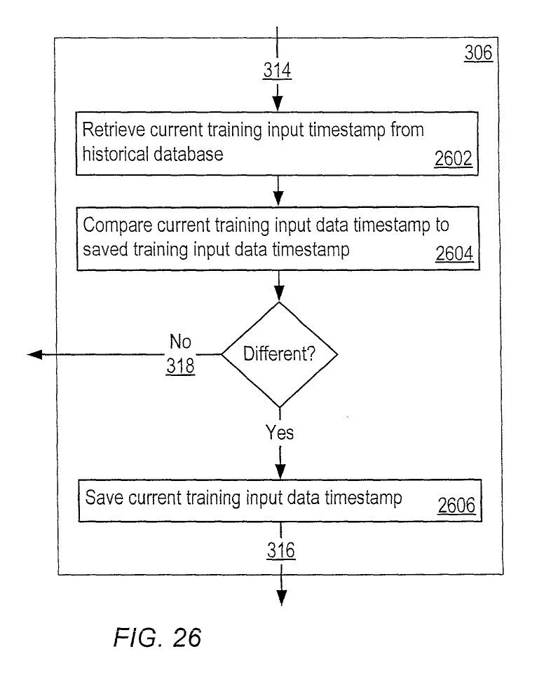

An order pointer 314 indicates that the next step may be a new training input data step 306. This new training input data step 306 may be utilized after the lapse of the training input data interval specified by step 304. The purpose of step 306 may be to examine the historical database 1210 to determine if new training input data has been stored in the historical database since the last time the historical database 1210 was examined for new training input data. The presence of new training input data may permit the system and method of one embodiment of the present invention to train the non-linear model 1206 if other parameters/conditions are met. FIG. 26 discussed below shows a specific embodiment for the step 306.

An order pointer 318 indicates that if step 306 indicates that new training input data are not present in the historical database 1210, the step 306 returns operation to the step 304.

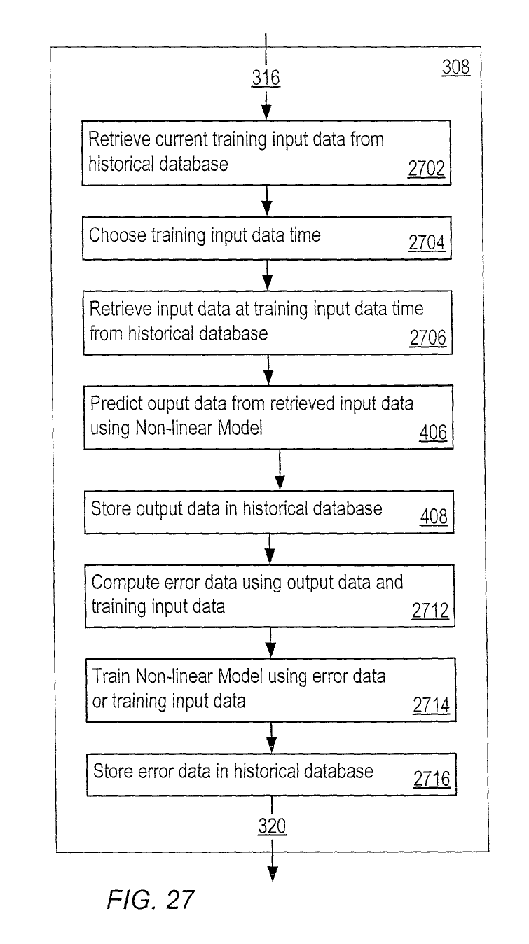

In contrast, if new training input data are present in the historical database 1210, the step 306, as indicated by an order pointer 316, continues processing with a train non-linear model step 308. Train non-linear model step 308 may be the actual training of the non-linear model 1206 using the new training input data retrieved from the historical database 1210. FIG. 27, discussed below in detail, shows a representative embodiment of the train non-linear model step 308.

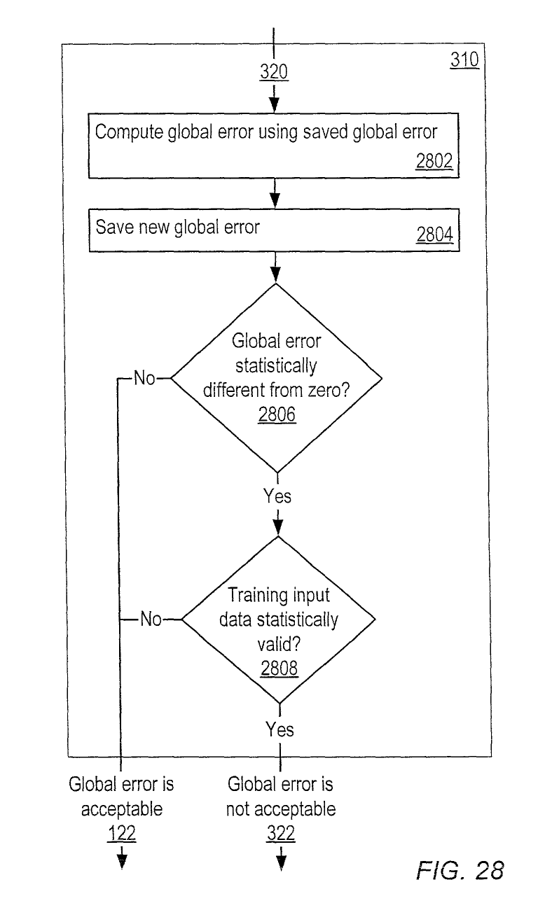

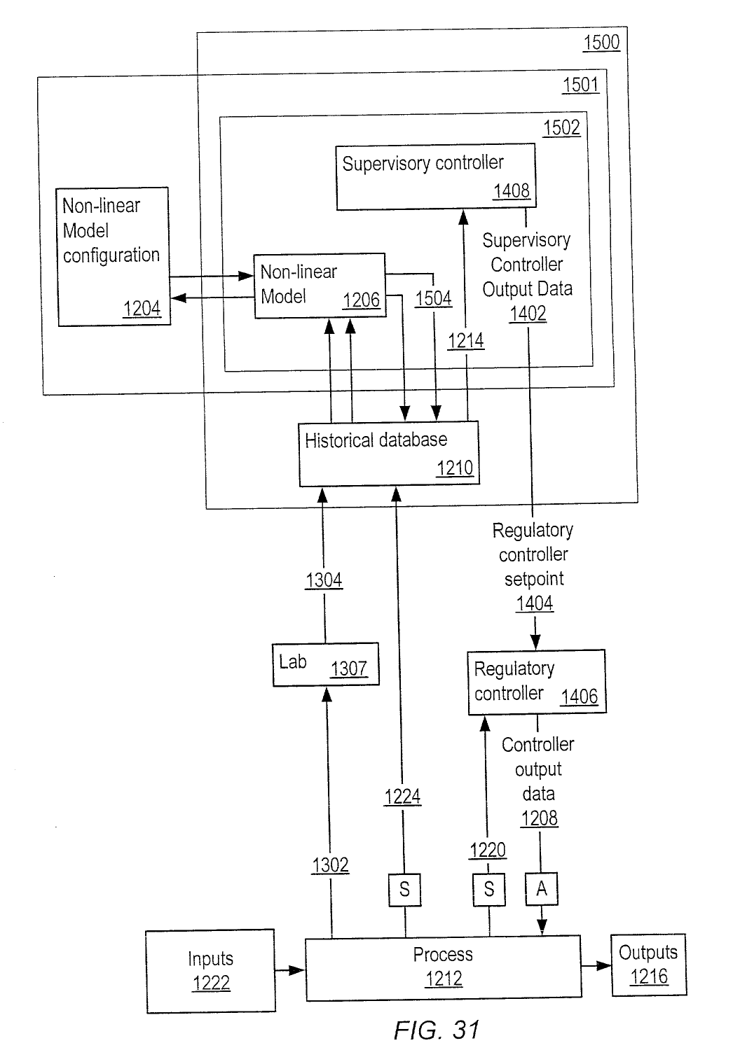

After the non-linear model has been trained, in step 308, the step 104 as indicated by an order pointer 320 may move to an error acceptable step 310. Error acceptable step 310 may determine whether the error data 1504 (as shown in FIG. 31) produced by the non-linear model 1206 is within an acceptable metric, (i.e., the non-linear model 1206 is providing output data 1218 that is close enough to the training input data 1306 to permit the use of the output data 1218 from the non-linear model 1206). In other words, an acceptable error may indicate that the non-linear model 1206 has been “trained” as training is specified by the user of the system and method of one embodiment of the present invention. A representative example of the error acceptable step 310 is shown in FIG. 28, which is discussed in detail below.

If an unacceptable error is determined by error acceptable step 310, an order pointer 322 indicates that the step 104 returns to the wait training input data interval step 304. In other words, when an unacceptable error exists, the step 104 has not completed training the non-linear model 1206. Because the non-linear model 1206 has not completed being trained, training may continue before the system and method of one embodiment of the present invention may move to steps 106 and 112 discussed below.

In contrast, if the error acceptable step 310 determines that an acceptable error from the non-linear model 1206 has been obtained, then the step 104 has trained non-linear model 1206. Since the non-linear model 1206 has now been trained, step 104 may allow the system and method of one embodiment of the present invention to move to the steps 106 and 112 discussed below.

Configure Non-Linear Model Step 302

Referring now to FIG. 25, a representative embodiment of the configure non-linear model step 302 is shown. This step 302 may allow the uses of one embodiment of the present invention to both configure and re-configure the non-linear model. Referring now to FIG. 25, the order pointer 120 indicates that the first step may be a specify training and prediction timing control step 2502. Step 2502 may allow the user configuring the system and method of one embodiment of the present invention to specify the training interval(s) and the prediction timing interval(s) of the non-linear model 1206.

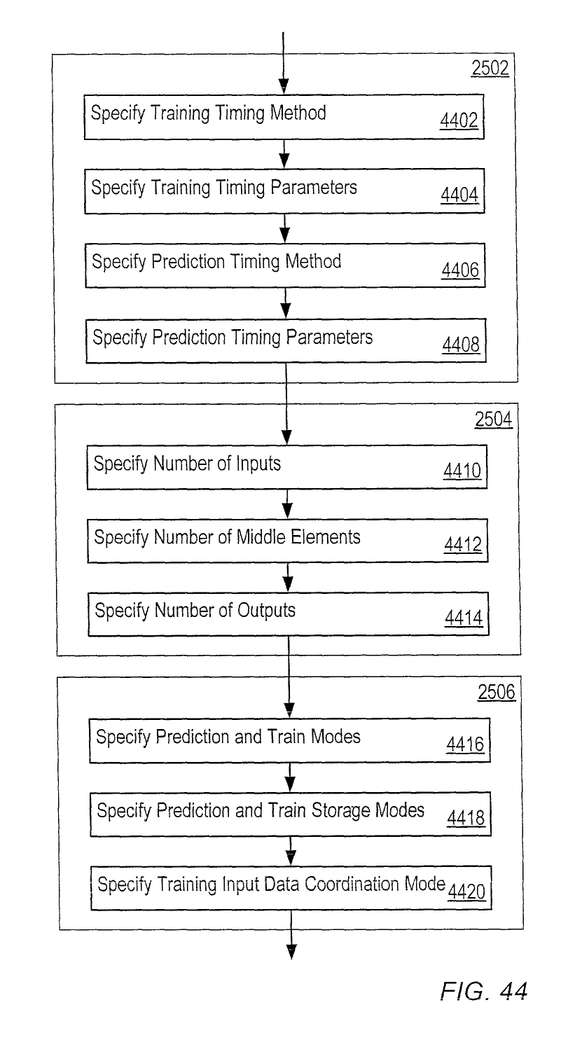

FIG. 44 shows a representative embodiment of the step 2502. Referring now to FIG. 44, step 2502 may be made up of four steps 4402, 4404, 4406, and 4408. Step 4402 may be a specify training timing method step. The specify training timing method step 4402 may allow the user configuring one embodiment of the present invention to specify the method or procedure to be followed to determine when the non-linear model 1206 is being trained. A representative example of this may be when all of the training input data has been updated. Another example may be the lapse of a fixed time interval. Other methods and procedures may be utilized, as desired.

An order pointer indicates that a specify training timing parameters step 4404 may then be carried out by the user of one embodiment of the present invention. This step 4404 may allow for any needed training timing parameters to be specified. It is noted that the method or procedure of step 4402 may result in zero or more training timing parameters, each of which may have a value. This value may be a time value, a module number (e.g., in the modular embodiment of the present invention of FIG. 32), or a data pointer. In other words, the user may configure one embodiment of the present invention so that considerable flexibility may be obtained in how training of the non-linear model 1206 may occur, based on the method or procedure of step 4402.

An order pointer indicates that once the training timing parameters 4404 have been specified, a specify prediction timing method step 4406 may be configured by the user of one embodiment of the present invention. This step 4406 may specify the method or procedure that may be used by the non-linear model 1206 to determine when to predict output data values 1218 after the non-linear model has been trained. This is in contrast to the actual training of the non-linear model 1206. Representative examples of methods or procedures for step 4406 may include: execute at a fixed time interval, execute after the execution of a specific module, and execute after a specific data value is updated. Other methods and procedures may also be used.

An order indicator in FIG. 44 shows that a specify prediction timing parameters step 4408 may then be carried out by the user of one embodiment of the present invention. Any needed prediction timing parameters for the method or procedure of step 4406 may be specified. For example, the time interval may be specified as a parameter for the execute at a fixed time interval method or procedure. Another example may be the specification of a module identifier when the execute after the execution of a specific module method or procedure is specified. Another example may be a data pointer when the execute after a specific data value is updated method or procedure is used. Other prediction timing parameters may be used.

Referring again to FIG. 25, after the specify training and prediction timing control step 2502 has been specified, a specify non-linear model size step 2504 may be carried out. This step 2504 may allow the user to specify the size and structure of the non-linear model 1206 that is used by one embodiment of the present invention.

Specifically, referring to FIG. 44 again, a representative example of how the non-linear model size may be specified by step 2504 is shown. An order pointer indicates that a specify number of inputs step 4410 may allow the user to indicate the number of inputs that the non-linear model 1206 may have. Note that the source of the input data for the specified number of inputs in the step 4410 is not specified. Only the actual number of inputs is specified in the step 4410.

In step 4412, a specific number of middle (hidden) layer elements may be determined for the non-linear model. When the non-linear model is a neural network, these middle elements may be one or more internal layers of the neural network. When the non-linear model is a support vector machine, these middle elements may be one or more kernel functions. The specific kernel functions chosen may determine the kind of support vector machine (e.g., radial basis function, polynomial, multi-layer network, etc.). Depending upon the specific kernel functions chosen, additional parameters may be specified. For example, as mentioned above, for gaussian kernels, one may specify the standard deviation, for polynomial kernels, one may specify the order of the polynomial. In one embodiment, there may be default values (estimates) for these parameters which may be overridden by user input.

It is noted that in other embodiments, various other training or execution parameters of the non-linear model not shown in FIG. 44 may be specified by the user (e.g., algorithm parameters such as cost of constraint violations, and convergence tolerance (epsilon)).

An order pointer indicates that once the middle elements have been specified in step 4412, a specify number of outputs step 4414 may allow the user to indicate the number of outputs that the non-linear model 1206 may have. Note that the storage location for the outputs of the non-linear model 1206 is not specified in step 4414. Instead, only the actual number of outputs is specified in the step 4414.

As discussed herein, one embodiment of the present invention may contemplate any form of presently known or future developed configuration for the structure of the non-linear model 1206. Thus, steps 4410, 4412, and 4414 may be modified so as to allow the user to specify these different configurations for the non-linear model 1206.

Referring again to FIG. 25, once the non-linear model size has been specified in step 2504, the user may specify the training and prediction modes in step 2506. Step 2506 may allow both the training and prediction modes to be specified. Step 2506 may also allow for controlling the storage of the data produced in the training and prediction modes. Step 2506 may also allow for data coordination to be used in training mode.

A representative example of the specify training and prediction modes step 2506 is shown in FIG. 44. It is made up of steps 4416, 4418, and 4420.

As shown in FIG. 44, an order pointer indicates that the user may specify prediction and train modes in step 4416. These prediction and train modes may be yes/no or on/off settings, in one embodiment. Since the system and method of one embodiment of the present invention is in the train mode at this stage in its operation, step 4416 typically goes to its default setting of train mode only. However, various embodiments of the present invention may contemplate allowing the user to independently control the prediction or train modes.

When prediction mode is enabled or “on,” the non-linear model 1206 may predict output data values 1218 using retrieved input data values 1220, as described below. When training mode is enabled or “on,” the non-linear model 1206 may monitor the historical database 1210 for new training input data and may train using the training input data, as described below.

An order pointer indicates that once the prediction and train modes have been specified in step 4416, the user may specify prediction and train storage modes in step 4418. These prediction and train storage modes may be on/off, yes/no values, similar to the modes of step 4416. The prediction and train storage modes may allow the user to specify whether the output data produced in the prediction and/or training may be stored for possible later use. In some situations, the user may specify that the output data are not to be stored, and in such a situation the output data will be discarded after the prediction or train mode has occurred. Examples of situations where storage may not be needed include: (1) if the error acceptable metric value in the train mode indicates that the output data are poor and retraining is necessary; (2) in the prediction mode, where the output data are not stored but are only used. Other situations may arise where no storage is warranted.

An order pointer indicates that a specify training input data coordination mode step 4420 may then be specified by the user. Oftentimes, training input data 1306 may be correlated in some manner with input data 1220. Step 4420 may allow the user to deal with the relatively long time period required to produce training input data 1306 from when the measured state(s) existed in the process. First, the user may specify whether the most recent input data are to be used with the training input data, or whether prior input data are to be used with the training input data. If the user specifies that prior input data are to be used, the method of determining the time of the prior input data may be specified in step 4420.

Referring again to FIG. 25, once the specify training and prediction modes step 2506 has been completed by the user, steps 2508, 2510, 2512 and 2514 may be carried out. In one embodiment, the user may follow specify input data step 2508, specify output data step 2510, specify training input data step 2512, and specify error data step 2514. Essentially, these four steps 2508-2514 may allow the user to specify the source and destination of input data and output data for both the (run) prediction and training modes, and the storage location of the error data determined in the training mode.

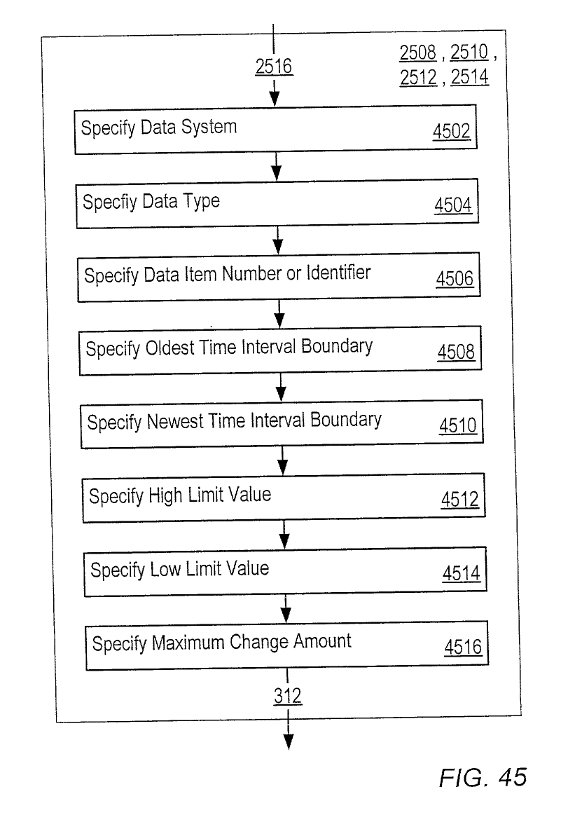

FIG. 45 shows a representative embodiment used for all of the steps 2508-2514 as follows.

Steps 4502, 4504, and 4506 essentially may be directed to specifying the data location for the data being specified by the user. In contrast, steps 4508-4516 may be optional in that they allow the user to specify certain options or sanity checks that may be performed on the data as discussed below in more detail.

The data system may be specified in step 4502. Step 4502 may allow for the user to specify which computer system(s) contains the data or storage location that is being specified.

Once the data system has been specified, the user may specify the data type using step 4504. The data type may indicate which of the many types of data and/or storage modes is desired. Examples may include current (most recent) values of measurements, historical values, time averaged values, setpoint values, limits, etc. After the data type has been specified, the user may specify a data item number or identifier using step 4506. The data item number or identifier may indicate which of the many instances of the specific data type in the specified data system is desired. Examples may include the measurement number, the control loop number, the control tag name, etc. These three steps 4502-4506 may thus allow the user to specify the source or destination of the data (used/produced by the non-linear model) being specified.

Once this information has been specified, the user may specify the following additional parameters. The user may specify the oldest time interval boundary using step 4508, and may specify the newest time interval boundary using step 4510. For example, these boundaries may be utilized where a time weighted average of a specified data value is needed. Alternatively, the user may specify one particular time when the data value being specified is a historical data point value.

Sanity checks on the data being specified may be specified by the user using steps 4512, 4514 and 4516 as follows. The user may specify a high limit value using step 4512, and may specify a low limit value using step 4514. This sanity check on the data may allow the user to prevent the system and method of one embodiment of the present invention from using false data. Other examples of faulty data may also be detected by setting these limits.

The high limit value and/or the low limit value may be used for scaling the input data. Non-linear models may be typically trained and operated using input data, output data, and training input data scaled within a fixed range. Using the high limit value and/or the low limit value may allow this scaling to be accomplished so that the scaled values use most of the range.

In addition, the user may know that certain values will normally change a certain amount over a specific time interval. Thus, changes which exceed these limits may be used as an additional sanity check. This may be accomplished by the user specifying a maximum change amount in step 4516.

Sanity checks may be used in the method of one embodiment of the present invention to prevent erroneous training, prediction, and control. Whenever any data value fails to pass the sanity checks, the data may be clamped at the limit(s), or the operation/control may be disabled. These tests may significantly increase the robustness of various embodiments of the present invention.

It is noted that these steps in FIG. 45 apply to the input data, the output data, the training input data, and the error data steps 2508, 2510, 2512 and 2514.

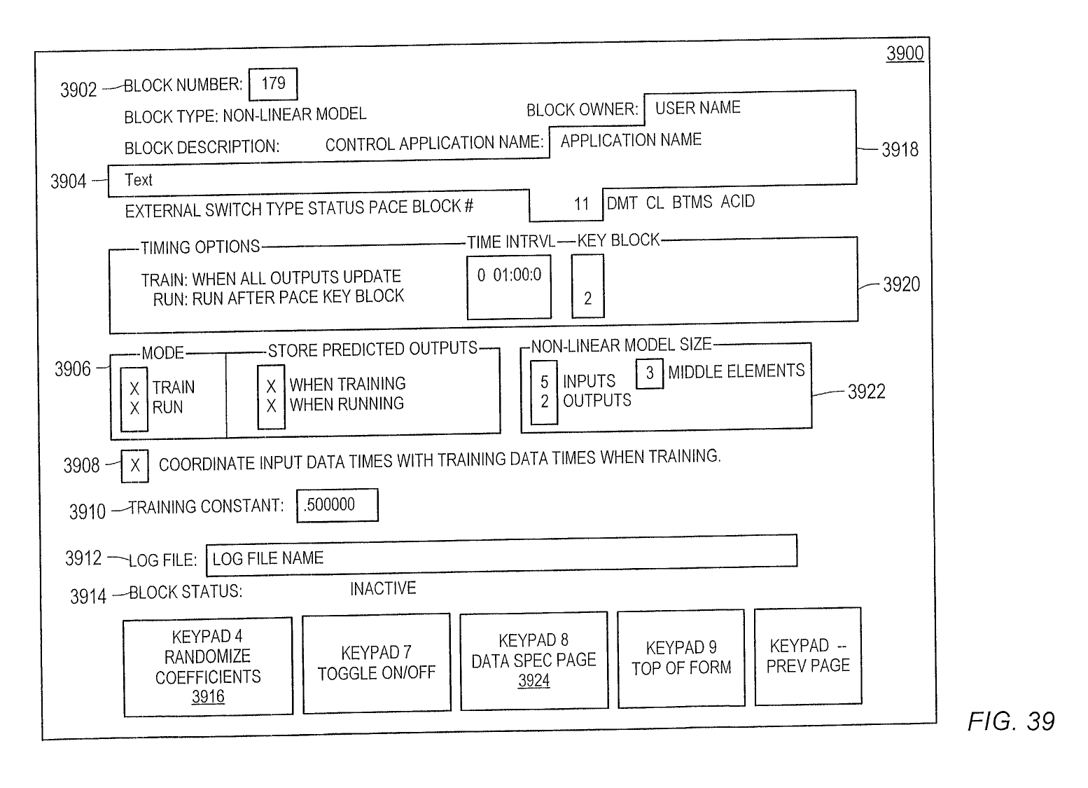

When the non-linear model is filly configured, the coefficients may be normally set to random values in their allowed ranges. This may be done automatically, or it may be performed on demand by the user (for example, using softkey randomize coefficients 3916 in FIG. 39).

Wait Training Input Data Interval Step 304

Referring again to FIG. 20, the wait training input data interval step 304 is now described in greater detail.

Typically, the wait training input data interval is much shorter than the time period (interval) when training input data becomes available. This wait training input data interval may determine how often the training input data will be checked to determine whether new training input data has been received. Obviously, the more frequently the training input data are checked, the shorter the time interval will be from when new training input data becomes available to when retraining has occurred.

It is noted that the configuration for the non-linear model 1206 and specifying its wait training input data interval may be done by the user. This interval may be inherent in the software system and method which contains the non-linear model of one embodiment of the present invention. Preferably, it is specifically defined by the entire software system and method of one embodiment of the present invention. Next, the non-linear model 1206 is trained.

New Training Input Data Step 306

An order pointer 314 indicates that once the wait training input data interval 304 has elapsed, the new training input data step 306 may occur.

FIG. 26 shows a representative embodiment of the new training input data step 306. Referring now to FIG. 26, a representative example of determining whether new training input data has been received is shown. A retrieve current training input timestamp from historical database step 2602 may first retrieve from the historical database 1210 the current training input data timestamp(s). As indicated by an order pointer, a compare current training input data timestamp to saved or stored training input data timestamp step 2604 may compare the current training input data timestamp(s) with saved training input data timestamp(s). Note that when the system and method of one embodiment of the present invention is first started, an initialization value may be used for the saved training input data timestamp. If the current training input data timestamp is the same as the saved training input data timestamp, this may indicate that new training input data does not exist, as shown by order pointer 318.

Step 2604 may function to determine whether any new training input data are available for use in training the non-linear model. In various embodiments of the present invention, the presence of new training input data may be detected or determined in various ways. One specific example is where only one storage location is available for training input data and the associated timestamp. In this case, detecting or determining the presence of new training input data may be carried out by saving internally in the non-linear model the associated timestamp of the training input data from the last time the training input data was checked, and periodically retrieving the timestamp from the storage location for the training input data and comparing it to the internally saved value of the timestamp. Other distributions and combinations of storage locations for timestamps and/or data values may be used in detecting or determining the presence of new training input data.

If the comparison of step 2604 indicates that the current training input data timestamp is different from the saved training input data timestamp, this may indicate that new training input data has been received or detected. This new training input data timestamp may be saved by a save current training input data timestamp step 2606. After this current timestamp of training input data has been saved, the new training input data step 306 is completed, and one embodiment of the present invention may move to the train non-linear model step 308 of FIG. 20 as indicated by order pointer 316.

Train Non-Linear Model Step 308

Referring again to FIG. 20, the train non-linear model step 308 may be the step where the non-linear model 1206 is trained. FIG. 27 shows a representative embodiment of the train non-linear model step 308.

Referring now to step 308 shown in FIG. 27, an order pointer 316 indicates that a retrieve current training input data from historical database step 2702 may occur. In step 2702, one or more current training input data values may be retrieved from the historical database 1210. The number of current training input data values that is retrieved may be equal to the number of outputs of the non-linear model 1206 that is being trained. The training input data are normally scaled. This scaling may use the high and low limit values specified in the configure and train non-linear model step 302, as shown in FIG. 45.

An order pointer shows that a choose training input data time step 2704 may be carried out next. Typically, when there are two or more current training input data values that are retrieved, the data time (as indicated by their associated timestamps) for them is different. The reason for this is that typically the sampling schedule used to produce the training input data are different for the various training input data. Thus, current training input data often have varying associated timestamps. In order to resolve these differences, certain assumptions are made. In certain situations, the average between the timestamps may be used. Alternately, the timestamp of one of the current training input data may be used. Other approaches also may be employed.

Once the training input data time has been chosen in step 2704, the input data at the training input data time may be retrieved from the historical database 1210 as indicated by step 2706. The input data are normally scaled. This scaling may use the high and low limit values specified in the configure and train non-linear model step 302, as shown in FIG. 45. Thereafter, the non-linear model 1206 may predict output data from the retrieved input data, as indicated by step 406.

The predicted output data from the non-linear model 1206 may then be stored in the historical database 1210, as indicated by step 408. The output data are normally produced in a scaled form, since all the input and training input data are scaled. In this case, the output data may be de-scaled. This de-scaling may use the high and low limit values specified in the configure and train non-linear model step 302. Thereafter, error data may be computed using the predicted output data from the non-linear model 1206 and the training input data, as indicated by step 2712. It is noted that the term error data 1504 as used in step 2712 may be a set of error data values for all of the predicted outputs from the non-linear model 1206. However, one embodiment of the present invention may also contemplate using a global or cumulative error data for evaluating whether the predicted output data values are acceptable.

After the error data 1504 has been computed or calculated in step 2712, the non-linear model 1206 may be retrained using the error data 1504 and/or the training input data 1306, as indicated by step 2714. One embodiment of the present invention may contemplate any method of training the non-linear model 1306.

After the training step 2714 is completed, the error data 1504 may be stored in the historical database 1210 in step 2716. It is noted that the error data 1504 shown here may be the individual data for each output. These stored error data 1504 may provide a historical record of the error performance for each output of the non-linear model 1206.

The sequence of steps described above may be used when the non-linear model 1206 is effectively trained using a single presentation of the training set created for each new training input data 1306.

However, in using certain training methods or for certain applications, the non-linear model 1206 may require many presentations of training sets to be adequately trained (i.e., to produce an acceptable metric). In this case, two alternate approaches may be used to train the non-linear model 1206, among other approaches.

In the first approach, the non-linear model 1206 may save the training sets (i.e., the training input data and the associated input data which is retrieved in steps 2702 and 2706) in a database of training sets, which may then be repeatedly presented to the non-linear model 1206 to train the non-linear model. The user may be able to configure the number of training sets to be saved. As new training input data becomes available, new training sets may be constructed and saved. When the specified number of training sets has been accumulated (e.g., in a “buffer”), the next training set created based on new data may “bump” the oldest training set from the buffer. This oldest training set may then be discarded. Conventional non-linear model training creates training sets all at once, off-line, and would continue using all the training sets created.

A second approach which may be used is to maintain a time history of input data and training input data in the historical database 1210 (e.g., in a “buffer”), and to search the historical database 1210, locating training input data and constructing the corresponding training set by retrieving the associated input data.

The combination of the non-linear model 1206 and the historical database 1210 containing both the input data and the training input data with their associated timestamps may provide a very powerful platform for building, training and using the non-linear model 1206. One embodiment of the present invention may contemplate various other modes of using the data in the historical database 1210 and the non-linear model 1206 to prepare training sets for training the non-linear model 1206.

Error Acceptable Step 310

Referring again to FIG. 20, once the non-linear model 1206 has been trained in step 308, a determination of whether an acceptable error exists may occur in step 310. FIG. 28 shows a representative embodiment of the error acceptable step 310.

Referring now to FIG. 28, an order pointer 320 indicates that a compute global error using saved global error step 2802 may occur. The term global error as used herein means the error over all the outputs and/or over two or more training sets (cycles) of the non-linear model 1206. The global error may reduce the effects of variation in the error from one training set (cycle) to the next. One cause for the variation is the inherent variation in data tests used to generate the training input data.

Once the global error has been computed or estimated in step 2802, the global error may be saved in step 2804. The global error may be saved internally in the non-linear model 1206, or it may be stored in the historical database 1210. Storing the global error in the historical database 1210 may provide a historical record of the overall performance of the non-linear model 1206.

Thereafter, if an appropriate history of global error is available (as would be the case in retraining), step 2806 may be used to determine if the global error is statistically different from zero. Step 2806 may determine whether a sequence of global error values falls within the expected range of variation around the expected (desired) value of zero, or whether the global error is statistically significantly different from zero. Step 2806 may be important when the training input data used to compute the global error has significant random variability. If the non-linear model 1206 is making accurate predictions, the random variability in the training input data may cause random variation of the global error around zero. Step 2806 may reduce the tendency to incorrectly classify as not acceptable the predicted outputs of the non-linear model 1206.

If the global error is not statistically different from zero, then the global error is acceptable, and one embodiment of the present invention may move to order pointer 122. An acceptable error indicated by order pointer 122 means that the non-linear model 1206 is trained. This completes step 104.

However, if the global error is statistically different from zero, one embodiment of the present invention in the retrain mode may move to step 2808. Step 2808 may determine whether the training input data are statistically valid. It is noted that step 2808 is not needed in the training mode of step 104. In the training mode, a global error statistically different from zero moves directly to order pointer 322, and thus back to the wait training input data interval step 304, as indicated in FIG. 20.

If the training input data in the retraining mode is not statistically valid, this may indicate that the acceptability of the global error may not be determined, and one embodiment of the present invention may move to order pointer 122. However, if the training input data are statistically valid, this may indicate that the error is not acceptable, and one embodiment of the present invention may move to order pointer 322, and thus back to the wait training input data interval step 304, as indicated in FIG. 20.

The steps described here for determining whether the global error is acceptable constitute one example of implementing a global error acceptable metric. Different process characteristics, different sampling frequencies, and/or different measurement techniques (for process conditions and output properties) may indicate alternate methods of determining whether the error is acceptable. One embodiment of the present invention may contemplate any method of creating an error acceptable metric.

Predict Output Data Using Non-Linear Model Step 106

Referring again to FIG. 18, the order pointer 122 indicates that there are two parallel paths that one embodiment of the present invention may use after the configure and train non-linear model step 104. One of the paths, which the predict output data using non-linear model step 106 described below is part of, may be used for: predicting output data using the non-linear model 1206; retraining the non-linear model 1206 using these predicted output data; and disabling control of the controlled process when the (global) error from the non-linear model 1206 exceeds a specified error acceptable metric (criterion). The other path may be the actual control of the process using the predicted output data from the non-linear model 1206.

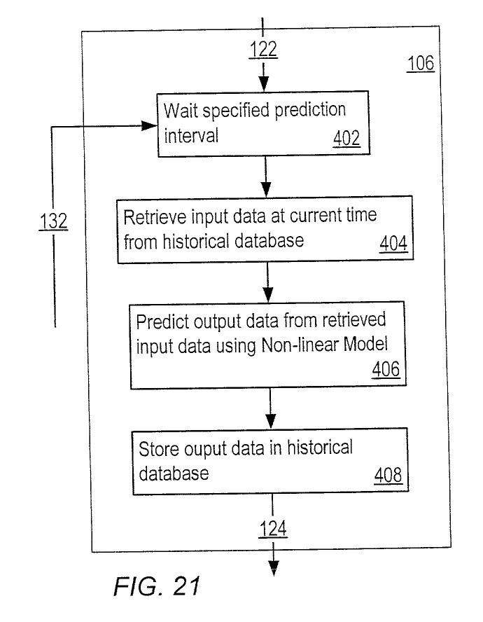

Turning now to the predict output data using non-linear model step 106, this step 106 may use the non-linear model 1206 to produce output data for use in control of the process and for retraining the non-linear model 1206. FIG. 21 shows a representative embodiment of step 106.

Turning now to FIG. 21, a wait specified prediction interval step 402 may utilize the method or procedure specified by the user in steps 4406 and 4408 (shown in FIG. 44) for determining when to retrieve input data. Once the specified prediction interval has elapsed, one embodiment of the present invention may move to a retrieve input data at current time from historical database step 404. The input data may be retrieved at the current time. That is, the most recent value available for each input data value may be retrieved from the historical database 1210.

The non-linear model 1206 may then predict output data from the retrieved input data, as indicated by step 406. This predicted output data may be used for retraining and/or control purposes as discussed below. Prediction of the output data may be done using any presently known or future developed approach. The predicted output data from the non-linear model 1206 may then be stored in the historical database 1210, as indicated by step 408.

Retrain Non-Linear Model Step 108

Referring again to FIG. 18, once the predicted output data has been produced by the non-linear model 1206, a retrain non-linear model step 108 may be used.

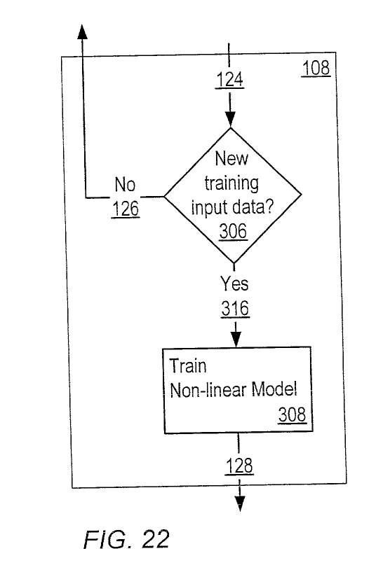

Retraining of the non-linear model 1206 may occur when new training input data becomes available. FIG. 22 shows a representative embodiment of the retrain non-linear model step 108.

Referring now to FIG. 22, an order pointer 124 shows that a new training input data step 306 may determine if new training input data has become available. FIG. 26 shows a representative embodiment of the new training input data step 306. Step 306 is described above in connection with FIG. 20.

As indicated by an order pointer 126, if new training input data are not present, one embodiment of the present invention may return to the predict output data using non-linear model step 106, as shown in FIG. 18.

If new training input data are present, the non-linear model 1206 may be retrained, as indicated by step 308. A representative example of step 308 is shown in FIG. 27. It is noted that training of the non-linear model is the same as retraining, and retraining is described in connection with FIG. 20, above.

Once the non-linear model 1206 has been retrained, an order pointer 128 may cause one embodiment of the present invention to move to an enable/disable control step 110, as discussed below.

Enable/Disable Control Step 110

Referring again to FIG. 18, once the non-linear model 1206 has been retrained, as indicated by step 108, one embodiment of the present invention may move to an enable/disable control step 110. The purpose of the enable/disable control step 110 may be to prevent the control of the process using output data (predicted values) produced by the non-linear model 1206 when the error is not acceptable (i.e., when the error is “poor”).

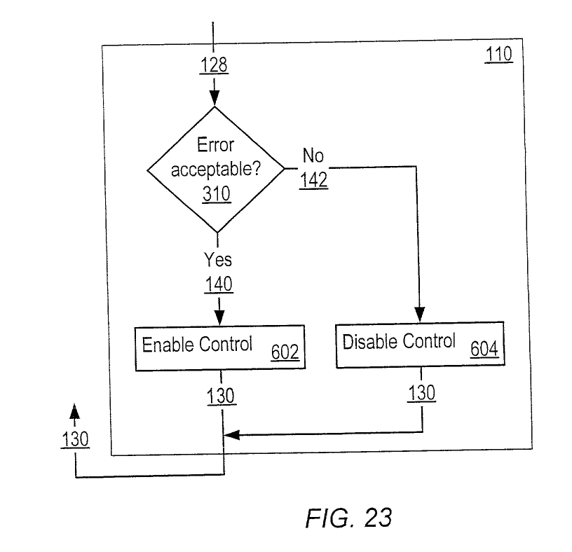

A representative example of the enable/disable control step 110 is shown in FIG. 23. Referring now to FIG. 23, the function of step 110 may be to enable control of the controlled process if the error is acceptable, and to disable control if the error is unacceptable. As shown in FIG. 23, an order pointer 128 may move one embodiment of the present invention to an error acceptable step 310. If the error between the training input data and the predicted output data is unacceptable, control of the controlled process is disabled by a disable control step 604. The disable control step 604 may set a flag or indicator which may be examined by the control process using output data step 112 (shown in FIG. 18). The flag may indicate that the output data should not be used for control.

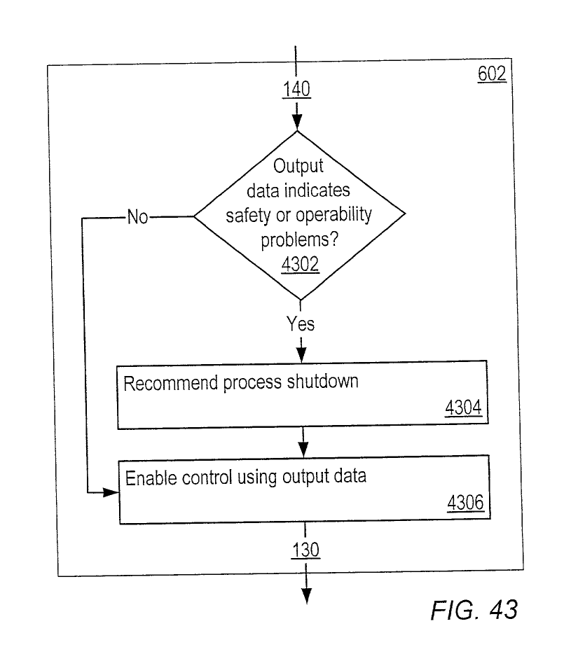

FIG. 43 shows a representative embodiment of the enable control step 602. Referring now to FIG. 43, an order pointer 140 may cause one embodiment of the present invention first to move to an output data indicates safety or operability problems step 4302. If the output data does not indicate a safety or operability problem, this may indicate that the process 1212 may continue to operate safely. Thus, processing may move to the enable control using output data step 4306.

In contrast, if the output data does indicate a safety or operability problem, one embodiment of the present invention may recommend that the process being controlled be shut down, as indicated by a recommend process shutdown step 4304. This recommendation to the operator of the process 1212 may be made using any suitable approach. One example of recommendation to the operator is a screen display or an alarm indicator. This safety feature may allow one embodiment of the present invention to prevent the controlled process 1212 from reaching a critical situation.

If the output data does not indicate safety or operability problems in step 4302, or after the recommendation to shut down the process has been made in step 4304, one embodiment of the present invention may move to the enable control using output data step 4306. Step 4306 may set a flag or indicator which may be examined by step 112 (shown in FIG. 18), indicating that the output data should be used to control the process.

Thus, it may be appreciated that the enable/disable control step 110 may provide the following functions: (1) allowing control of the process 1212 using the output data in step 112, (2) preventing the use of the output data in controlling the process 1212, but allowing the process 1212 to continue to operate, or (3) shutting down the process 1212 for safety reasons.

Control Process Using Output Data Step 112

Referring again to FIG. 18, the order pointer 122 indicates that the control of the process using the output data from the non-linear model 1206 may run in parallel with the prediction of output data using the non-linear model 1206, the retraining of the non-linear model 1206, and the enable/disable control of the process 1212.

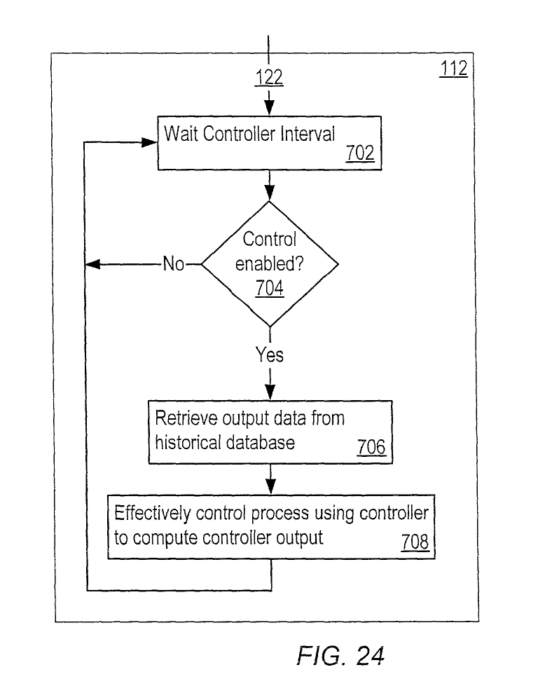

FIG. 24 shows a representative embodiment of the control process using output data step 112. Referring now to FIG. 24, the order pointer 122 may indicate that one embodiment of the present invention may first move to a wait controller interval step 702. The interval at which the controller may operate may be any pre-selected value. This interval may be a time value, an event, or the occurrence of a data value. Other interval control methods or procedures may be used.

Once the controller interval has occurred, as indicated by the order pointer, one embodiment of the present invention may move to a control enabled step 704. If control has been disabled by the enable/disable control step 110, one embodiment of the present invention may not control the process 1212 using the output data. This may be indicated by the order pointer marked “No” from the control enabled step 704.

If control has been enabled, one embodiment of the present invention may move to the retrieve output data from historical database step 706. Step 706 may indicate the following activity which is illustrated in FIG. 17: the output data 1218 produced by the non-linear model 1206 and stored in the historical database 1210 is retrieved 1214 and used by the controller 1202 to compute controller output data 1208 for control of the process 1212.

This control by the controller 1202 of the process 1212 may be indicated by an effectively control process using controller to compute controller output step 708 of FIG. 24.

Thus, it may be appreciated that one embodiment of the present invention may effectively control the process using the output data from the non-linear model 1206. The control of the process 1212 may be any presently known or future developed approach, including the architecture shown in FIGS. 31 and 32. Further, the process 1212 may be any kind of process, including an analysis process, a business process, a scientific process, an e-commerce process, or any other process wherein predictive models may be useful.

Alternatively, when the output data from the non-linear model 1206 is determined to be unacceptable, the process 1212 may continue to be controlled by the controller 1202 without the use of the output data.

One Structure (Architecture)

One structure (architecture) of one embodiment of the present invention may be a modular structure, discussed below. It is noted that the modular structure (architecture) of the embodiment of the present invention is also discussed in connection with the operation. Thus, certain portions of the structure of the embodiment of the present invention have inherently been described in connection with the description set forth above.

One embodiment of the present invention may comprise one or more software systems. In this context, software system refers to a collection of one or more executable software programs, and one or more storage areas, for example, RAM or disk. In general terms, a software system may be understood to comprise a fully functional software embodiment of a function, which may be added to an existing computer system to provide new function to that computer system.

Software systems generally are constructed in a layered fashion. In a layered system, a lowest level software system is usually the computer operating system which enables the hardware to execute software instructions. Additional layers of software systems may provide, for example, historical database capability. This historical database system may provide a foundation layer on which additional software systems may be built. For example, a non-linear model software system may be layered on top of the historical database. Also, a supervisory control software system may be layered on top of the historical database system.

A software system may thus be understood to be a software implementation of a function which may be assembled in a layered fashion to produce a computer system providing new functionality. Also, in general, the interface provided by one software system to another software system is well-defined. In the context of one embodiment of the present invention, delineations between software systems may be representative of one implementation. However, one embodiment of the present invention may be implemented using any combination or separation of software systems. Similarly, in some embodiments of the present invention, there may be no need for some of the described components.

FIG. 17 shows one embodiment of the structure of the present invention. Referring now to FIG. 17, the process 1212 being controlled may receive inputs 1222 and may produce outputs 1216. In one embodiment, sensors 1226 (of any suitable type) may provide sensor signals 1221 and/or 1224. As mentioned above, the sensors may be any program, device, or process which collects data regarding a phenomenon. As shown, sensor signal 1224 may be supplied to the historical database 1210 for storage with associated timestamps, and sensor signal 1221 may be supplied directly to the controller 1202. It is noted that any suitable type of sensor 1226 may be employed which provides sensor signals 1221 and/or 1224. It is also noted that in some embodiments, no sensors 1226 may exist.

The historical database 1210 may store the sensor signals 1224 that may be supplied to it with associated timestamps as provided by a clock 1230. In addition, as described below, the historical database 1210 may also store output data 1218 from the non-linear model 1206. This output data 1218 may also have associated timestamps as provided by the clock 1230.

The historical database 1210 that is used may be capable of storing the sensor input data 1224 with associated timestamps, and the predicted output data 1218 from the non-linear model 1206 with associated timestamps. Typically, the historical database 1210 may store the sensor data 1224 in a compressed fashion to reduce storage space requirements, and may store sampled (e.g., lab) data 1304 (refer to FIG. 29) in uncompressed form.

A historical database is a special type of database in which at least some of the data are stored with associated timestamps. Usually the timestamps may be referenced in retrieving (obtaining) data from the historical database.

The historical database 1210 may be implemented as a stand alone software system which forms a foundation layer on which other software systems, such as the non-linear model 1206, may be layered. Such a foundation layer historical database system may support many functions. For example, the historical database may serve as a foundation for software which provides graphical displays of historical process data. A historical database may also provide data to data analysis and display software for analyzing the operation of the process 1212. Such a foundation layer historical database system may often contain a large number of data inputs, and may also contain a fairly long time history for these inputs.

One embodiment of the present invention may require a very limited subset of the functions of the historical database 1210. Specifically, an embodiment of the present invention may require the ability to store at least one training input data value with the timestamp which indicates an associated input data value, and the ability to store at least one associated input data value. In certain circumstances where, for example, a historical database foundation layer system does not exist, it may be desirable to implement the essential historical database functions as part of the non-linear model software. By integrating the essential historical database capabilities into the non-linear model software, one embodiment of the present invention may be implemented in a single software system. The various divisions among software systems used to describe various embodiments of the present invention may only be illustrative in describing the best mode as currently practiced. Any division, combination, or subset of various software systems of the steps and elements of various embodiments of the present invention may be used.

The historical database 1210, as used in one embodiment of the present invention, may be implemented using a number of methods. For example, the historical database may be built as a random access memory (RAM) database. The historical database 1210 may also be implemented as a disk-based database, or as a combination of RAM and disk databases. If an analog non-linear model 1206 is used in one embodiment of the present invention, the historical database 1210 may be implemented using a physical storage device. One embodiment of the present invention may contemplate any computer or analog means of performing the functions of the historical database 1210.

The non-linear model 1206 may retrieve input data 1220 with associated timestamps. The non-linear model 1206 may use this retrieved input data 1220 to predict output data 1218. The output data 1218 with associated timestamps may be supplied to the historical database 1210 for storage.

Various embodiments of non-linear model 1206 are described above. Non-linear models, as used in one embodiment of the present invention, may be implemented in any way. For example, one embodiment may use a software implementation of a non-linear model 1206. However, any form of implementing a non-linear model 1206 may be used in various embodiments of the present invention. Specifically, as described below, the non-linear model may be implemented as a software module in a modular non-linear model control system.

Software and computer embodiments are only one possible way of implementing the various elements in the systems and methods. As mentioned above, the non-linear model 1206 may be implemented in analog or digital form and also, for example, the controller 1202 may also be implemented in analog or digital form. It is noted that operations such as computing (which imply the operation of a digital computer) may also be carried out in analog equivalents or by other methods.

Returning again to FIG. 17, the output data 1214 with associated timestamps stored in the historical database 1210 may be supplied by a path to the controller 1202. This output data 1214 may be used by the controller 1202 to generate controller output data 1208 which, in turn, may be sent to actuator(s) 1228 used to control a controllable process state 2002 of the process 1212. Another term for actuators is outputs (e.g., outputs 1216). Representative examples of controller 1202 are discussed below.

The box labeled 1207 in FIG. 17 indicates that the non-linear model 1206 and the historical database 1210 may, in a variant embodiment of the present invention, be implemented as a single software system. This single software system may be delivered to a computer installation in which no historical database previously existed, to provide the functions of one embodiment of the present invention. Alternatively, a non-linear model configuration module (or program) 1204 may also be included in the software system 1207.

Two additional aspects of the architecture and structure shown in FIG. 17 include: (1) the controller 1202 may also be provided with input data 1221 from sensors 1226. Another term for sensors is inputs (e.g., inputs 1222). This input data may be provided directly to controller 1202 from these sensor(s); (2) the non-linear model configuration module 1204 may be connected in a bidirectional path configuration with the non-linear model 1206. The non-linear model configuration module 1204 may be used by the user (developer) to configure and control the non-linear model 1206 in a fashion as discussed above in connection with the step 104 (FIG. 20), or in connection with the user interface discussion below.

Turning now to FIG. 29, an alternate embodiment of the structure and architecture of the present invention is shown. Differences between the embodiment of FIG. 17 and that of FIG. 29 are discussed below.

In FIG. 29, a laboratory (“lab”) 1307 may be supplied with samples 1302. These samples 1302 may be raw data from e-commerce system operations or some type of data from an analytical test or reading. Regardless of the form, the lab 1307 may take the samples 1302 and may utilize the samples 1302 to produce actual measurements 1304, which may be supplied to the historical database 1210 with associated timestamps. The actual measurements 1304 may be stored in the historical database 1210 with their associated timestamps.

Thus, the historical database 1210 may also contain actual test results or actual lab results in addition to other types of input data. A laboratory is illustrative of a source of actual measurements 1304 which may be useful as training input data. Other sources may be encompassed by various embodiments of the present invention. Laboratory data may be electronic data, printed data, or data exchanged over any communications link.

A second difference between the embodiment of FIG. 17 and the embodiment of FIG. 29 is that the non-linear model 1206 may be supplied with the actual measurements 1304 and associated timestamps stored in the historical database 1210.

Thus, it may be appreciated that the embodiment of FIG. 29 may allow one embodiment of the present invention to utilize lab data in the form of actual measurements 1304 as training input data 1306 to train the non-linear model.

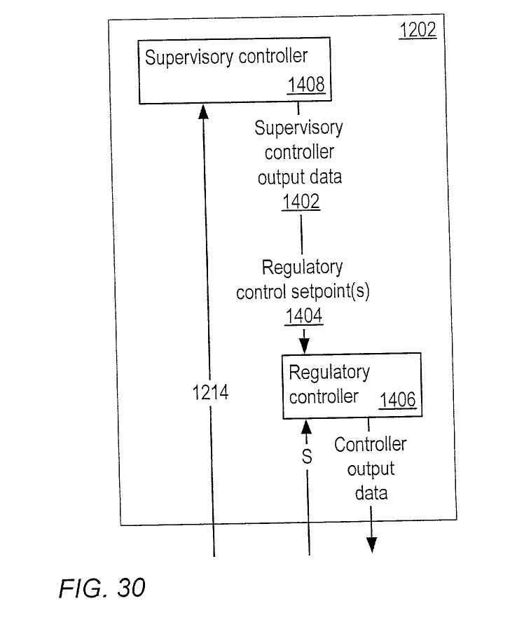

Turning now to FIG. 30, a representative embodiment of the controller 1202 is shown. The embodiment may utilize a regulatory controller 1406 for regulatory control of the process 1212. Any type of regulatory controller may be contemplated which provides such regulatory control. There may be many commercially available embodiments for such a regulatory controller. Typically, various embodiments of the present invention may be implemented using regulatory controllers already in place. In other words, various embodiments of the present invention may be integrated into existing management systems, analysis systems, or other existing systems.

In addition to the regulatory controller 1406, the embodiment shown in FIG. 30 may also include a supervisory controller 1408. The supervisory controller 1408 may compute supervisory controller output data, computed in accordance with the predicted output data 1214. In other words, the supervisory controller 1408 may utilize the predicted output data 1214 from the non-linear model 1206 to produce supervisory controller output data 1402.

The supervisory controller output data 1402 may be supplied to the regulatory controller 1406 for changing the regulatory control setpoint(s) 1404 (or other parameters of regulatory controller 1406). In other words, the supervisory controller output data 1402 may be used for changing the regulatory control setpoint(s) 1404 so as to change the regulatory control provided by the regulatory controller 1406. It is noted that the regulatory control setpoint(s) 1404 may refer not only to plant operation setpoints, but to any parameter of a system or process using an embodiment of the present invention.

Any suitable type of supervisory controller 1408 may be employed by one embodiment of the present invention, including commercially available embodiments. The only limitation is that the supervisory controller 1408 be able to use the output data 1214 to compute the supervisory controller output data 1402 used for changing the regulatory control setpoint(s) 1404.

This embodiment of the present invention may contemplate the supervisory controller 1408 being in a software and hardware system which is physically separate from the regulatory controller 1406. Referring now to FIG. 31, a more detailed embodiment of the present invention is shown. In this embodiment, the supervisory controller 1408 is separated from the regulatory controller 1406. The boxes labeled 1500, 1501, and 1502 shown in FIG. 31 suggest various ways in which the functions of the supervisory controller 1408, the non-linear model configuration module 1204, the non-linear model 1206 and the historical database 1210 may be implemented. For example, the box labeled 1502 shows the supervisory controller 1408 and the non-linear model 1206 implemented together in a single software system. This software system may take the form of a modular system as described below in FIG. 32. Alternatively, the non-linear model configuration program 1204 may be included as part of the software system, as shown in the box labeled 1501. These various software system groupings may be indicative of various ways in which various embodiments of the present invention may be implemented. Any combination of functions into various software systems may be used to implement various embodiments of the present invention.

Referring now to FIG. 32, a representative embodiment 1502 of the non-linear model 1206 combined with the supervisory controller 1408 is shown. This embodiment may be called a modular supervisory controller approach. The modular architecture that is shown illustrates that various embodiments of the present invention may contemplate the use of various types of modules which may be implemented by the user (developer) in configuring non-linear model(s) 1206 in combination with supervisory control functions.

Several modules that may be implemented by the user of one embodiment of the present invention may be shown in the embodiment of FIG. 32. Specifically, in addition to the non-linear model module 1206, the modular embodiment of FIG. 32 may also include a feedback control module 3202, a feedforward control module 3204, an expert system module 3206, a cusum (cumulative summation) module 3208, a Shewhart module 3210, a user program module 3212, and/or a batch event module 3214. Each of these modules may be selected by the user. The user may implement more than one of each of these modules in configuring various embodiments of the present invention. Moreover, additional types of modules may be utilized.

The intent of the embodiment shown in FIG. 32 is to illustrate three concepts. First, various embodiments of the present invention may utilize a modular approach which may ease user configuration. Second, the modular approach may allow for much more complicated systems to be configured since the modules may act as basic building blocks which may be manipulated and used independently of each other. Third, the modular approach may show that various embodiments of the present invention may be integrated into other systems or processes. In other words, various embodiments of the present invention may be implemented into the system and method of the United States patents and patent applications which are incorporated herein by reference as noted above, among others.

Specifically, this modular approach may allow the non-linear model capability of various embodiments of the present invention to be integrated with the expert system capability described in the above-noted patents and patent applications. As described above, this may enable the non-linear model capabilities of various embodiments of the present invention to be easily integrated with other standard control functions such as statistical tests, feedback control, and feedforward control. However, even greater function may be achieved by combining the non-linear model capabilities of various embodiments of the present invention, as implemented in this modular embodiment, with the expert system capabilities of the above-noted patent applications, also implemented in modular embodiments. This easy combination and use of standard control functions, non-linear model functions, and expert system functions may allow a very high level of capability to be achieved in solving process problems.

The modular approach to building non-linear models may result in two principal benefits. First, the specification needed from the user may be greatly simplified so that only data are required to specify the configuration and function of the non-linear model. Secondly, the modular approach may allow for much easier integration of non-linear model function with other related control functions, such as feedback control, feedforward control, etc.

In contrast to a programming approach to building a non-linear model, a modular approach may provide a partial definition beforehand of the function to be provided by the non-linear model module. The predefined function for the module may determine the procedures that need to be followed to carry out the module function, and it may determine any procedures that need to be followed to verify the proper configuration of the module. The particular function may define the data requirements to complete the specification of the non-linear model module. The specifications for a modular non-linear model may be comprised of configuration information which may define the size and behavior of the non-linear model in general, and the data interactions of the non-linear model which may define the source and location of data that may be used and created by the system.

Two approaches may be used to simplify the user configuration of non-linear models. First, a limited set of procedures may be prepared and implemented in the modular non-linear model software. These predefined functions may define the specifications needed to make these procedures work as a non-linear model module. For example, the creation of a non-linear model module may require the specification of the number of inputs, the number of middle elements (e.g., a kernel function middle element in the case of a support vector machine non-linear model), and the number of outputs. The initial values of the coefficients may not be required. Thus, the user input required to specify such a module may be greatly simplified. This predefined procedure approach is one method of implementing the modular non-linear model.

A second approach to provide modular non-linear model function may allow a limited set of natural language expressions to be used to define the non-linear model. In such an implementation, the user or developer may be permitted to enter, through typing or other means, natural language definitions for the non-linear model. For example, the user may enter text which may read, for example, “I want a fully randomized non-linear model.” These user inputs may be parsed in search of specific combinations of terms, or their equivalents, which would allow the specific configuration information to be extracted from the restricted natural language input.

By parsing the total user input provided in this method, the complete specification for a non-linear model module may be obtained. Once this information is known, two approaches may be used to generate a non-linear model module.

A first approach may be to search for a predefined procedure matching the configuration information provided by the restricted natural language input. This may be useful where users tend to specify the same basic non-linear model functions for many problems.

A second approach may provide for much more flexible creation of non-linear model modules. In this approach, the specifications obtained by parsing the natural language input may be used to generate a non-linear model procedure by actually generating software code. In this approach, the non-linear model functions may be defined in relatively small increments as opposed to the approach of providing a complete predefined non-linear model module. This approach may combine, for example, a small function which is able to obtain input data and populate a set of inputs. By combining a number of such small functional pieces and generating software code which reflects and incorporates the user specifications, a complete non-linear model procedure may be generated.

This approach may optionally include the ability to query the user for specifications which have been neglected or omitted in the restricted natural language input. Thus, for example, if the user neglected to specify the number of outputs in the non-linear model, the user may be prompted for this information and the system may generate an additional line of user specification reflecting the answer to the query. The parsing and code generation in this approach may use pre-defined, small sub-functions of the overall non-linear model module. A given keyword (term) may correspond to a certain sub-function of the overall non-linear model module. Each sub-function may have a corresponding set of keywords (terms) and associated keywords and numeric values. Taken together, each keyword and associated keywords and values may constitute a symbolic specification of the non-linear model sub-function. The collection of all the symbolic specifications may make up a symbolic specification of the entire non-linear model module.

The parsing step may process the substantially natural language input. The parsing step may remove unnecessary natural language words, and may group the remaining keywords and numeric values into symbolic specifications of non-linear model sub-functions. One way to implement parsing may be to break the input into sentences and clauses bounded by periods and commas, and restrict the specification to a single sub-function per clause. Each clause may be searched for keywords, numeric values, and associated keywords. The remaining words may be discarded. A given keyword (term) may correspond to a certain sub-function of the overall non-linear model module.

Alternatively, keywords may have relational tag words (e.g., “in,” “with,” etc.) which may indicate the relation of one keyword to another. Using such relational tag words, multiple sub-function specifications may be processed in the same clause.

Keywords may be defined to have equivalents. For example, when the non-linear model is a neural network, the user may be allowed, in an embodiment of this aspect of the invention, to specify the transfer function (activation function) used in the elements (nodes) in the neural network. Thus the keyword may be “activation function” and an equivalent may be “transfer function.” This keyword may correspond to a set of pre-defined sub-functions which implement various kinds of transfer functions in the neural network elements. The specific data that may be allowed in combination with this term may be, for example, the term “sigmoidal” or the word “threshold.” These specific data, combined with the keyword, may indicate which of the sub-functions to use to provide the activation function capability in the neural network when it is constructed.

As another example, when the non-linear model is a support vector machine, the user may be allowed, in an embodiment of this aspect of the invention, to specify the kernel function used in the support vector machine. Thus the keyword may be “kernel” and an equivalent keyword may be “kernel function.” This keyword may correspond to a set of pre-defined sub-functions which may implement various kinds of kernel functions in the support vector machine.

Yet another example, which may apply to either a neural network, a support vector machine, or some other non-linear model, may be keyword “coefficients”, which may have equivalent “weights”. The associated data may be a real number which may indicate the value(s) of one or more coefficients. Thus, it may be seen that various levels of flexibility in the substantially natural language specification may be provided. Increasing levels of flexibility may require more detailed and extensive specification of keywords and associated data with their associated keywords.

The non-linear model itself may be constructed, using this method, by processing the specifications, as parsed from the substantially natural language input, in a pre-defined order, and generating the fully functional procedure code for the non-linear model from the procedural sub-function code fragments.

Another major advantage of a modular approach is the ease of integration with other functions in the application (problem) domain. For example, it may be desirable or productive to combine the functions of a non-linear model with other more standard control functions such as statistical tests, feedback control, etc. The implementation of non-linear models as modular non-linear models in a larger system may greatly simplify this kind of implementation.

The incorporation of modular non-linear models into a modular system may be beneficial because it may make it easy to create and use non-linear model predictions in various applications. For example, the control functions described in some of the United States patents and patent applications incorporated by reference above generally rely on current information for their actions, and they do not generally define their function in terms of past (historical) data. In order to make a non-linear model function effectively in a modular control system, some means is needed to train and operate the non-linear model using the data which is not generally available by retrieving current data values. The systems and methods of various embodiments of the present invention, as described above, may provide this essential capability which may allow a modular non-linear model function to be implemented in a modular control system.

A modular non-linear model has several characteristics which may significantly ease its integration with other control functions. First, the execution of non-linear model functions, prediction and/or training may easily be coordinated in time with other control functions. The timing and sequencing capabilities of a modular implementation of a non-linear model may provide this capability. Also, when implemented as a modular function, non-linear models may make their results readily accessible to other control functions that may need them. This may be done, for example, without needing to store the non-linear model outputs in an external system, such as a historical database.

Modular non-linear models may run either synchronized or unsynchronized with other functions in the control system. Any number of non-linear models may be created within the same control application, or in different control applications, within the control system. This may significantly facilitate the use of non-linear models to make predictions of output data where several small non-linear models may be more easily or rapidly trained than a single large non-linear model. Modular non-linear models may also provide a consistent specification and user interface so that a user trained to use the modular non-linear model control system may address many control problems without learning new software.

An extension of the modular concept is the specification of data using pointers. Here again, the user (developer) is offered the easy specification of a number of data retrieval or data storage functions by simply selecting the function desired and specifying the data needed to implement the function. For example, the retrieval of a time-weighted average from the historical database is one such predefined function. By selecting a data type such as a time-weighted average, the user (developer) need only specify the specific measurement desired, the starting time boundary, and the ending time boundary. With these inputs, the predefined retrieval function may use the appropriate code or function to retrieve the data. This may significantly simplify the user's access to data which may reside in a number of different process data systems. By contrast, without the modular approach, the user may have to be skilled in the programming techniques needed to write the calls to retrieve the data from the various process data systems.

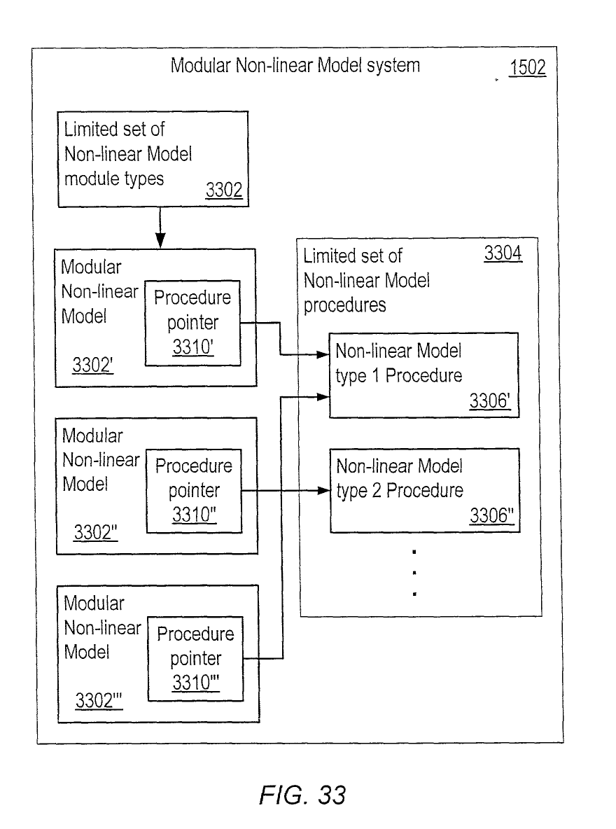

A further development of the modular approach of an embodiment of the present invention is shown in FIG. 33. FIG. 33 shows the non-linear model 1206 in a modular form (within the box labeled 1502).

Referring now to FIG. 33, a specific software embodiment of the modular form of the present invention is shown. In this modular embodiment, a limited set of non-linear model module types 3302 is provided. Each non-linear model module type 3302 may allow the user to create and configure a non-linear model module implementing a specific type of non-linear model (e.g., a neural network, or a support vector machine). For each non-linear model module type, the user may create and configure non-linear model modules. Three specific instances of non-linear model modules may be shown as 3302′, 3302″, and 3302′″.

In this modular software embodiment, non-linear model modules may be implemented as data storage areas which contain a procedure pointer 3310′, 3310″, 3310′″ to procedures which carry out the functions of the non-linear model type used for that module. The non-linear model procedures 3306′ and 3306″, for example, may be contained in a limited set of non-linear model procedures 3304. The procedures 3306′, 3306″ may correspond one to one with the non-linear model types contained in the limited set of non-linear model types 3302.

In this modular software embodiment, many non-linear model modules may be created which use the same non-linear model procedure. In this case, the multiple modules each contain a procedure pointer to non-linear model procedure 3306′ or 3306″. In this way, many modular non-linear models may be implemented without duplicating the procedure or code needed to execute or carry out the non-linear model functions.

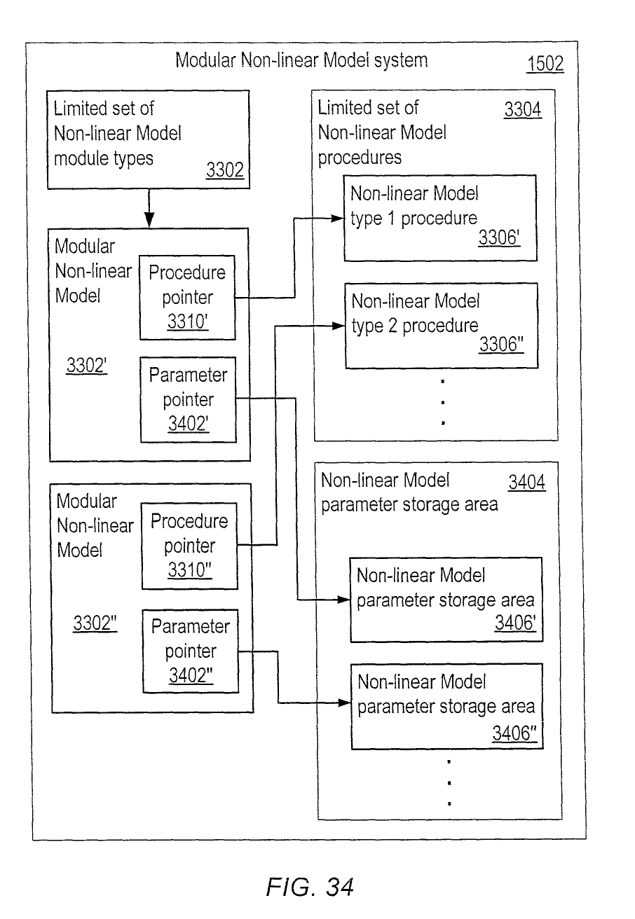

Referring now to FIG. 34, a more specific software embodiment of the modular non-linear model is shown. This embodiment is of particular value when the non-linear model modules are implemented in the same modular software system as modules performing other functions such as statistical tests or feedback control.

Because non-linear models may use a large number of inputs and outputs with associated error values and training input data values, and also because non-linear models may require a large number of coefficient values which need to be stored, non-linear model modules may have significantly greater storage requirements than other module types in the control system. In this case, it is advantageous to store non-linear model parameters in a separate non-linear model parameter storage area 3404.

In this modular software embodiment, each instance of a modular non-linear model 3302′ and 3302″ may contain two pointers. The first pointers (3310′ and 3310″) may be the procedure pointer described above in reference to FIG. 33. Each non-linear model module may also contain a second pointer, (3402′ and 3402″), referred to as parameter pointers, which may point to storage areas 3406′and 3406″, respectively, for non-linear model parameters in a non-linear model parameter storage area 3404. In this embodiment, only non-linear model modules may need to contain the parameter pointers 3402′ and 3402″, which point to the non-linear model parameter storage area 3404. Other module types, such as control modules which do not require such extensive storage, need not have the storage allocated via the parameter pointers 3402′ and 3402″, which may be a considerable savings.

FIG. 35 shows representative aspects of the architecture of the non-linear model 1206. The representation in FIG. 35 is particularly relevant in connection with the modular non-linear model approach shown in FIGS. 32, 33, and 34 discussed above.

Referring now to FIG. 35, the components to make and use a representative embodiment of the non-linear model 1206 are shown in an exploded format.

The non-linear model 1206 may contain a neural network model, or a support vector machine model, or any other non-linear model, as desired. As stated above, one embodiment of the present invention may contemplate all presently available and future developed non-linear models and architectures.

The non-linear model 1206 may have access to input data and training input data and access to locations in which it may store output data and error data. One embodiment of the present invention may use an on-line approach. In this on-line approach, the data may not be kept in the non-linear model 1206. Instead, data pointers may be kept in the non-linear model. The data pointers may point to data storage locations in a separate software system. These data pointers, also called data specifications, may take a number of forms and may be used to point to data used for a number of purposes.

For example, input data pointer 3504 and output data pointer 3506 may be specified. As shown in the exploded view, each pointer (i.e., input data pointer 3504 and output data pointer 3506) may point to or use a particular data source system 3524 for the data, a data type 3526, and a data item pointer 3528.

Non-linear model 1206 may also have a data retrieval function 3508 and a data storage function 3510. Examples of these data retrieval and data storage functions may be callable routines 3530, disk access 3532, and network access 3534. These are merely examples of the aspects of retrieval and storage functions.

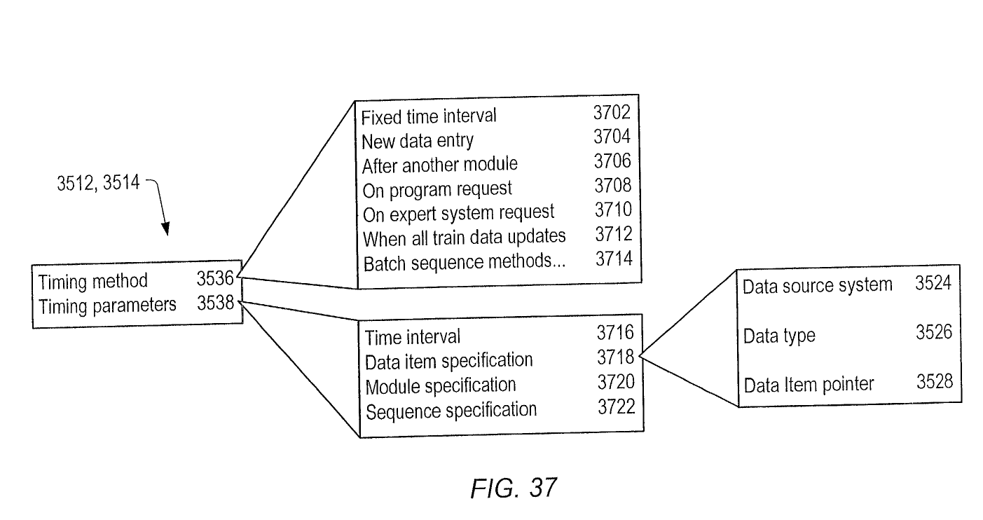

Non-linear model 1206 may also have prediction timing and training timing. These may be specified by prediction timing control 3512 and training timing control 3514. One way to implement this may be to use a timing method 3536 and its associated timing parameters 3538. Referring now to FIG. 37, examples of timing method 3536 may include a fixed time interval 3702, a new data entry 3704, an after another module 3706, an on program request 3708, an on expert system request 3710, a when all training input data updates 3712, and/or a batch sequence methods 3714. These may be designed to allow the training and function of the non-linear model 1206 to be controlled by time, data, completion of modules, or other methods or procedures. The examples are merely illustrative in this regard.

FIG. 37 also shows examples of the timing parameters 3538. Such examples may include a time interval 3716, a data item specification 3718, a module specification 3720, and/or a sequence specification 3722. As is shown in FIG. 37, examples of the data item specification 3718 may include specifying a data source system 3524, a data type 3526, and/or a data item pointer 3528 which have been described above (see FIG. 35).

Referring again to FIG. 35, training input data coordination 3516, as discussed previously, may also be required in many applications. Examples of approaches that may be used for such coordination are shown. One method may be to use all current values 3540. Another method may be to use current training input data values with the input data at the earliest training input data time 3542. Yet another approach may be to use current training input data values with the input data at the latest training input data time 3544. Again, these are merely examples, and should not be construed as limiting in terms of the type of coordination of training input data that may be utilized by various embodiments of the present invention.

The non-linear model 1206 may also need to be trained, as discussed above. As stated previously, any presently available or future developed training method may be contemplated by various embodiments of the present invention. The training method also may be somewhat dictated by the architecture of the non-linear model that is used.

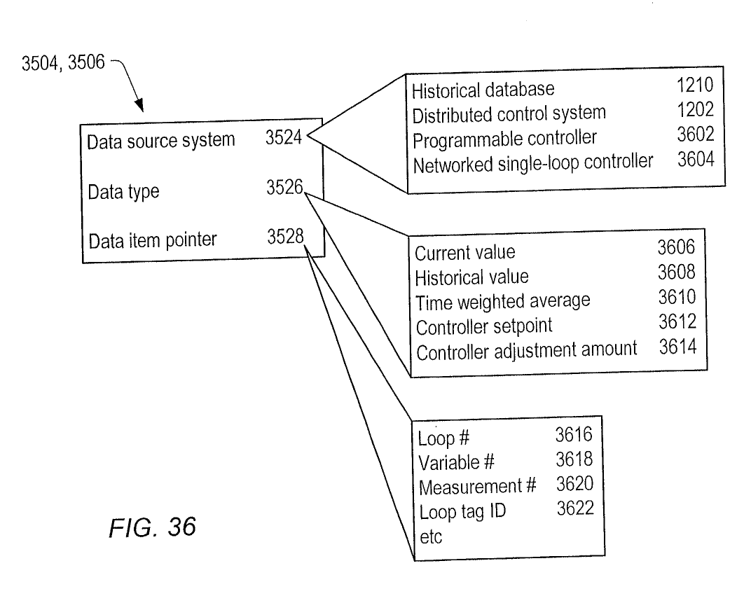

Referring now to FIG. 36, examples of the data source system 3524, the data type 3526, and the data item pointer 3528 are shown for purposes of illustration.

With respect to the data source system 3524, examples may be a historical database 1210, a distributed control system 1202, a programmable controller 3602, and a networked single loop controller 3604. These are merely illustrative and are not intended to be limiting.

Any data source system may be utilized by various embodiments of the present invention. Examples of data source systems may include: (i) a storage device; (ii) an actual measuring device; (iii) a calculating device. In one embodiment, all that is required is that a source of data be specified to provide the non-linear model 1206 with the input data 1220 that is needed to produce the output data 1218. One embodiment of the present invention may contemplate more than one data source system used by the same non-linear model 1206.

The non-linear model 1206 needs to know the data type that is being specified. This is particularly important in a historical database 1210 since it may provide more than one type of data. Several examples of data types 3526 may be shown in FIG. 36, as follows: a current value 3606, a historical value 3608, a time weighted average 3610, a controller setpoint 3612, and a controller adjustment amount 3614. Additionally or alternatively, other data types may be contemplated, as desired.

Finally, the data item pointer 3528 may be specified. The examples shown in FIG. 36 may include: a loop number 3616, a variable number 3618, a measurement number 3620, and/or a loop tag identifier (ID) 3622, among others. Again, these are merely examples for illustration purposes, as various embodiments of the present invention may contemplate any type of data item pointer 3528.

It is thus seen that non-linear model 1206 may be constructed so as to obtain desired input data 1220 and to provide output data 1218 in any intended fashion. In one embodiment of the present invention, this may be done through menu selection by the user (developer) using a graphical user interface of a software based system on a computer platform.

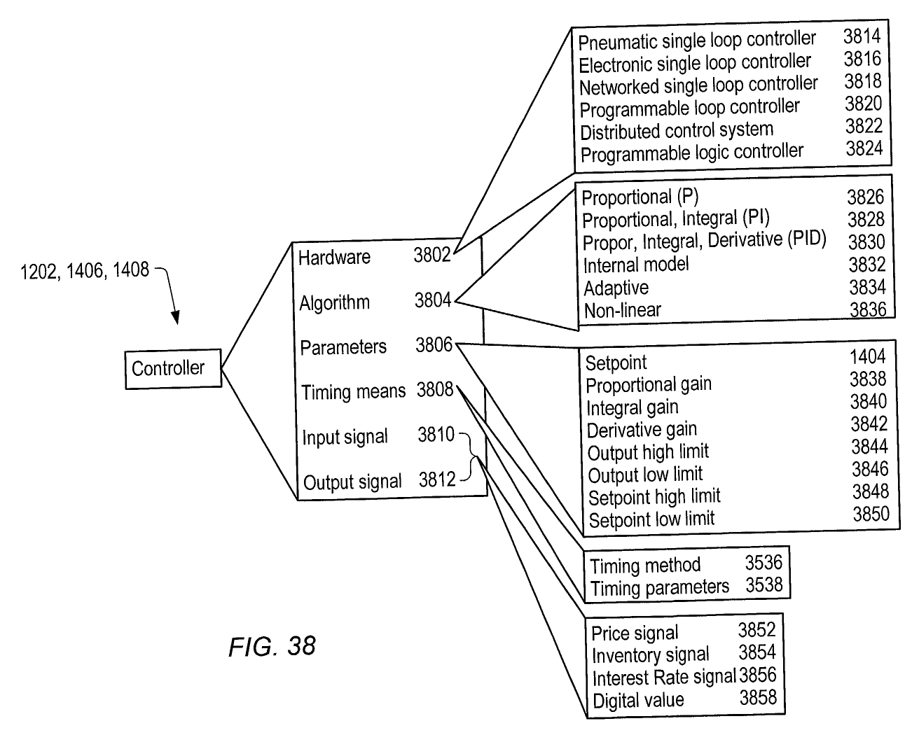

One embodiment of the construction of controllers 1202 (see FIG. 17), 1406 and 1408 (see FIG. 30) is shown in FIG. 38 in an exploded format. Again, this is merely for purposes of illustration. First, the controllers may be implemented on a hardware platform 3802. Examples of hardware platforms 3802 may include: a pneumatic single loop controller 3814, an electronic single loop controller 3816, a networked single looped controller 3818, a programmable loop controller 3820, a distributed control system 3822, and/or a programmable logic controller 3824. Again, these are merely examples for illustration. Any type of hardware platform 3802 may be contemplated by various embodiments of the present invention.

In addition to the hardware platform 3802, the controllers 1202, 1406, and/or 1408 each may need to implement or utilize an algorithm 3804. Any type of algorithm 3804 may be used. Examples shown may include: proportional (P) 3826; proportional, integral (PI) 3828; proportional, integral, derivative (PID) 3830; internal model 3832; adaptive 3834; and, non-linear 3836. These are merely illustrative of feedback algorithms. Various embodiments of the present invention may also contemplate feedforward algorithms and/or other algorithm approaches.

The controllers 1202, 1406, and/or 1408 may also include parameters 3806. These parameters 3806 may be utilized by the algorithm 3804. Examples shown may include setpoint 1404, proportional gain 3838, integral gain 3840, derivative gain 3842, output high limit 3844, output low limit 3846, setpoint high limit 3848, and/or setpoint low limit 3850.

The controllers 1202, 1406, and/or 1408 may also need some means for timing operations. One way to do this is to use a timing means 3808. Timing means 3808, for example, may use a timing method 3536 with associated timing parameters 3538, as previously described (see FIG. 35). Again, these are merely illustrative and are not intended to be limiting.

The controllers 1202, 1406, and/or 1408 may also need to utilize one or more input signals 3810, and to provide one or more output signals 3812. These signals may take the form of price signals 3852, inventory signals 3854, interest rate signals 3856, or digital values 3858, among others. It is noted that input and output signals may be in either analog or digital format.

User Interface

In one embodiment of the present invention, a template and menu driven user interface is utilized (e.g., FIGS. 39 and 40) which may allow the user to configure, reconfigure, and/or operate the embodiment of the present invention. This approach may make the embodiment of the present invention very user friendly. This approach may also eliminate the need for the user to perform any computer programming, since the configuration, reconfiguration and operation of the embodiment of the present invention is carried out in a template and menu format not requiring any actual computer programming expertise or knowledge.

The system and method of one embodiment of the present invention may utilize templates. These templates may define certain specified fields that may be addressed by the user in order to configure, reconfigure, and/or operate various embodiments of the present invention. The templates may guide the user in using various embodiments of the present invention.

Representative examples of templates for the menu driven system of various embodiments of the present invention are shown in FIGS. 39 and 40. These are merely for purposes of illustration and are not intended to be limiting.

One embodiment of the present invention may use a two-template specification (i.e., a first template 3900 as shown in FIG. 39, and a second template 4000 as shown in FIG. 40) for a non-linear model module. Referring now to FIG. 39, the first template 3900 in this set of two templates is shown. First template 3900 may specify general characteristics of how the non-linear model 1206 may operate. The portion of the screen within a box labeled 3920, for example, may show how timing options may be specified for the non-linear model module 1206. As previously described, more than one timing option may be provided. A training timing option may be provided, as shown under the label “train” in box 3920. Similarly, a prediction timing control specification may also be provided, as shown under the label “run” in box 3920. The timing methods may be chosen from a pop-up menu of various timing methods that may be implemented, in one embodiment. The parameters needed for the user-selected timing method may be entered by a user in the blocks labeled “Time Interval” and “Key Block” in box 3920. These parameters may only be required for certain timing methods. Not all timing methods may require parameters, and not all timing methods that require parameters may require all the parameters shown.

In a box labeled 3906 bearing the headings “Mode” and “Store Predicted Outputs”, the prediction and training functions of the non-linear model module may be controlled. By putting a check or an “X” in the box next to either the train or the run designation under “Mode”, the training and/or prediction functions of the non-linear model module 1206 may be enabled. By putting a check or an “X” in the box next to either the “when training” or the “when running” labels under “Store Predicted Outputs”, the storage of predicted output data 1218 may be enabled when the non-linear model 1206 is training or when the non-linear model 1206 is predicting (i.e., running), respectively.

The size of the non-linear model 1206 may be specified in a box labeled 3922 bearing the heading “non-linear model size”. In this embodiment of a non-linear model module 1206, there may be inputs, outputs, and/or middle elements (e.g., when the non-linear model is a neural network, these middle elements may be one or more internal layers of the neural network; or when the non-linear model is a support vector machine, these middle elements may be one or more kernel functions). In one embodiment, the number of inputs and the number of outputs may be limited to some predefined value.

The coordination of input data times or timestamps with training input data times or timestamps may be controlled using a checkbox labeled 3908. By checking this box, the user may specify that input data 1220 is to be retrieved such that the timestamps on the input data 1220 correspond with the timestamps on the training input data 1306. The training or learning constant may be entered in field 3910. This training or learning constant may determine how aggressively the coefficients in the non-linear model 1206 are adjusted when there is an error 1504 between the output data 1218 and the training input data 1306.

The user may, by pressing a keypad softkey labeled “data spec page” 3924, call up the second template 4000 in the non-linear model module specification. This second template 4000 is shown in FIG. 40. This second template 4000 may allow the user to specify the data inputs 1220, 1306, and the outputs 1218, 1504 that may be used by the non-linear model module. Data specification boxes 4002, 4004, 4006, and 4008 may be provided for each of the inputs 1220, training inputs 1306, the outputs 1218, and the summed error output 1504, respectively. These may correspond to the input data, the training input data, the output data, and the error data, respectively. These four boxes may use the same data specification methods.

Within each data specification box, the data pointers and parameters may be specified. In one embodiment, the data specification may comprise a three-part data pointer as described above. In addition, various time boundaries and constraint limits may be specified depending on the data type specified.

In FIG. 41, an example of a pop-up menu is shown. The specification for the data system for the network input number 1 is being specified as shown by the highlighted field reading “DMT PACE”. The box in the center of the screen is a pop-up menu 4102 containing choices which may be selected to complete the data system specification. The templates in one embodiment of the present invention may utilize such pop-up menus 4102 wherever applicable.

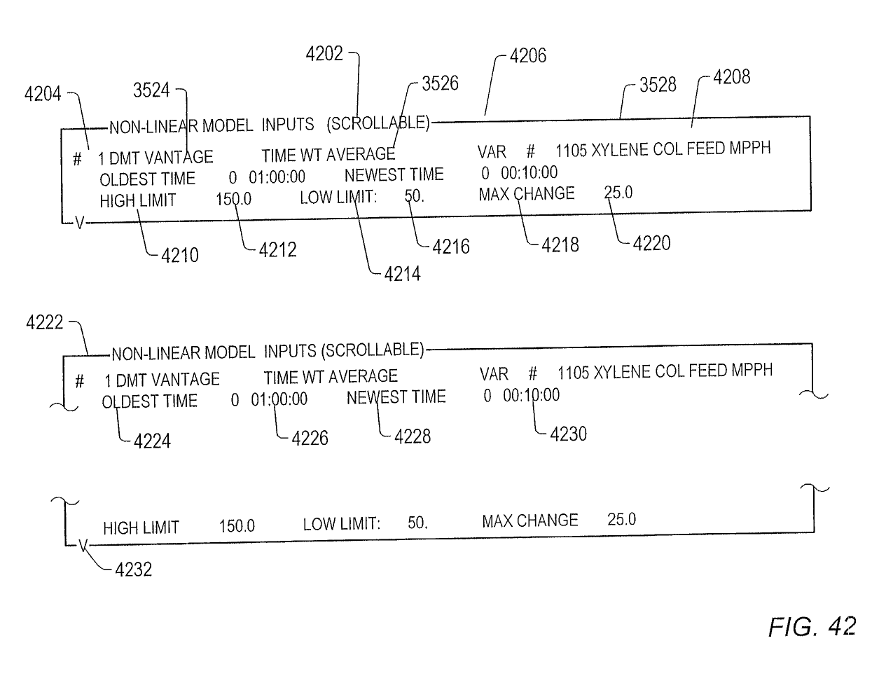

FIG. 42 shows the various elements included in the data specification block. These elements may include a data title 4202, an indication as to whether the block is scrollable 4206, and/or an indication of the number of the specification in a scrollable region 4204. The box may also contain arrow pointers indicating that additional data specifications may exist in the list either above or below the displayed specification. These pointers 4222 and 4232 may be displayed as a small arrow when other data are present (e.g., pointer 4232). Otherwise, they may be blank (e.g., pointer 4222).

The items making up the actual data specification may include: a data system 3524, a data type 3526, a data item pointer or number 3528, a name and units label for the data specification 4208, a label 4224, a time boundary 4226 for the oldest time interval boundary, a label 4228, a time specification 4230 for the newest time interval boundary, a label 4210, a high limit 4212 for the data value, a label 4214, a low limit value 4216 for the low limit on the data value, a label 4218, and a value 4220 for the maximum allowed change in the data value.

The data specification shown in FIG. 42 is representative of one mode of implementing one embodiment of the present invention. Various other modifications of the data specification may be used to give more or less flexibility depending on the complexity needed to address the various data sources which may be present. Various embodiments of the present invention may contemplate any variation on this data specification method.

Although the system and method of the present invention have been described in connection with several embodiments, the invention is not intended to be limited to the specific forms set forth herein, but on the contrary, it is intended to cover such alternatives, modifications, and equivalents, as can be reasonably included within the spirit and scope of the invention as defined by the appended claims.

What is claimed is:

1. A method for training a non-linear model used to control an electronic commerce system, the method comprising:
(1) training said non-linear model using a first training set, wherein said first training set is based on first electronic commerce data;
(2) training said non-linear model using said first training set and a second training set, wherein said second training set is based on second electronic commerce data; and
(3) training said non-linear model using said second training set and a third training set, without using said first training set, wherein said third training set is based on third electronic commerce data;
wherein at least one of (1), (2), and (3) comprises:
(a) retrieving electronic commerce training input data from a historical database, wherein said electronic commerce training input data has one or more timestamps;
(b) selecting an electronic commerce training input data time period based on said one or more timestamps; and
(c) retrieving electronic commerce input data indicated by said electronic commerce training input data time period.

2. The method of claim 1, wherein at least one of (1), (2), and (3) operates substantially in real-time.

3. The method of claim 1,
wherein (1) is preceded by analyzing behavior of the electronic commerce system; and
wherein (1) further comprises using data representative of said analyzing as said first electronic commerce data.

4. A method for training a non-linear model used to control an electronic commerce system, the method comprising:
(1) detecting first electronic commerce data;
(2) training said non-linear model in response to said detecting first electronic commerce data, using a first training set based on said first electronic commerce data;
(3) detecting second electronic commerce data;
(4) training said non-linear model in response to said detecting second electronic commerce data, using said first training set and a second training set, wherein said second training set is based on said second electronic commerce data;
(5) detecting third electronic commerce data;
(6) training said non-linear model in response to said detecting third electronic commerce data, using said second training set and a third training set, without using said first training set, wherein said third training set is based on said third electronic commerce data;
wherein at least one of (2), (4), and (6) comprises:
(a) retrieving electronic commerce training input data from a historical database, wherein said electronic commerce training input data has one or more timestamps;
(b) selecting an electronic commerce training input data time period based on said one or more timestamps; and
(c) retrieving electronic commerce input data indicated by said electronic commerce training input data time period.

5. The method of claim 4, further comprising discarding said first training set between (4) and (5).

6. The method of claim 4, further comprising discarding said second training set after (6).

7. A method for training a non-linear model used to control an electronic commerce system, the method comprising:
(1) constructing a list containing at least two training sets;
(2) training said non-linear model using said at least two training sets in said list;
(3) constructing a new training set and replacing an oldest training set in said list with said new training set; and
(4) repeating (2) and (3) at least once;
wherein at least one of (1) and (3) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

8. The method of claim 7, wherein (3) comprises:
(a) monitoring substantially in real-time for new electronic commerce training input data; and
(b) retrieving electronic commerce input data indicated by said new electronic commerce training input data to construct said new training set.

9. The method of claim 7, wherein (2) uses said at least two training sets once.

10. The method of claim 7, wherein (2) uses said at least two training sets at least twice.

11. A method for training a non-linear model used to control an electronic commerce system, the method comprising:
(1) producing first electronic commerce data, second electronic commerce data, and third electronic commerce data;
(2) training said non-linear model using a first training set, wherein said first training set is based on said first electronic commerce data;
(3) training said non-linear model using said first training set and a second training set, wherein said second training set is based on said second electronic commerce data; and
(4) training said non-linear model using said second training set and a third training set, without using said first training set, wherein said third training set is based on said third electronic commerce data;
wherein at least one of (2), (3), and (4) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

12. A method for training a non-linear model used to control an electronic commerce system, the method comprising:
(1) training said non-linear model using a first training set, wherein said first training set is based on first electronic commerce data;
(2) training said non-linear model using said first training set and a second training set, wherein said second training set is based on second electronic commerce data;
(3) training said non-linear model using said second training set and a third training set, without using said first training set, wherein said third training set is based on third electronic commerce data; and
(4) using said non-linear model to predict first electronic commerce output data using first electronic commerce input data;
wherein at least one of (1), (2), and (3) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

13. A method for training a non-linear model used to control an electronic commerce system, the method comprising:
(1) detecting first electronic commerce data;
(2) training said non-linear model in response to said detecting first electronic commerce data, using a first training set, wherein said first training set is based on said first electronic commerce data;
(3) detecting second electronic commerce data;
(4) training said non-linear model in response to said detecting said second electronic commerce data, using said first training set and a second training set, wherein said second training set is based on said second electronic commerce data;
(5) detecting third electronic commerce data;
(6) training said non-linear model in response to said detecting third electronic commerce data, using said second training set and a third training set, without using said first training set, wherein said third training set is based on said third electronic commerce data; and
(7) using said non-linear model to predict first electronic commerce output data using first electronic commerce input data;
wherein at least one of (2), (4), and (6) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

14. A method for training a non-linear model used to control an electronic commerce system, the method comprising:
(1) producing first electronic commerce data, second electronic commerce data, and third electronic commerce data;
(2) detecting said first electronic commerce data;
(3) training said non-linear model in response to said detecting first electronic commerce data, using a first training set, wherein said first training set is based on said first electronic commerce data;
(4) detecting said second electronic commerce data;
(5) training said non-linear model in response to said detecting second electronic commerce data, using said first training set and a second training set; wherein said second training set is based on said second electronic commerce data;
(6) detecting said third electronic commerce data; and
(7) training said non-linear model in response to said detecting third electronic commerce data, using said second training set and a third training set, without using said first training set, wherein said third training set is based on said third electronic commerce data;
wherein at least one of (3), (5), and (7) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

15. A method for constructing training sets for a non-linear model used to control an electronic commerce system, the method comprising:
(1) developing a first training set for said non-linear model by:
(a) retrieving first electronic commerce training input data from a historical database, wherein said first electronic commerce training input data has a first set of one or more timestamps;
(b) selecting a first electronic commerce training input data time period based on said first set of one or more timestamps; and
(c) retrieving first electronic commerce input data indicated by said first electronic commerce training input data time period; and
(2) developing a second training set for said non-linear model by:
(a) retrieving second electronic commerce training input data from said historical database, wherein said second electronic commerce training input data has a second set of one or more timestamps;
(b) selecting a second electronic commerce training input data time period based on said second set of one or more timestamps; and
(c) retrieving second electronic commerce input data indicated by said second electronic commerce training input data time period.

16. The method of claim 15, further comprising:
(3) searching said historical database in either a forward time direction or a backward time direction so that said second electronic commerce training input data is the next electronic commerce training input data in time to said first electronic commerce training input data in said forward time direction or said backward time direction, whichever is used.

17. The method of claim 15, further comprising:
(3) training said non-linear model using said first training set and/or said second training set.

18. A method for generating predicted output data using a non-linear model, wherein the predicted output data is provided to a computer system used to control an electronic commerce system, the method comprising:
(1) monitoring for the availability of new electronic commerce training input data by monitoring for a change in an associated timestamp of said electronic commerce training input data;
(2) constructing a training set by retrieving first electronic commerce input data corresponding to said electronic commerce training input data;
(3) training said non-linear model using said training set; and
(4) predicting the electronic commerce output data from second electronic commerce input data using said non-linear model.

19. The method of claim 18, wherein (2) further comprises using data pointers to indicate said electronic commerce training input data and said first electronic commerce input data.

20. The method of claim 18, wherein (1) is preceded by:
(i) presenting to a user a template for a partially specified non-linear model; and
(ii) entering data into said template to create a complete non-linear model specification; and
wherein (3) further comprises using a non-linear model representative of said complete non-linear model specification.

21. The method of claim 18, wherein (1) is preceded by:
(i) presenting to a user an interface for accepting a limited set of substantially natural language format specifications; and
(ii) entering into said interface sufficient specifications in said substantially natural language format to completely define a non-linear model; and
wherein (3) further comprises using a non-linear model representative of said completely defined non-linear model.

22. The method of claim 18, wherein (1), (2), and (3) operate substantially in real-time.

23. A method for constructing training sets for a non-linear model used to control an electronic commerce system, the method comprising:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

24. A method for predicting electronic commerce output data provided to a computer system used to control an electronic commerce system, the method comprising:
(1) monitoring for the availability of new electronic commerce training input data;
(2) constructing a training set by retrieving first electronic commerce input data corresponding to said electronic commerce training input data comprising:
(a) selecting a electronic commerce training input data time using one or more timestamps associated with said electronic commerce training input data; and
(b) retrieving electronic commerce input data representing measurement(s) at said electronic commerce training input data time, said electronic commerce input data comprising said first electronic commerce input data;
(3) training said non-linear model using said training set; and
(4) predicting the electronic commerce output data from second electronic commerce input data using said non-linear model.

25. The method of claim 24, wherein (1) comprises monitoring for a change between two successive electronic commerce training input data values.

26. The method of claim 24,
wherein (1) comprises computing a difference between a most recent electronic commerce training input data value and a next most recent electronic commerce training input data value; and
wherein (3) further comprises using said difference with said first electronic commerce input data for said training.

27. The method of claim 24, wherein (2) further comprises using data pointers to indicate said electronic commerce training input data and said first electronic commerce input data.

28. The method of claim 24, wherein (1), (2), and (3) operate substantially in real-time.

29. A method adapted for predicting electronic commerce output data provided to a computer system used to control an electronic commerce system, the method comprising:
(1) presenting to a user a template for a partially specified non-linear model;
(2) entering data into said template to create a complete non-linear model specification;
(3) monitoring for the availability of new electronic commerce training input data;
(4) constructing a training set by retrieving first electronic commerce input data corresponding to said electronic commerce training input data;
(5) training said non-linear model using said training set, said training further comprising using a non-linear model representative of said complete non-linear model specification; and
(6) predicting the electronic commerce output data from second electronic commerce input data using said non-linear model.

30. The method of claim 29, wherein (3) comprises monitoring for a change between two successive electronic commerce training input data values.

31. The method of claim 29,
wherein (3) comprises computing a difference between a most recent electronic commerce training input data value and a next most recent electronic commerce training input data value; and
wherein (5) further comprises using said difference with said first electronic commerce input data for said training.

32. The method of claim 29, wherein (4) further comprises using data pointers to indicate said electronic commerce training input data and said first electronic commerce input data.

33. The method of claim 29, wherein (3), (4), and (5) operate substantially in real-time.

34. A method for predicting electronic commerce output data provided to a computer system used to control an electronic commerce system, the method comprising:
(1) presenting to a user an interface for accepting a limited set of substantially natural language format specifications;
(2) entering into said interface sufficient specifications in said substantially natural language format to completely define a non-linear model;
(3) monitoring for the availability of new electronic commerce training input data;
(4) constructing a training set by retrieving first electronic commerce input data corresponding to said electronic commerce training input data;
(5) training said non-linear model using said training set, wherein said training comprises using a non-linear model representative of said completely defined non-linear model; and
(6) predicting the electronic commerce output data from second electronic commerce input data using said non-linear model.

35. The method of claim 34, wherein (3) comprises monitoring for a change between two successive electronic commerce training input data values.

36. The method of claim 34,
wherein (3) comprises computing a difference between a most recent electronic commerce training input data value and a next most recent electronic commerce training input data value; and
wherein (5) further comprises using said difference with said first electronic commerce input data for said training.

37. The method of claim 34, wherein (4) further comprises using data pointers to indicate said electronic commerce training input data and said first electronic commerce input data.

38. The method of claim 34, wherein (3), (4), and (5) operate substantially in real-time.

39. A method for training a non-linear model used to control an electronic commerce system, the method comprising:
building a first training set using training electronic commerce data, wherein said training electronic commerce data comprises one or more timestamps indicating a chronology of said training electronic commerce data and one or more parameter values corresponding to each timestamp, and wherein said first training set comprises parameter values corresponding to a first time period in said chronology;
training a non-linear model using said first training set.

40. The method of claim 39, wherein said building a first training set comprises:
retrieving said training electronic commerce data from a historical database;
selecting a training electronic commerce data time period based on said one or more timestamps; and
retrieving said parameter values from said training electronic commerce data indicated by said training electronic commerce data time period, wherein said first training set comprises said retrieved parameter values in chronological order over said selected training electronic commerce data time period.

41. The method of claim 40, further comprising:
generating a second training set by:
removing at least a subset of the parameter values of said first training set, wherein said at least a subset of the parameter values comprises oldest parameter values of said training set; and
adding new parameter values from said training electronic commerce data based on said timestamps to generate a second training set;
wherein said second training set corresponds to a second time period in said chronology; and
training a non-linear model using said second training set.

42. A system for training a non-linear model used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(1) training said non-linear model using a first training set, wherein said first training set is based on first electronic commerce data;
(2) training said non-linear model using said first training set and a second training set, wherein said second training set is based on second electronic commerce data; and
(3) training said non-linear model using said second training set and a third training set, without using said first training set, wherein said third training set is based on third electronic commerce data;
wherein at least one of (1), (2), and (3) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

43. The system of claim 42, wherein at least one of (1), (2), and (3) operates substantially in real-time.

44. The system of claim 42,
wherein (1) is preceded by analyzing behavior of the electronic commerce system; and
wherein (1) farther comprises using data representative of said analyzing as said first electronic commerce data.

45. A system for training a non-linear model used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(1) detecting first electronic commerce data;
(2) training said non-linear model in response to said detecting first electronic commerce data, using a first training set based on said first electronic commerce data;
(3) detecting second electronic commerce data;
(4) training said non-linear model in response to said detecting second electronic commerce data, using said first training set and a second training set, wherein said second training set is based on said second electronic commerce data;
(5) detecting third electronic commerce data;
(6) training said non-linear model in response to said detecting third electronic commerce data, using said second training set and a third training set, without using said first training set, wherein said third training set is based on said third electronic commerce data;
wherein at least one of (2), (4), and (6) comprises:
(a) retrieving electronic commerce training input data from a historical database, wherein said electronic commerce training input data has one or more timestamps;
(b) selecting an electronic commerce training input data time period based on said one or more timestamps; and
(c) retrieving electronic commerce input data indicated by said electronic commerce training input data time period.

46. The system of claim 45, further comprising discarding said first training set between (4) and (5).

47. The system of claim 45, further comprising discarding said second training set after (6).

48. A system for training a non-linear model used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(1) constructing a list containing at least two training sets;
(2) training said non-linear model using said at least two training sets in said list;
(3) constructing a new training set and replacing an oldest training set in said list with said new training set; and
(4) repeating (2) and (3) at least once;
wherein at least one of (1) and (3) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

49. The system of claim 48, wherein (3) comprises:
(a) monitoring substantially in real-time for new electronic commerce training input data; and
(b) retrieving electronic commerce input data indicated by said new electronic commerce training input data to construct said new training set.

50. The system of claim 48, wherein (2) uses said at least two training sets once.

51. The system of claim 48, wherein (2) uses said at least two training sets at least twice.

52. A system for training a non-linear model used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(1) producing first electronic commerce data, second electronic commerce data, and third electronic commerce data;
(2) training said non-linear model using a first training set, wherein said first training set is based on said first electronic commerce data;
(3) training said non-linear model using said first training set and a second training set, wherein said second training set is based on said second electronic commerce data; and
(4) training said non-linear model using said second training set and a third training set, without using said first training set, wherein said third training set is based on said third electronic commerce data;
wherein at least one of (2), (3), and (4) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

53. A system for training a non-linear model used to control an electronic commerce system, the system comprising:
a processor; a memory medium coupled to the processor, wherein the memory medium stores a non-linear model software program, wherein the non-linear model software program includes the non-linear model, and wherein the non-linear model software program is executable to perform:
(1) training said non-linear model using a first training set, wherein said first training set is based on first electronic commerce data;
(2) training said non-linear model using said first training set and a second training set, wherein said second training set is based on second electronic commerce data;
(3) training said non-linear model using said second training set and a third training set, without using said first training set, wherein said third training set is based on third electronic commerce data; and
(4) using said non-linear model to predict first electronic commerce output data using first electronic commerce input data;
wherein at least one of (1), (2), and (3) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

54. A system for training a non-linear model used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(1) detecting first electronic commerce data;
(2) training said non-linear model in response to said detecting first electronic commerce data, using a first training set, wherein said first training set is based on said first electronic commerce data;
(3) detecting second electronic commerce data;
(4) training said non-linear model in response to said detecting said second electronic commerce data, using said first training set and a second training set, wherein said second training set is based on said second electronic commerce data;
(5) detecting third electronic commerce data;
(6) training said non-linear model in response to said detecting third electronic commerce data, using said second training set and a third training set, without using said first training set, wherein said third training set is based on said third electronic commerce data; and
(7) using said non-linear model to predict first electronic commerce output data using first electronic commerce input data;
wherein at least one of (2), (4), and (6) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

55. A system for training a non-linear model used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(1) producing first electronic commerce data, second electronic commerce data, and third electronic commerce data;
(2) detecting said first electronic commerce data;
(3) training said non-linear model in response to said detecting first electronic commerce data, using a first training set, wherein said first training set is based on said first electronic commerce data;
(4) detecting said second electronic commerce data;
(5) training said non-linear model in response to said detecting second electronic commerce data, using said first training set and a second training set; wherein said second training set is based on said second electronic commerce data;
(6) detecting said third electronic commerce data; and
(7) training said non-linear model in response to said detecting third electronic commerce data, using said second training set and a third training set, without using said first training set, wherein said third training set is based on said third electronic commerce data;
wherein at least one of (3), (5), and (7) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

56. A system for constructing training sets for a non-linear model used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(1) developing a first training set for said non-linear model by:
(a) retrieving first electronic commerce training input data from a historical database, wherein said first electronic commerce training input data has a first set of one or more timestamps;
(b) selecting a first electronic commerce training input data time period based on said first set of one or more timestamps; and
(c) retrieving first electronic commerce input data indicated by said first electronic commerce training input data time period; and
(2) developing a second training set for said non-linear model by:
(a) retrieving second electronic commerce training input data from said historical database, wherein said second electronic commerce training input data has a second set of one or more timestamps;
(b) selecting a second electronic commerce training input data time period based on said second set of one or more timestamps; and
(c) retrieving second electronic commerce input data indicated by said second electronic commerce training input data time period.

57. The system of claim 56, further comprising:
(3) searching said historical database in either a forward time direction or a backward time direction so that said second electronic commerce training input data is the next electronic commerce training input data in time to said first electronic commerce training input data in said forward time direction or said backward time direction, whichever is used.

58. The system of claim 56, further comprising:
(3) training said non-linear model using said first training set and/or said second training set.

59. A system for generating predicted output data using a non-linear model, wherein the predicted output data is provided to a computer system used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(1) monitoring for the availability of new electronic commerce training input data by monitoring for a change in an associated timestamp of said electronic commerce training input data;
(2) constructing a training set by retrieving first electronic commerce input data corresponding to said electronic commerce training input data;
(3) training said non-linear model using said training set; and
(4) predicting the electronic commerce output data from second electronic commerce input data using said non-linear model.

60. The system of claim 59, wherein (2) further comprises using data pointers to indicate said electronic commerce training input data and said first electronic commerce input data.

61. The system of claim 59, wherein (1) is preceded by:
(i) presenting to a user a template for a partially specified non-linear model; and
(ii) entering data into said template to create a complete non-linear model specification; and
wherein (3) further comprises using a non-linear model representative of said complete non-linear model specification.

62. The system of claim 59, wherein (1) is preceded by:
(i) presenting to a user an interface for accepting a limited set of substantially natural language format specifications; and
(ii) entering into said interface sufficient specifications in said substantially natural language format to completely define a non-linear model; and
wherein (3) further comprises using a non-linear model representative of said completely defined non-linear model.

63. The system of claim 59, wherein (1), (2), and (3) operate substantially in real-time.

64. A system for constructing training sets for a non-linear model used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

65. A system for predicting electronic commerce output data provided to a computer system used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(1) monitoring for the availability of new electronic commerce training input data;
(2) constructing a training set by retrieving first electronic commerce input data corresponding to said electronic commerce training input data comprising:
(a) selecting a electronic commerce training input data time using one or more timestamps associated with said electronic commerce training input data; and
(b) retrieving electronic commerce input data representing measurement(s) at said electronic commerce training input data time, said electronic commerce input data comprising said first electronic commerce input data;
(3) training said non-linear model using said training set; and
(4) predicting the electronic commerce output data from second electronic commerce input data using said non-linear model.

66. The system of claim 65, wherein (1) comprises monitoring for a change between two successive electronic commerce training input data values.

67. The system of claim 65,
wherein (1) comprises computing a difference between a most recent electronic commerce training input data value and a next most recent electronic commerce training input data value; and
wherein (3) further comprises using said difference with said first electronic commerce input data for said training.

68. The system of claim 65, wherein (2) further comprises using data pointers to indicate said electronic commerce training input data and said first electronic commerce input data.

69. The system of claim 65, wherein (1), (2), and (3) operate substantially in real-time.

70. A system adapted for predicting electronic commerce output data provided to a computer system used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(1) presenting to a user a template for a partially specified non-linear model;
(2) entering data into said template to create a complete non-linear model specification;
(3) monitoring for the availability of new electronic commerce training input data;
(4) constructing a training set by retrieving first electronic commerce input data corresponding to said electronic commerce training input data;
(5) training said non-linear model using said training set, said training further comprising using a non-linear model representative of said complete non-linear model specification; and
(6) predicting the electronic commerce output data from second electronic commerce input data using said non-linear model.

71. The system of claim 70, wherein (3) comprises monitoring for a change between two successive electronic commerce training input data values.

72. The system of claim 70,
wherein (3) comprises computing a difference between a most recent electronic commerce training input data value and a next most recent electronic commerce training input data value; and
wherein (5) further comprises using said difference with said first electronic commerce input data for said training.

73. The system of claim 70, wherein (4) further comprises using data pointers to indicate said electronic commerce training input data and said first electronic commerce input data.

74. The system of claim 70, wherein (3), (4), and (5) operate substantially in real-time.

75. A system for predicting electronic commerce output data provided to a computer system used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
(1) presenting to a user an interface for accepting a limited set of substantially natural language format specifications;
(2) entering into said interface sufficient specifications in said substantially natural language format to completely define a non-linear model;
(3) monitoring for the availability of new electronic commerce training input data;
(4) constructing a training set by retrieving first electronic commerce input data corresponding to said electronic commerce training input data;
(5) training said non-linear model using said training set, wherein said training comprises using a non-linear model representative of said completely defined non-linear model; and
(6) predicting the electronic commerce output data from second electronic commerce input data using said non-linear model.

76. The system of claim 75, wherein (3) comprises monitoring for a change between two successive electronic commerce training input data values.

77. The system of claim 75,
wherein (3) comprises computing a difference between a most recent electronic commerce training input data value and a next most recent electronic commerce training input data value; and
wherein (5) further comprises using said difference with said first electronic commerce input data for said training.

78. The system of claim 75, wherein (4) further comprises using data pointers to indicate said electronic commerce training input data and said first electronic commerce input data.

79. The system of claim 75, wherein (3), (4), and (5) operate substantially in real-time.

80. A system for training a non-linear model used to control an electronic commerce system, the system comprising:
a processor;
a memory medium coupled to the processor, wherein the memory medium stores a non-linear model software program, wherein the non-linear model software program includes the non-linear model, and wherein the non-linear model software program is executable to perform:
building a first training set using training electronic commerce data, wherein said training electronic commerce data comprises one or more timestamps indicating a chronology of said training electronic commerce data and one or more parameter values corresponding to each timestamp, and wherein said first training set comprises parameter values corresponding to a first time period in said chronology;
training a non-linear model using said first training set.

81. The system of claim 80, wherein said building a first training set comprises:
retrieving said training electronic commerce data from a historical database;
selecting a training electronic commerce data time period based on said one or more timestamps; and
retrieving said parameter values from said training electronic commerce data indicated by said training electronic commerce data time period, wherein said first training set comprises said retrieved parameter values in chronological order over said selected training electronic commerce data time period.

82. The system of claim 81, further comprising:
generating a second training set by:
removing at least a subset of the parameter values of said first training set, wherein said at least a subset of the parameter values comprises oldest parameter values of said training set; and
adding new parameter values from said training electronic commerce data based on said timestamps to generate a second training set;
wherein said second training set corresponds to a second time period in said chronology; and
training a non-linear model using said second training set.

83. A memory medium which stores program instructions for training a non-linear model used to control an electronic commerce system, wherein the program instructions are executable to perform:
(1) training said non-linear model using a first training set, wherein said first training set is based on first electronic commerce data;
(2) training said non-linear model using said first training set and a second training set, wherein said second training set is based on second electronic commerce data; and
(3) training said non-linear model using said second training set and a third training set, without using said first training set, wherein said third training set is based on third electronic commerce data;
wherein at least one of (1), (2), and (3) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

84. The memory medium of claim 83, wherein at least one of (1), (2), and (3) operates substantially in real-time.

85. The memory medium of claim 83,
wherein (1) is preceded by analyzing raw data from the electronic commerce system; and
wherein (1) further comprises using data representative of said analyzing as said first electronic commerce data.

86. A memory medium which stores program instructions for training a non-linear model used to control an electronic commerce system, wherein the program instructions are executable to perform:
(1) detecting first electronic commerce data;
(2) training said non-linear model in response to said detecting first electronic commerce data, using a first training set based on said first electronic commerce data;
(3) detecting second electronic commerce data;
(4) training said non-linear model in response to said detecting second electronic commerce data, using said first training set and a second training set, wherein said second training set is based on said second electronic commerce data;
(5) detecting third electronic commerce data;
(6) training said non-linear model in response to said detecting third electronic commerce data, using said second training set and a third training set, without using said first training set, wherein said third training set is based on said third electronic commerce data;
wherein at least one of (2), (4), and (6) comprises:
(a) retrieving electronic commerce training input data from a historical database, wherein said electronic commerce training input data has one or more timestamps;
(b) selecting an electronic commerce training input data time period based on said one or more timestamps; and
(c) retrieving electronic commerce input data indicated by said electronic commerce training input data time period.

87. The memory medium of claim 86, further comprising discarding said first training set between (4) and (5).

88. The memory medium of claim 86, further comprising discarding said second training set after (6).

89. A memory medium which stores program instructions for training a non-linear model used to control an electronic commerce system, wherein the program instructions are executable to perform:
(1) constructing a list containing at least two training sets;
(2) training said non-linear model using said at least two training sets in said list;
(3) constructing a new training set and replacing an oldest training set in said list with said new training set; and
(4) repeating (2) and (3) at least once;
wherein at least one of (1) and (3) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

90. The memory medium of claim 89, wherein (3) comprises:
(a) monitoring substantially in real-time for new electronic commerce training input data; and
(b) retrieving electronic commerce input data indicated by said new electronic commerce training input data to construct said new training set.

91. The memory medium of claim 89, wherein (2) uses said at least two training sets once.

92. The memory medium of claim 89, wherein (2) uses said at least two training sets at least twice.

93. A memory medium which stores program instructions for training a non-linear model used to control an electronic commerce system, wherein the program instructions are executable to perform:
(1) producing first electronic commerce data, second electronic commerce data, and third electronic commerce data;
(2) training said non-linear model using a first training set, wherein said first training set is based on said first electronic commerce data;
(3) training said non-linear model using said first training set and a second training set, wherein said second training set is based on said second electronic commerce data; and
(4) training said non-linear model using said second training set and a third training set, without using said first training set, wherein said third training set is based on said third electronic commerce data;
wherein at least one of (2), (3), and (4) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

94. A memory medium which stores program instructions for training a non-linear model used to control an electronic commerce system, wherein the program instructions are executable to perform:
(1) training said non-linear model using a first training set, wherein said first training set is based on first electronic commerce data;
(2) training said non-linear model using said first training set and a second training set, wherein said second training set is based on second electronic commerce data;
(3) training said non-linear model using said second training set and a third training set, without using said first training set, wherein said third training set is based on third electronic commerce data; and
(4) using said non-linear model to predict first electronic commerce output data using first electronic commerce input data;
wherein at least one of (1), (2), and (3) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

95. A memory medium which stores program instructions for training a non-linear model used to control an electronic commerce system, wherein the program instructions are executable to perform:
(1) detecting first electronic commerce data;
(2) training said non-linear model in response to said detecting first electronic commerce data, using a first training set, wherein said first training set is based on said first electronic commerce data;
(3) detecting second electronic commerce data;
(4) training said non-linear model in response to said detecting said second electronic commerce data, using said first training set and a second training set, wherein said second training set is based on said second electronic commerce data;
(5) detecting third electronic commerce data;
(6) training said non-linear model in response to said detecting third electronic commerce data, using said second training set and a third training set, without using said first training set, wherein said third training set is based on said third electronic commerce data; and
(7) using said non-linear model to predict first electronic commerce output data using first electronic commerce input data;
wherein at least one of (2), (4), and (6) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

96. A memory medium which stores program instructions for training a non-linear model used to control an electronic commerce system, wherein the program instructions are executable to perform:
(1) producing first electronic commerce data, second electronic commerce data, and third electronic commerce data;
(2) detecting said first electronic commerce data;
(3) training said non-linear model in response to said detecting first electronic commerce data, using a first training set, wherein said first training set is based on said first electronic commerce data;
(4) detecting said second electronic commerce data;
(5) training said non-linear model in response to said detecting second electronic commerce data, using said first training set and a second training set; wherein said second training set is based on said second electronic commerce data;
(6) detecting said third electronic commerce data; and
(7) training said non-linear model in response to said detecting third electronic commerce data, using said second training set and a third training set, without using said first training set, wherein said third training set is based on said third electronic commerce data;
wherein at least one of (3), (5), and (7) comprises:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

97. A memory medium which stores program instructions for constructing training sets for a non-linear model used to control an electronic commerce system, wherein the program instructions are executable to perform:
(1) developing a first training set for said non-linear model by:
(a) retrieving first electronic commerce training input data from a historical database, wherein said first electronic commerce training input data has a first set of one or more timestamps;
(b) selecting a first electronic commerce training input data time period based on said first set of one or more timestamps; and
(c) retrieving first electronic commerce input data indicated by said first electronic commerce training input data time period; and
(2) developing a second training set for said non-linear model by:
(a) retrieving second electronic commerce training input data from said historical database, wherein said second electronic commerce training input data has a second set of one or more timestamps;
(b) selecting a second electronic commerce training input data time period based on said second set of one or more timestamps; and
(c) retrieving second electronic commerce input data indicated by said second electronic commerce training input data time period.

98. The memory medium of claim 97, further comprising:
(3) searching said historical database in either a forward time direction or a backward time direction so that said second electronic commerce training input data is the next electronic commerce training input data in time to said first electronic commerce training input data in said forward time direction or said backward time direction, whichever is used.

99. The memory medium of claim 97, further comprising:
(3) training said non-linear model using said first training set and/or said second training set.

100. A memory medium which stores program instructions for generating predicted output data using a non-linear model, wherein the predicted output data is provided to a computer system used to control an electronic commerce system, wherein the program instructions are executable to perform:
(1) monitoring for the availability of new electronic commerce training input data by monitoring for a change in an associated timestamp of said electronic commerce training input data;
(2) constructing a training set by retrieving first electronic commerce input data corresponding to said electronic commerce training input data;
(3) training said non-linear model using said training set; and
(4) predicting the electronic commerce output data from second electronic commerce input data using said non-linear model.

101. The memory medium of claim 100, wherein (2) further comprises using data pointers to indicate said electronic commerce training input data and said first electronic commerce input data.

102. The memory medium of claim 100, wherein (1) is preceded by:
(i) presenting to a user a template for a partially specified non-linear model; and
(ii) entering data into said template to create a complete non-linear model specification; and
wherein (3) further comprises using a non-linear model representative of said complete non-linear model specification.

103. The memory medium of claim 100, wherein (1) is preceded by:
(i) presenting to a user an interface for accepting a limited set of substantially natural language format specifications; and
(ii) entering into said interface sufficient specifications in said substantially natural language format to completely define a non-linear model; and
wherein (3) further comprises using a non-linear model representative of said completely defined non-linear model.

104. The memory medium of claim 100, wherein (1), (2), and (3) operate substantially in real-time.

105. A memory medium which stores program instructions for constructing training sets for a non-linear model used to control an electronic commerce system, wherein the program instructions are executable to perform:
(a) retrieving electronic commerce training input data from a historical database, wherein said electronic commerce training input data has one or more timestamps;
(b) selecting a electronic commerce training input data time period based on said one or more timestamps; and
(c) retrieving electronic commerce input data indicated by said electronic commerce training input data time period.

106. A memory medium which stores program instructions for predicting electronic commerce output data provided to a computer system used to control an electronic commerce system, wherein the program instructions are executable to perform:
(1) monitoring for the availability of new electronic commerce training input data;
(2) constructing a training set by retrieving first electronic commerce input data corresponding to said electronic commerce training input data comprising:
(a) selecting a electronic commerce training input data time using one or more timestamps associated with said electronic commerce training input data; and
(b) retrieving electronic commerce input data representing measurement(s) at said electronic commerce training input data time, said electronic commerce input data comprising said first electronic commerce input data;
(3) training said non-linear model using said training set; and
(4) predicting the electronic commerce output data from second electronic commerce input data using said non-linear model.

107. The memory medium of claim 106, wherein (1) comprises monitoring for a change between two successive electronic commerce training input data values.

108. The memory medium of claim 106, wherein (1) comprises computing a difference between a most recent electronic commerce training input data value and a next most recent electronic commerce training input data value; and
wherein (3) further comprises using said difference with said first electronic commerce input data for said training.

109. The memory medium of claim 106, wherein (2) further comprises using data pointers to indicate said electronic commerce training input data and said first electronic commerce input data.

110. The memory medium of claim 106, wherein (1), (2), and (3) operate substantially in real-time.

111. A memory medium which stores program instructions adapted for predicting electronic commerce output data provided to a computer system used to control an electronic commerce system, wherein the program instructions are executable to perform:
(1) presenting to a user a template for a partially specified non-linear model;
(2) entering data into said template to create a complete non-linear model specification;
(3) monitoring for the availability of new electronic commerce training input data;
(4) constructing a training set by retrieving first electronic commerce input data corresponding to said electronic commerce training input data;
(5) training said non-linear model using said training set, said training further comprising using a non-linear model representative of said complete non-linear model specification; and
(6) predicting the electronic commerce output data from second electronic commerce input data using said non-linear model.

112. The memory medium of claim 111, wherein (3) comprises monitoring for a change between two successive electronic commerce training input data values.

113. The memory medium of claim 111,
wherein (3) comprises computing a difference between a most recent electronic commerce training input data value and a next most recent electronic commerce training input data value; and
wherein (5) further comprises using said difference with said first electronic commerce input data for said training.

114. The memory medium of claim 111, wherein (4) further comprises using data pointers to indicate said electronic commerce training input data and said first electronic commerce input data.

115. The memory medium of claim 111, wherein (3), (4), and (5) operate substantially in real-time.

116. A memory medium which stores program instructions for predicting electronic commerce output data provided to a computer system used to control an electronic commerce system, wherein the program instructions are executable to perform:
(1) presenting to a user an interface for accepting a limited set of substantially natural language format specifications;
(2) entering into said interface sufficient specifications in said substantially natural language format to completely define a non-linear model;
(3) monitoring for the availability of new electronic commerce training input data;
(4) constructing a training set by retrieving first electronic commerce input data corresponding to said electronic commerce training input data;
(5) training said non-linear model using said training set, wherein said training comprises using a non-linear model representative of said completely defined non-linear model; and
(6) predicting the electronic commerce output data from second electronic commerce input data using said non-linear model.

117. The memory medium of claim 116, wherein (3) comprises monitoring for a change between two successive electronic commerce training input data values.

118. The memory medium of claim 116,
wherein (3) comprises computing a difference between a most recent electronic commerce training input data value and a next most recent electronic commerce training input data value; and
wherein (5) further comprises using said difference with said first electronic commerce input data for said training.

119. The memory medium of claim 116, wherein (4) further comprises using data pointers to indicate said electronic commerce training input data and said first electronic commerce input data.

120. The memory medium of claim 116, wherein (3), (4), and (5) operate substantially in real-time.

121. A memory medium which stores program instructions for training a non-linear model used to control an electronic commerce system, wherein the program instructions are executable to perform:
building a first training set using training electronic commerce data, wherein said training electronic commerce data comprises one or more timestamps indicating a chronology of said training electronic commerce data and one or more parameter values corresponding to each timestamp, and wherein said first training set comprises parameter values corresponding to a first time period in said chronology;
training a non-linear model using said first training set.

122. The memory medium of claim 121, wherein said building a first training set comprises:
retrieving said training electronic commerce data from a historical database;
selecting a training electronic commerce data time period based on said one or more timestamps; and
retrieving said parameter values from said training electronic commerce data indicated by said training electronic commerce data time period, wherein said first training set comprises said retrieved parameter values in chronological order over said selected training electronic commerce data time period.

123. The memory medium of claim 122, further comprising:
generating a second training set by:
removing at least a subset of the parameter values of said first training set, wherein said at least a subset of the parameter values comprises oldest parameter values of said training set; and
adding new parameter values from said training electronic commerce data based on said timestamps to generate a second training set;
wherein said second training set corresponds to a second time period in said chronology; and
training a non-linear model using said second training set.
